(19) United States
(12) Patent Application Publication
(10) Pub. No.: US 2026/0371467 A1
(43) Pub. Date: Nov. 19, 2026

(54) LIGHT-EMITTING DEVICE CONTROL SYSTEM AND OPERATING METHOD THEREOF

(71) Applicant: SOLUM CO., LTD., Yongin-si (KR)

(72) Inventors: Jae Hyuk Park, Hwaseong-si (KR); Nam Min Kim, Seoul (KR); Seung Min Lee, Bucheon-si (KR); Kyung Ah Cho, Yongin-si (KR); In Jong Jang, Yongin-si (KR)

(73) Assignee: SOLUM CO., LTD., Yongin-si (KR)

(21) Appl. No.: 19/679,213

(22) Filed: May 15, 2026

(30) Foreign Application Priority Data
May 15, 2025 (KR) 10-2025-0063453
May 14, 2026 (KR) 10-2026-0087264
May 14, 2026 (KR) 10-2026-0087265
May 14, 2026 (KR) 10-2026-0087266
May 14, 2026 (KR) 10-2026-0087325

(51) Int. Cl. H05B 47/19; H05B 47/155; A63J 5/00

(52) U.S. Cl. CPC H05B 47/19; H05B 47/155; A63J 5/00

(57) ABSTRACT

A control device for controlling a plurality of light-emitting devices includes a communication device, a memory, and a processor. The processor is configured to acquire performance production information including at least one of performance progress time information, production target information, and light emission effect information, generate, based on the performance production information, a light emission control packet including light emission control information and information on a reception target range of the light emission control information, determine one of a plurality of transmission methods corresponding to different reception target ranges based on the information on the reception target range, determine a transmission condition to be applied to at least one repeater for transmitting the light emission control packet based on the determined transmission method, and transmit the light emission control packet and the transmission condition to the at least one repeater through the communication device.

### CROSS REFERENCE TO RELATED APPLICATION

This application claims the benefit of and priority to Korean Patent Application No. 10-2025-0063453 filed on May 15, 2025, Korean Patent Application No. 10-2026-0087264 filed on May 14, 2026, Korean Patent Application No. 10-2026-0087265 filed on May 14, 2026, Korean Patent Application No. 10-2026-0087266 filed on May 14, 2026, and Korean Patent Application No. 10-2026-0087325 filed on May 14, 2026, the entire disclosures of which are hereby incorporated herein by reference in their entireties.

### TECHNICAL FIELD

The present disclosure relates to a technology for controlling a light-emitting device.

### BACKGROUND OF THE INVENTION

As performance, sports cheering, and large-scale event cultures advance, there has been an increasing number of cases in which light-emitting devices, carried by audience members or disposed at spectator seats, are utilized for performance production. Such light-emitting devices can provide visual production effects throughout the performance space by outputting at least one of color, brightness, blinking, fading, and patterns in accordance with the performance time.

Conventionally, a method has been used in which operation scenarios of a light-emitting device are pre-stored in the light-emitting device, and the start or interruption of a specific scenario is instructed during a performance.

A method of controlling a light-emitting device using only the identification information of stored scenarios and start instructions may have difficulty in sufficiently responding to production changes made spontaneously during a performance, selective control for a specific group of light-emitting devices, calibration control for individual light-emitting devices, or status calibration corresponding to the current performance time.

Accordingly, there is a need for a technology for efficiently controlling a plurality of light-emitting devices based on performance production information.

### SUMMARY OF THE INVENTION

An object of the present disclosure is to provide a control device, a light-emitting device, and an operating method thereof, capable of efficiently controlling a plurality of light-emitting devices based on performance production information.

Another object of the present disclosure is to provide a control device capable of: generating a light emission control packet including light emission control information and information on a reception target range; and determining one of a plurality of transmission methods corresponding to different reception target ranges based on the information on the reception target range.

Another object of the present disclosure is to provide a control device capable of: generating information on a reception target range based on at least one of a target area based on a performance space, a light-emitting device group, an individual light-emitting device, and a state condition of a light-emitting device; and determining a transmission method or a repeater corresponding to the reception target range.

Another object of the present disclosure is to provide a light-emitting device capable of determining whether a received light emission control packet is a processing target packet by comparing information on a reception target range included in the light emission control packet with at least one of device identification information and current device correspondence information.

Another object of the present disclosure is to provide a light-emitting device capable of performing at least one of immediate application, application after temporary storage, and non-application of light emission control information based on execution time information.

Another object of the present disclosure is to provide a light-emitting device control system capable of reducing packet loss or light emission state inconsistency in a large-scale performance space by performing at least one of repeated transmission, re-transmission, and calibration transmission based on information on a transmission result of a light emission control packet.

According to one aspect, there is provided a control device for controlling a plurality of light-emitting devices, the control device comprising: a communication device; a memory; and a processor configured to execute instructions stored in the memory, wherein the processor, by executing the instructions, is configured to: acquire performance production information including at least one of performance progress time information, production target information, and light emission effect information; generate, based on the performance production information, a light emission control packet including light emission control information and information on a reception target range of the light emission control information; determine one of a plurality of transmission methods corresponding to different reception target ranges based on the information on the reception target range; determine a transmission condition to be applied to at least one repeater for transmitting the light emission control packet based on the determined transmission method; and transmit the light emission control packet and the transmission condition to the at least one repeater through the communication device.

According to an embodiment, the processor is configured to identify at least one of a target area based on a performance space, a light-emitting device group, an individual light-emitting device, and a state condition of a light-emitting device from the production target information, and generate the information on the reception target range based on the identified at least one of the target area, the light-emitting device group, the individual light-emitting device, and the state condition.

According to an embodiment, the processor is configured to generate the information on the reception target range using at least one of correspondence information between the target area based on the performance space and a preset light-emitting device group, identification information of the light-emitting device group, identification information of the individual light-emitting device, and the state condition of the light-emitting device.

According to an embodiment, the plurality of transmission methods correspond to a plurality of target categories having different reception target ranges, and the processor is configured to select one of the plurality of transmission methods based on a target category to which the reception target range belongs.

According to an embodiment, the processor is configured to generate execution time information representing an application timing of the light emission control information based on the performance progress time information, and construct the light emission control packet to include the execution time information.

According to an embodiment, the processor is configured to determine the transmission condition including at least one of a transmission timing, a transmission repetition count, and a transmission priority of the light emission control packet, based on a relationship between the application timing indicated by the execution time information and a current performance progress time.

According to an embodiment, the transmission condition includes at least one of a transmission method, a transmission target, a transmission timing, a transmission repetition count, a transmission priority, whether to re-transmit, and whether to perform calibration transmission, and the processor is configured to transmit the transmission condition to the at least one repeater so that the at least one repeater transmits the light emission control packet according to the transmission condition.

According to an embodiment, the at least one repeater is selected from a plurality of repeaters, and the processor is configured to select the at least one repeater based on a correspondence relationship between the reception target range and a transmittable range of each of the plurality of repeaters.

According to an embodiment, the processor is configured to determine whether a subsequent transmission of the light emission control packet is necessary and determine a subsequent transmission condition, based on information on a transmission result of the light emission control packet.

According to an embodiment, the information on the transmission result includes at least one of packet identification information of the light emission control packet, transmission history information, reception state information collected from a light-emitting device, device state information of the light-emitting device, and valid time information of the light emission control packet, and the subsequent transmission condition includes at least one of a repeated transmission condition for the same light emission control packet, a re-transmission condition for a previously transmitted light emission control packet, and a transmission condition for a calibration packet indicating a light emission state corresponding to a current performance progress time.

According to another aspect, there is provided a light-emitting device comprising: a communication device configured to receive a light emission control packet from an external device; a light source device configured to emit light; a memory; and a processor configured to execute instructions stored in the memory, wherein the processor, by executing the instructions, is configured to: determine whether the light emission control packet is a processing target packet based on information on a reception target range included in the light emission control packet; determine, when the light emission control packet is the processing target packet, an application timing of light emission control information included in the light emission control packet based on execution time information included in the light emission control packet; and control the light source device based on the light emission control information at the application timing.

According to an embodiment, the memory is configured to store device identification information of the light-emitting device and current device correspondence information that is updated based on at least one of a performance progress time, a previously received light emission control packet, group update information, and state information of the light-emitting device, the current device correspondence information includes at least one of information on a light-emitting device group to which the light-emitting device currently belongs and current state information of the light-emitting device, and the processor is configured to determine whether the light emission control packet is the processing target packet applied to the light-emitting device as any one of target categories corresponding to all light-emitting devices, a light-emitting device group, or an individual light-emitting device, by comparing the information on the reception target range with at least one of the device identification information and the current device correspondence information.

According to an embodiment, the light emission control packet further includes at least one of packet identification information, version information, error detection information, and valid time information, and the processor is configured to determine, before determining whether the light emission control packet is the processing target packet, at least one of integrity, redundancy, and validity of the light emission control packet based on at least one of the packet identification information, the version information, the error detection information, and the valid time information.

According to an embodiment, the processor is configured to: immediately apply the light emission control information when the execution time information indicates immediate execution; temporarily store the light emission control information in the memory when the execution time information indicates an application timing corresponding to a reserved execution time or a performance progress time, and apply the light emission control information at the application timing; and not apply the light emission control information when the execution time information includes a valid time or an expiration time and indicates that validity of the light emission control packet has been lost.

According to an embodiment, the processor is configured to generate processing result information representing at least one of whether the light emission control packet is received, whether the light emission control packet is the processing target packet, whether the light emission control information is applied, whether an error occurs, and a current light emission state, and store the processing result information in the memory or transmit the processing result information to the external device through the communication device.

According to an embodiment of the present disclosure, a control device may generate a light emission control packet including light emission control information and information on a reception target range based on performance production information. Therefore, the light emission control packet can define not only a light emission effect but also a target range to which the light emission control information is to be applied.

According to an embodiment of the present disclosure, the control device may determine one of a plurality of transmission methods corresponding to different reception target ranges based on the information on the reception target range included in the light emission control packet. Therefore, the control device can select a transmission method suitable for each target category corresponding to at least one of all light-emitting devices, a light-emitting device group, and an individual light-emitting device.

According to an embodiment of the present disclosure, the control device may select at least one repeater based on a correspondence relationship between the reception target range and a transmittable range of each of a plurality of repeaters. Therefore, the control device can more efficiently transmit a light emission control packet corresponding to a specific area or a specific light-emitting device group within a performance space.

According to an embodiment of the present disclosure, a light-emitting device may determine whether a light emission control packet is a processing target packet by comparing information on a reception target range with at least one of device identification information and current device correspondence information. Therefore, the light-emitting device can selectively process packets corresponding to all light-emitting devices, a light-emitting device group, and an individual light-emitting device.

According to an embodiment of the present disclosure, the current device correspondence information may be updated based on at least one of a performance progress time, a previously received light emission control packet, group update information, and state information of the light-emitting device. Therefore, the light-emitting device group is not limited to a group fixed to seating information or ticket information, but can be flexibly changed according to performance progress or device states.

According to an embodiment of the present disclosure, the light-emitting device may determine an application timing of the light emission control information based on execution time information. Therefore, the light-emitting device can separate a reception timing of the light emission control packet from the application timing of the light emission control information, and a plurality of light-emitting devices can perform light emission operations in accordance with an application timing corresponding to the performance progress time.

According to an embodiment of the present disclosure, the control device may determine whether a subsequent transmission is necessary and determine a subsequent transmission condition based on information on a transmission result. Therefore, even when packet loss, reception failure, an error, or current light emission state inconsistency occurs, the control device can correct the light emission state through at least one of repeated transmission, re-transmission, and calibration transmission.

According to an embodiment of the present disclosure, a repeater may transmit a light emission control packet using at least one of a Wi-Fi HaLow communication method, RF channel division, continuous transmission of the same information, and antenna beamforming. Therefore, the repeater can enable long-distance, low-power, and spatially selective transmission for a plurality of light-emitting devices in a large-scale performance space, and can stably perform light emission operations corresponding to the performance production information.

### BRIEF DESCRIPTION OF THE DRAWINGS

The present disclosure can be easily understood by the following detailed description in combination with the accompanying drawings, in which reference numerals refer to structural elements.

FIG. 1 is a diagram illustrating an overall configuration of a light-emitting device control system according to an embodiment.

FIG. 2 is a block diagram illustrating a configuration of a light-emitting device according to an embodiment.

FIG. 3 is a block diagram illustrating a configuration of a control device according to an embodiment.

FIG. 4 is a block diagram illustrating a configuration of a repeater according to an embodiment.

FIG. 5 is a diagram illustrating a structure of a light emission control packet according to an embodiment.

FIG. 6 is a diagram illustrating an embodiment of light-emitting device arrangement and packet transmission within a concert hall according to an embodiment.

FIG. 7 is a diagram illustrating an embodiment of selecting a transmission method for a light emission control packet according to an embodiment.

FIG. 8 is a diagram illustrating an embodiment of an application range of a light emission control packet based on information on a reception target range according to an embodiment.

FIG. 9 is a diagram illustrating an embodiment of a light emission operation based on execution time information according to an embodiment.

FIG. 10 is a flowchart illustrating a flow of determining and applying a transmission method for a light emission control packet according to an embodiment.

FIG. 11 is a flowchart illustrating a flow of processing a light emission control packet by a light-emitting device according to an embodiment.

FIG. 12 is a diagram illustrating embodiments of repeated transmission, re-transmission, and calibration transmission according to an embodiment.

FIG. 13 is a diagram illustrating an arrangement of a plurality of repeaters and a plurality of light-emitting device groups within a performance space according to an embodiment.

FIG. 14 is a diagram illustrating reception control intervals for each of a plurality of light-emitting device groups according to an embodiment.

FIG. 15A is a diagram illustrating a transmission structure of a light emission control packet using a common transmission resource according to an embodiment.

FIG. 15B is a diagram illustrating a linkage structure between a light emission control packet and a transmission schedule for differential light emission control according to an embodiment.

FIG. 15C is a diagram illustrating a transmission structure of differential light emission control information using a time division transmission resource according to an embodiment.

FIG. 15D is a diagram illustrating a transmission structure of differential light emission control information using a frequency division transmission resource according to an embodiment.

FIG. 15E is a diagram illustrating a transmission structure of differential light emission control information using a spatial division transmission resource according to an embodiment.

FIG. 16 is a diagram illustrating a transmission schedule update structure based on reception state information according to an embodiment.

FIG. 17 is a flowchart illustrating a light emission control method based on operations among a control device, a repeater, and a light-emitting device according to an embodiment.

FIG. 18 is a flowchart illustrating a method for generating and updating a transmission schedule performed by a control device according to an embodiment.

FIG. 19 is a flowchart illustrating a method for processing a light emission control packet performed by a light-emitting device according to an embodiment.

FIG. 20 is a diagram illustrating an arrangement of spatial units and transmittable ranges of a plurality of repeaters within a performance space, according to an embodiment.

FIG. 21 is a diagram illustrating a plurality of beam transmission profiles and a plurality of estimated coverage areas of a repeater, according to an embodiment.

FIG. 22 is a diagram illustrating an embodiment of selecting a beam transmission profile based on evaluation results of a plurality of estimated coverage areas, according to an embodiment.

FIG. 23 is a diagram illustrating an embodiment of selecting a transmission mode according to a result of determining spatial selectivity, according to an embodiment.

FIG. 24 is a flowchart illustrating a method for a control device to determine a target spatial area and a beam transmission condition from performance production information, according to an embodiment.

FIG. 25 is a diagram illustrating an embodiment of converting an area selection input, entered through a user interface device, into a performance space coordinate system and determining a target spatial area based on the converted performance space coordinates, according to an embodiment.

FIG. 26A is a diagram illustrating an embodiment of reusing a current beam transmission profile by partially correcting current beam transmission conditions during a real-time production change, according to an embodiment.

FIG. 26B is a diagram illustrating an embodiment of determining new updated beam transmission conditions by selecting a different beam transmission profile during a real-time production change, according to an embodiment.

FIG. 27 is a diagram illustrating a plurality of embodiments of correcting beam transmission conditions based on a distribution of reception states, according to an embodiment.

FIG. 28 is a flowchart illustrating a spatial-selective light emission control method among a control device, a repeater, and a light-emitting device, according to an embodiment.

FIG. 29 is a flowchart illustrating a method for determining beam transmission conditions performed by a control device, according to an embodiment.

FIG. 30 is a flowchart illustrating a spatial-selective packet transmission method performed by a repeater, according to an embodiment.

FIG. 31 is a flowchart illustrating a light emission control packet processing method performed by a light-emitting device, according to an embodiment.

### DETAILED DESCRIPTION OF THE INVENTION

Hereinafter, some exemplary embodiments will be described in detail with reference to the accompanying drawings. The embodiments described below may be modified and implemented in various different forms. In order to more clearly describe the features of the embodiments, detailed descriptions of matters widely known to those of ordinary skill in the art to which the following embodiments pertain will be omitted.

Meanwhile, in the present specification, when a component is referred to as being "connected" to another component, this includes not only the case where they are "directly connected" but also the case where they are "connected with another component interposed therebetween." In addition, when a component is referred to as "comprising" or "including" another component, this means that other components may be further included rather than excluding other components unless specifically stated to the contrary.

Furthermore, terms including ordinal numbers such as "first" or "second" may be used to describe various components, but the components should not be limited by these terms. These terms are used only for the purpose of distinguishing one component from another.

In the present specification, a "light-emitting device control system" may mean a system for controlling light emission operations of a plurality of light-emitting devices in at least one space among a concert hall, a stadium, an outdoor event space, and a fan meeting venue. The light-emitting device control system may be a system that generates a light emission control packet based on performance production information, transmits the light emission control packet to at least one of the plurality of light-emitting devices, and controls the light-emitting device to perform a light emission operation based on the light emission control packet.

The light-emitting device control system may include at least one of a control device, a repeater, and a light-emitting device. Depending on the implementation form, the light-emitting device control system may further include at least one of a user terminal, a performance operation server, an external storage device, and a network device. For example, the light-emitting device control system may be implemented in a structure in which the control device acquires performance production information, the repeater transmits a light emission control packet, and the light-emitting device processes the light emission control packet to control a light source device.

In the present specification, a "control device" may mean a device that processes performance production information, generates a light emission control packet, and determines a transmission method or a transmission condition of the light emission control packet in order to control a plurality of light-emitting devices. The control device may acquire performance production information from a performance operator, a director, a performance operation server, or a performance control program, and generate information for controlling a light emission operation of the light-emitting device based on the acquired performance production information.

The control device may include at least one of a control server installed in a concert hall, a computing device in a performance operation room, a control device linked with a lighting console, a portable computing device, and a cloud server. The control device may be implemented as a device physically separated from the repeater, or may be implemented as an integrated device including at least a portion of the functions of the repeater.

For example, the control device may acquire performance production information including at least one of performance progress time information, production target information, and light emission effect information, and generate a light emission control packet including light emission control information and information on a reception target range. The control device may determine one of a plurality of transmission methods corresponding to different reception target ranges based on the information on the reception target range included in the light emission control packet.

In the present specification, a "repeater" may mean a device for receiving a light emission control packet or a transmission condition from the control device and transmitting the light emission control packet to at least one of a plurality of light-emitting devices. The repeater may be a device that delivers a light emission control packet between the control device and the light-emitting device, and may adjust at least one of a transmission method, a transmission target, a transmission timing, a transmission repetition count, and a transmission priority according to the transmission condition.

The repeater may include at least one of a wireless access point, a Wi-Fi HaLow access point, a gateway, a wireless transmission device, a wired/wireless bridge, and a transmission device. The repeater may perform wireless communication with the light-emitting device and may be connected to the control device through at least one method among a wired communication method, a wireless communication method, and a mixed wired/wireless communication method.

The wired communication method through which the repeater is connected to the control device may include at least one of an Ethernet method, an optical cable communication method, a Power Line Communication (PLC) method, a coaxial cable communication method, a twisted pair cable communication method, an optical fiber communication method, and a serial communication method. However, the present disclosure is not limited thereto, and the repeater may be connected to the control device using a wired communication method having optimal performance based on at least one of a transmission speed, a transmission distance, a stability, and an installation environment of a performance space.

For example, the repeater may transmit the light emission control packet using at least one of a long-range low-power wireless communication method, a sub-1GHz band wireless communication method, and an IEEE 802.11ah-based Wi-Fi HaLow communication method.

In the present specification, a "light-emitting device" may mean a device that receives a light emission control packet and emits light based on the received light emission control packet. The light-emitting device may be carried by an audience member, disposed at a spectator seat, or installed at a specific position within a performance space in at least one space among a concert hall, a stadium, an outdoor event space, and a fan meeting venue.

The light-emitting device may include at least one of a cheering stick, a lighting device, a portable light-emitting device, a wearable light-emitting device, a seat-disposed light-emitting device, and a wireless lighting device. The light-emitting device may include at least one of a communication device, a light source device, a memory, and a processor.

For example, the light-emitting device may receive a light emission control packet from an external device and determine whether the light emission control packet is a packet to be processed (hereinafter, "processing target packet") based on the information on the reception target range included in the light emission control packet. If the light emission control packet is a processing target packet, the light-emitting device may determine an application timing of the light emission control information based on execution time information and control the light source device based on the light emission control information at the application timing.

In the present specification, "performance production information" may mean information used to control light emission operations of a plurality of light-emitting devices in accordance with the progress of a performance. The performance production information may represent at least one of temporal progress of a performance, a production target, and a light emission effect, and may be used as reference information for the control device to generate a light emission control packet.

The performance production information may include at least one of performance progress time information, production target information, and light emission effect information. The performance production information may be acquired from at least one of a performance operation server, a performance control program, a user interface device, and an external storage device.

For example, the performance production information may include at least one of: information for causing all light-emitting devices to output the same light emission effect in a specific performance section; information for causing a light-emitting device group included in a target area based on a specific performance space to emit light in a specific color; and information for causing a specific light-emitting device to perform a calibration light emission operation.

In the present specification, "performance progress time information" may mean information representing a temporal progress state of a performance or an application timing of a specific light emission operation within a performance. The performance progress time information may be used as a reference for determining when the light emission control information should be applied.

The performance progress time information may include at least one of a performance reference time, an elapsed time after the start of a performance, performance section information, a scene start time, a song start time, a reserved execution time, and a current performance progress time. The performance progress time information may be used as reference information for the control device to generate execution time information, and may also be used as a reference for the light-emitting device to determine an application timing of the light emission control information.

For example, the control device may generate execution time information representing an application timing of the light emission control information based on the performance progress time information. When the execution time information represents an application timing corresponding to a reserved execution time or a performance progress time, the light-emitting device may temporarily store the light emission control information in a memory and apply the light emission control information at the application timing.

In the present specification, "production target information" may mean information representing a range of light-emitting devices to which light emission control information is to be applied, or a spatial target or a logical target on which light emission production is to be performed. The production target information may be used as reference information for generating information on a reception target range.

The production target information may include information indicating at least one of an overall performance space, a target area based on the performance space, a light-emitting device group, an individual light-emitting device, and a state condition of the light-emitting device. The production target information may not necessarily be limited to being determined by seat information or ticket information.

For example, the control device may identify at least one of a target area based on a performance space, a light-emitting device group, an individual light-emitting device, and a state condition of the light-emitting device from the production target information, and generate information on a reception target range based on the identified information.

In the present specification, "light emission effect information" may mean information representing a visual effect to be output by a light source device of a light-emitting device. The light emission effect information may be used as reference information for the control device to generate light emission control information.

The light emission effect information may include at least one of color information, brightness information, blinking information, blinking period information, blinking count information, fading information, pattern information, light emission maintenance time information, and an effect parameter. The light emission effect information may be included in the performance production information and may be converted into light emission control information within a light emission control packet.

For example, the light emission effect information may include at least one of: information for causing all light-emitting devices to be turned on in blue in a specific performance section; information for causing a specific light-emitting device group to blink at a predetermined period; and information for causing a specific light-emitting device to fade in or fade out in accordance with the performance progress time.

In the present specification, "light emission control information" may mean information for controlling a light source device of a light-emitting device. The light emission control information may be used to determine a method, a timing, or a state in which the light-emitting device emits light.

The light emission control information may include at least one of a color value, a brightness value, a blinking period, a blinking count, a fade-in time, a fade-out time, pattern identification information, an effect parameter, and a light emission maintenance time. The light emission control information may be included in a light emission control packet and may be used by a processor of the light-emitting device to control the light source device.

For example, the light-emitting device may control the light source device to emit light in a specific color based on the light emission control information. The light-emitting device may also control at least one of brightness, a blinking period, a fade time, and a pattern output of the light source device based on the light emission control information.

In the present specification, "information on a reception target range" may mean information representing a range of light-emitting devices to which a light emission control packet or light emission control information is to be applied. The information on the reception target range may be used as a reference for the control device to determine a transmission method, and may be used as a reference for the light-emitting device to determine whether a light emission control packet is a processing target packet.

The information on the reception target range may indicate a target category corresponding to at least one of all light-emitting devices, a light-emitting device group, and an individual light-emitting device. The information on the reception target range may be generated based on at least one of a target area based on a performance space, identification information of a light-emitting device group, identification information of an individual light-emitting device, and a state condition of the light-emitting device.

For example, the information on the reception target range may be information for causing all light-emitting devices to process a light emission control packet. As another example, the information on the reception target range may be information for causing a specific light-emitting device group or a specific light-emitting device to process a light emission control packet. The light-emitting device may determine whether a light emission control packet is a processing target packet by comparing the information on the reception target range with at least one of device identification information and current device correspondence information.

In the present specification, a "light emission control packet" may mean a data unit delivered from a control device or a repeater to a light-emitting device in order to control a light emission operation of the light-emitting device. The light emission control packet is not limited to a simple light emission command, and may include information for an application target of light emission control information, an application timing, determination of a transmission method, or determination of whether to process a packet.

The light emission control packet may include at least one of light emission control information, information on a reception target range, performance type information, and execution time information. Depending on embodiments, the light emission control packet may further include at least one of packet identification information, version information, error detection information, valid time information, and priority information.

For example, the control device may generate a light emission control packet based on performance production information. The control device may determine one of a plurality of transmission methods corresponding to different reception target ranges based on information on the reception target range included in the light emission control packet. The light-emitting device may determine whether a light emission control packet is a processing target packet based on the information on the reception target range included in the light emission control packet.

In the present specification, "execution time information" may mean information representing a timing at which light emission control information is to be applied to a light-emitting device. The execution time information may be used to distinguish a reception timing of a light emission control packet from an actual application timing of the light emission control information.

The execution time information may include at least one of immediate execution information, a reserved execution time, an application timing corresponding to a performance progress time, a valid time, and an expiration time. The execution time information may be generated by the control device based on performance progress time information, and may be used by the light-emitting device to determine an application timing of light emission control information.

For example, the light-emitting device may immediately apply light emission control information if the execution time information indicates immediate execution. If the execution time information indicates an application timing corresponding to a reserved execution time or a performance progress time, the light-emitting device may temporarily store the light emission control information in a memory and apply the light emission control information at the application timing. The light-emitting device may not apply the light emission control information if the execution time information includes a valid time or an expiration time and indicates that the validity of the light emission control packet has been lost.

In the present specification, a "transmission method" may mean a method indicating in which range of light-emitting devices among a plurality of light-emitting devices a light emission control packet is to be transmitted to be receivable. The transmission method may be determined based on information on a reception target range included in the light emission control packet.

The transmission method may be any one of a plurality of methods corresponding to different reception target ranges. For example, the transmission method may include at least one of a method receivable by all light-emitting devices, a method receivable by a light-emitting device group, and a method receivable by an individual light-emitting device. Depending on embodiments, the transmission method may be implemented as at least one of a broadcast method, a multicast method, and a unicast method.

For example, the control device may select one of a plurality of transmission methods based on a target category to which the reception target range belongs. The repeater may transmit a light emission control packet in a transmission method selected according to a transmission condition received from the control device.

In the present specification, a "transmission condition" may mean a condition applied when a repeater transmits a light emission control packet. The transmission condition may be determined by the control device and may be used to control which target, timing, priority, or repetition condition the repeater transmits a light emission control packet with.

The transmission condition may include at least one of a transmission method, a transmission target, a transmission timing, a transmission repetition count, a transmission priority, whether to re-transmit, and whether to perform calibration transmission. The transmission condition may be determined based on at least one of information on a reception target range of a light emission control packet, execution time information, priority information, and information on a transmission result.

For example, the control device may determine a transmission condition including at least one of a transmission timing, a transmission repetition count, and a transmission priority of a light emission control packet based on a relationship between an application timing indicated by execution time information and a current performance progress time. The control device may transmit the transmission condition to the repeater so that the repeater transmits the light emission control packet according to the transmission condition.

In the present specification, "information on a transmission result" may mean information representing a delivery, reception, processing, or light emission application state of a light emission control packet after the light emission control packet is transmitted. The information on the transmission result may be used as a reference for determining whether a subsequent transmission is necessary or a subsequent transmission condition.

The information on the transmission result may include at least one of packet identification information of a light emission control packet, transmission history information, reception state information collected from light-emitting devices, device state information of light-emitting devices, and valid time information of a light emission control packet. The information on the transmission result may be provided from the repeater or the light-emitting device to the control device, and may also be stored in the control device or the repeater.

For example, the control device may determine whether a subsequent transmission is necessary for a light emission control packet and a subsequent transmission condition based on the information on the transmission result of the light emission control packet. The light-emitting device may generate processing result information representing at least one of: whether a light emission control packet is received; whether it is a processing target packet; whether light emission control information is applied; whether an error occurs; and a current light emission state, and may transmit the processing result information to an external device.

In the present specification, a "subsequent transmission condition" may mean a condition indicating whether to perform repeated transmission, re-transmission, or calibration transmission after a light emission control packet is initially transmitted, and a method thereof. The subsequent transmission condition may be determined based on information on a transmission result of a light emission control packet.

The subsequent transmission condition may include information on at least one of a repeated transmission condition for the same light emission control packet, a re-transmission condition for a previously transmitted light emission control packet, and a transmission condition for a calibration packet indicating a light emission state corresponding to a current performance progress time. The subsequent transmission condition may be used to respond to at least one of packet loss, reception failure, error occurrence, execution time expiration, and inconsistency between a current light emission state and a target light emission state.

For example, the control device may determine a subsequent transmission condition to repeatedly transmit the same light emission control packet based on reception state information or device state information of a light-emitting device. The control device may determine a re-transmission condition when it is determined that a specific light-emitting device failed to receive a previous light emission control packet. The control device may also determine a calibration transmission condition to transmit a calibration packet indicating a light emission state corresponding to the current performance progress time.

In the present specification, "current device correspondence information" may mean information used to determine which target category or device group a light-emitting device currently corresponds to. The current device correspondence information may be used as reference information for determining whether a light emission control packet received by the light-emitting device is a processing target packet.

The current device correspondence information may include at least one of information on a light-emitting device group to which the light-emitting device currently belongs and current state information of the light-emitting device. The current device correspondence information may be updated based on at least one of a performance progress time, a previously received light emission control packet, group update information, and state information of the light-emitting device.

For example, the light-emitting device may determine whether a light emission control packet is a processing target packet applied to itself in any one of target categories corresponding to all light-emitting devices, a light-emitting device group, or an individual light-emitting device by comparing the information on the reception target range with at least one of device identification information and current device correspondence information. The current device correspondence information may not be limited to information fixedly mapped to seat information or ticket information, and may be changed according to a performance progress time or group update information.

In the present specification, a "processing target packet" may mean a packet determined to be applied to a light-emitting device among light emission control packets received by the light-emitting device. The processing target packet may be a target for which the light-emitting device determines an application timing or whether to apply light emission control information.

The processing target packet may be a light emission control packet applied to a specific light-emitting device in any one of target categories corresponding to all light-emitting devices, a light-emitting device group, or an individual light-emitting device. The processing target packet may be determined based on a comparison result of information on a reception target range and at least one of device identification information and current device correspondence information.

For example, if the light emission control packet is a processing target packet, the light-emitting device may determine an application timing of the light emission control information based on execution time information. If the light emission control packet is not a processing target packet, the light-emitting device may discard the light emission control packet or may not apply the light emission control information.

In the present specification, "light-emitting device control system" may refer to a system for controlling the light emission operations of a plurality of light-emitting devices in at least one space among a concert hall, a stadium, an outdoor event space, and a fan meeting venue. The light-emitting device control system may include at least one of a control device, a repeater, and a light-emitting device. Depending on the implementation form, the light-emitting device control system may further include at least one of a user terminal, a performance operation server, an external storage device, and a network device.

In the present specification, "control device" may refer to a device that processes performance production information, generates light emission control packets, and creates transmission schedules for light emission control packets in order to control a plurality of light-emitting devices. The control device may acquire performance production information from a performance operator, a director, a performance operation server, a performance control program, or a user interface device. The control device may determine at least one of a light emission control packet, a reception control interval, transmission resources, and a transmission schedule based on at least one of performance production information, information on a plurality of light-emitting device groups, and information on a plurality of repeaters.

In the present specification, "repeater" may refer to a device that receives a light emission control packet and a transmission schedule from the control device and transmits the light emission control packet to at least one of the plurality of light-emitting devices based on the transmission schedule. The repeater may include at least one of a wireless access point, a Wi-Fi HaLow access point, a gateway, a wireless transmission device, a wired/wireless bridge, and a transmission device. The repeater may transmit the light emission control packet using at least one of a long-range low-power wireless communication method, a sub-1GHz band wireless communication method, and an IEEE 802.11ah-based Wi-Fi HaLow communication method.

In the present specification, "light-emitting device" may refer to a device that receives a light emission control packet and emits light based on the received light emission control packet. The light-emitting device may be implemented as at least one of a cheering stick, a lighting device, a portable light-emitting device, a wearable light-emitting device, a seat-disposed light-emitting device, and a wireless lighting device. The light-emitting device may include at least one of a communication device, a light source device, a memory, a processor, and a power supply device.

In the present specification, "performance production information" may refer to information used to control the light emission operations of a plurality of light-emitting devices in accordance with the progress of a performance. The performance production information may include at least one of performance progress time information, production target information, and light emission effect information. The performance production information may be used as reference information for the control device to generate or determine at least one of a light emission control packet, a target light-emitting device group, a reception control interval, transmission resources, and a transmission schedule.

In the present specification, "performance progress time information" may refer to information representing a temporal progress state of a performance or an application timing of a specific light emission operation within a performance. The performance progress time information may include at least one of a performance reference time, an elapsed time after the start of a performance, performance section information, a scene start time, a song start time, a reserved execution time, and a current performance progress time.

In the present specification, "light emission effect information" may refer to information representing a visual effect to be output by a light source device of a light-emitting device. The light emission effect information may include at least one of color information, brightness information, blinking information, blinking period information, blinking count information, fading information, pattern information, light emission maintenance time information, and an effect parameter.

In the present specification, "light emission control information" may refer to information for controlling a light source device of a light-emitting device. The light emission control information may include at least one of a color value, a brightness value, a blinking period, a blinking count, a fade-in time, a fade-out time, pattern identification information, an effect parameter, and a light emission maintenance time.

In the present specification, "light emission control packet" may refer to a data unit delivered from a control device or a repeater to a light-emitting device in order to control the light emission operation of the light-emitting device. The light emission control packet may include at least one of light emission control information, execution time information, priority information, internal application criteria information, packet identification information, error detection information, valid time information, transmission target information, and device group information.

In the present specification, "execution time information" may refer to information representing a timing at which light emission control information is to be applied to a light-emitting device. The execution time information may include at least one of immediate execution information, a reserved execution time, an application timing corresponding to a performance progress time, a valid time, and an expiration time.

In the present specification, "light-emitting device group" may refer to a set of a plurality of light-emitting devices treated as a single communication or scheduling unit. The light-emitting device group may be determined based on at least one of a target area based on a performance space, a seat area, a block, a row, a column, a floor, a subgroup, communication quality, reception state, device state, or a performance production purpose. The light-emitting device group is not limited to a group fixed by seat information or ticket information.

In the present specification, "information on a light-emitting device group" may refer to information used to identify a light-emitting device group or to control communication for a light-emitting device group. The information on the light-emitting device group may include at least one of identification information of the light-emitting device group, a location of the light-emitting device group, the number of light-emitting devices belonging to the light-emitting device group, a reception control interval of the light-emitting device group, subgroup information of the light-emitting device group, reception state information of the light-emitting device group, and a reception failure history of the light-emitting device group.

In the present specification, "information on a repeater" may refer to information used to identify a repeater or to control the transmission of a repeater. The information on the repeater may include at least one of repeater identification information, a location of the repeater, a transmittable range of the repeater, congestion of the repeater, a reception failure history of the repeater, a transmission channel of the repeater, a transmission resource division method of the repeater, a supported communication method of the repeater, and an operating state of the repeater.

In the present specification, "target light-emitting device group" may refer to a light-emitting device group determined as a target to which a light emission control packet is to be transmitted. The target light-emitting device group may be determined based on at least one of performance production information, information on a light-emitting device group, state information of a light-emitting device, reception failure information, and a user input of the control device.

In the present specification, "reception control interval" may refer to a time interval set so that a light-emitting device belonging to a target light-emitting device group can receive a light emission control packet or perform communication operations related to the reception of a light emission control packet. The reception control interval may include at least one of downlink transmission resources and uplink response resources. The reception control interval may be set as an interval corresponding to a specific light-emitting device group, or may be set as a common reception control interval receivable by a plurality of light-emitting device groups in common.

In the present specification, "reception interval" may refer to an interval in which a light-emitting device belonging to a target light-emitting device group activates a communication device to receive a light emission control packet. The reception interval may include a wake-up interval in which a light-emitting device performing a low-power operation activates a communication device at a predetermined timing.

In the present specification, "restricted access interval" may refer to an interval in which communication access of a light-emitting device belonging to a target light-emitting device group is allowed. The restricted access interval may be used to allow communication access for a specific light-emitting device group or a specific set of devices and restrict communication access for other light-emitting device groups.

In the present specification, "Target Wake Time (TWT)" may correspond to a reception interval or a wake-up interval for causing a light-emitting device to activate a communication device at a designated time and maintain a low-power state at other times. In the present specification, TWT may be described as a specific example of an IEEE 802.11ah-based Wi-Fi HaLow communication method and may be modified into other low-power reception control methods.

In the present specification, "Restricted Access Window (RAW)" may correspond to a restricted access interval set so that a specific light-emitting device group or a specific set of light-emitting devices can perform communication access. In the present specification, RAW may be described as a specific example of an IEEE 802.11ah-based Wi-Fi HaLow communication method and may be modified into other group-based access control methods.

In the present specification, "transmission resource" may refer to time, frequency, space, channel, beam, slot, band, or a communication opportunity used by a repeater to transmit a light emission control packet. Transmission resources may be arranged within a reception control interval. Transmission resources may include at least one of common transmission resources, split transmission resources, downlink transmission resources, and backup transmission resources.

In the present specification, "transmission schedule" may refer to information representing at least one of an arrangement of transmission resources, a transmission timing, a transmission target, a transmission channel, a transmission repetition count, a transmission priority, a primary repeater, a secondary repeater, and backup transmission resources, used by the repeater to transmit a light emission control packet. The transmission schedule may be generated such that a transmission resource corresponding to a light emission control packet is arranged within a reception control interval corresponding to a target light-emitting device group.

In the present specification, "downlink transmission resource" may refer to a transmission resource used by a repeater to transmit a light emission control packet to a light-emitting device. Downlink transmission resources may be arranged within a reception control interval.

In the present specification, "uplink response resource" may refer to a communication resource used by a light-emitting device to transmit reception state information, processing result information, or device state information to a repeater or a control device. Uplink response resources may be arranged within a reception control interval together with downlink transmission resources.

In the present specification, "common light emission control information" may refer to light emission control information applied in common to a plurality of light-emitting devices belonging to a target light-emitting device group. The common light emission control information may be information for causing a plurality of light-emitting devices belonging to a target light-emitting device group to operate according to the same color, brightness, blinking, fading, pattern, or light emission maintenance time.

In the present specification, "differential light emission control information" may refer to light emission control information applied differently within a target light-emitting device group. The differential light emission control information may include at least one of light emission control information for each subgroup, light emission control information for each individual light-emitting device, light emission control information for each location, light emission control information for each row/column, and light emission control information for each pattern index.

In the present specification, "common transmission resource" may refer to a transmission resource used to transmit common light emission control information. The common transmission resource may be arranged within a reception control interval so that a plurality of light-emitting devices belonging to a target light-emitting device group can receive the same light emission control information.

In the present specification, "split transmission resource" may refer to a plurality of transmission resources split within one reception control interval to transmit a plurality of pieces of differential light emission control information. Different pieces of differential light emission control information may be assigned to each of the split transmission resources. Split transmission resources may be set based on at least one of the data amount of the differential light emission control information, the number of subgroups to which the differential light emission control information is to be applied, and the size of the internal application criteria information.

In the present specification, "time division transmission resource" may refer to a split transmission resource distinguished by different time slots. Time division transmission resources may be used to temporally distinguish and transmit differential light emission control information corresponding to different subgroups or different light-emitting devices.

In the present specification, "frequency division transmission resource" may refer to a split transmission resource distinguished by different frequency bands, subchannels, or tone groups. Frequency division transmission resources may be implemented as an OFDMA method or a similar frequency resource division method.

In the present specification, "spatial division transmission resource" may refer to a split transmission resource distinguished by different transmission directions, beams, antenna patterns, spatial streams, or transmittable ranges. Spatial division transmission resources may be implemented as a MU-MIMO method, a beamforming method, or a similar spatial resource division method.

In the present specification, "internal application criteria information" may refer to reference information used by a light-emitting device belonging to a light-emitting device group to select or calculate light emission control information to be applied to itself. Internal application criteria information may be compared with at least one of subgroup identification information, device identification information, a location index, a row/column index, a pattern index, mask information, and state information stored in the light-emitting device.

In the present specification, "device correspondence information" may refer to information representing which light-emitting device group, subgroup, location, row, column, pattern index, mask, or state a light-emitting device corresponds to. Device correspondence information may be stored in a memory of a light-emitting device. The light-emitting device may select or calculate light emission control information to be applied to itself by comparing the internal application criteria information with the device correspondence information.

In the present specification, "subgroup" may refer to a set of light-emitting devices subdivided within one light-emitting device group. Subgroups may be set based on location, row, column, seat block, pattern index, device identification information, communication state, reception state, or light emission effect.

In the present specification, "primary repeater" may refer to a repeater determined to primarily perform transmission of a light emission control packet for a target light-emitting device group. The primary repeater may be determined based on a result of comparing the location of the target light-emitting device group with the transmittable range of each of a plurality of repeaters.

In the present specification, "secondary repeater" may refer to a repeater determined to supplement or back up the transmission of the primary repeater. The secondary repeater may be determined when a target light-emitting device group is included in the transmittable range of two or more repeaters. The secondary repeater may be determined based on at least one of congestion, a reception failure history, a transmittable range, or communication quality.

In the present specification, "backup transmission resource" may refer to a transmission resource allocated to a secondary repeater to respond to transmission failure of the primary repeater, an increase in reception failure rate, an increase in congestion, or a decrease in communication quality. Backup transmission resources may be increased or added in the next cycle.

In the present specification, "reception state information" may refer to information representing whether a light-emitting device has normally received a light emission control packet or the reception quality. Reception state information may include at least one of whether a packet is received, packet identification information, whether an error occurs, reception strength, signal quality, whether it is a processing target packet, and whether light emission control information is applied.

In the present specification, "processing result information" may refer to information representing a processing result performed by a light-emitting device after receiving a light emission control packet. Processing result information may include at least one of whether a light emission control packet is received, a result of validity verification, a result of comparison of internal application criteria information, a result of selection of light emission control information, whether light emission control information is applied, whether an error occurs, and a current light emission state.

In the present specification, "reception failure rate" may refer to a value representing a ratio of light-emitting devices that have not normally received a light emission control packet among light-emitting devices belonging to a target light-emitting device group or a degree of reception failure. The reception failure rate may be calculated based on reception state information collected through uplink response resources.

In the present specification, "transmission schedule update" may refer to an operation of changing a reception control interval or a transmission resource of a next cycle based on at least one of reception state information, processing result information, a reception failure rate, congestion of a repeater, a reception failure history of a repeater, or a current performance progress time. Transmission schedule update may include at least one of increasing the length of a reception control interval, increasing the number of downlink transmission resources, increasing the number of repeated transmissions, and adding or increasing backup transmission resources.

In the present specification, "common reception control interval" may refer to a reception control interval receivable by a plurality of light-emitting device groups in common. The common reception control interval may be used when the time remaining until the execution timing of the light emission control packet is equal to or less than a reference time, when the priority of the light emission control packet is equal to or higher than a reference priority, or when spontaneous production, emergency control, or global synchronization is required.

In the present specification, "priority information" may refer to information for determining a transmission order or a processing order of light emission control packets. Priority information may be used to distinguish at least one of spontaneous production, emergency control, global synchronization, general production control, calibration control, and state verification.

In the present specification, "repetition count" may refer to the number of times the same light emission control packet or a packet corresponding to the same light emission control information is repeatedly transmitted. The repetition count may be determined or updated based on at least one of the priority of the light emission control packet, the time remaining until the execution timing, the reception failure rate of the target light-emitting device group, the congestion of the repeater, or communication quality.

In the present specification, a "light-emitting device control system" may mean a system for controlling the light emission operations of a plurality of light-emitting devices. The light-emitting device control system may be implemented as an information output device control system for controlling output operations of a plurality of information output devices, depending on embodiments. For example, the light-emitting device control system may be implemented as a display device control system or an electronic shelf label control system for controlling or updating display content of a plurality of display devices or a plurality of electronic shelf labels. In this case, the control of a light-emitting device may include at least one of update of display content, display of product information, output of advertisement information, output of guidance information, and output of sound information.

In the present specification, an "information output device" may mean a device that outputs information recognizable by a user or an external observer. The information output device may include at least one of a light-emitting device that emits light to provide a visual effect, a display device that displays visual information through a screen or a panel, and a sound output device that outputs sound. For example, the information output device may be implemented as at least one of a cheering stick, a lighting device, a wireless lighting device, a display device, an electronic shelf label, an electronic paper display device, a store guidance display device, a shelf-attached display device, a product information display device, an advertisement display device, and a display device including a sound output unit.

In the present specification, a "display device" may mean an information output device that receives a control packet from an external device and displays visual information based on the received control packet. The display device may include at least one of an electronic shelf label, an electronic paper display device, a liquid crystal display device, an LED display device, an OLED display device, a store guidance display device, a shelf-attached display device, a product information display device, and an advertisement display device. The display device may include at least one of a communication device, a display panel, a memory, a processor, a power supply device, and a sound output unit.

In the present specification, an "electronic shelf label" or "ESL (Electronic Shelf Label)" may mean a display device disposed in a store, a warehouse, a logistics space, or a display space for displaying price information, product name information, discount information, inventory information, product identification codes, barcodes, QR codes, promotion information, guidance information, advertisement information, or logistics management information of products. An electronic shelf label may be attached to or disposed at at least one of a display rack, a shelf, a shelf tier, a product placement area, a refrigerated display case, a warehouse rack, an aisle, a checkout counter surrounding area, or a promotion area.

In the present specification, descriptions regarding a light-emitting device may be correspondingly applied to a display device, an electronic shelf label, or an information output device within a range that is not technically contradictory. For example, a light source device of a light-emitting device may be replaced with a display panel of a display device or an output unit of an information output device, light emission control information may be replaced with display control information or output control information, and a light emission operation may be replaced with a display content update operation, an information display operation, or a sound output operation. In addition, a light-emitting device group may be replaced with a display device group, an electronic shelf label group, or an information output device group, and a light emission control packet may be replaced with a display control packet or an output control packet.

In the present specification, "output control information" may mean information for controlling visual information or sound information to be output by an information output device. The output control information may include light emission control information, display control information, sound control information, or a combination thereof. The output control information may include at least one of color information, brightness information, blinking information, price information, product name information, discount information, promotion information, inventory information, product identification codes, image information, text information, display layout information, voice guidance information, advertisement voice information, volume information, sound output timing information, and output maintenance time information.

In a display device control system or an electronic shelf label control system, information on a reception target range may represent a range of information output devices to which an output control packet, a display control packet, output control information, or display control information is to be applied. The information on the reception target range may be generated based on at least one of all display devices, a display device group, an individual display device, a store area, a display rack, a shelf, a product group, product identification information, an electronic shelf label group, an individual electronic shelf label, and a state condition of an information output device. A display device or an electronic shelf label may determine whether a display control packet or an output control packet is a packet applicable to itself by comparing the information on the reception target range with at least one of device identification information, device group identification information, product identification information, spatial correspondence information, and current device correspondence information.

In the present specification, an "output control packet" may mean a data unit delivered from a control device or a repeater to an information output device in order to control or update the output operation of the information output device. The output control packet may include at least one of output control information, display control information, sound control information, update timing information, information on a reception target range, device group information, device identification information, product identification information, priority information, packet identification information, error detection information, and valid time information.

In a display device control system or an electronic shelf label control system, an information output device group may mean a set of a plurality of information output devices, display devices, or electronic shelf labels treated as a single communication unit, scheduling unit, update unit, or management unit. The information output device group may be determined based on at least one of a store area, a display rack, a shelf, a product group, a product category, an update priority, communication quality, a reception state, a display state, an output state, and an operation policy.

In a display device control system or an electronic shelf label control system, a reception control interval may be a time interval set so that a display device group, an electronic shelf label group, or an information output device group can activate a communication device to receive an output control packet or a display control packet, or can perform communication operations related to packet reception. The reception control interval may be set or updated based on at least one of an update timing, an update priority, a data amount of output control information, a data amount of display control information, the number of information output device groups, a battery state of an electronic shelf label, communication quality, and a past reception failure history.

In a display device control system or an electronic shelf label control system, internal application criteria information may be used by an information output device belonging to an information output device group to select or calculate output control information or display control information to be applied to itself. The information output device may select or calculate output control information or display control information to be applied to itself by comparing the internal application criteria information included in the output control packet with at least one of device identification information, product identification information, display rack identification information, shelf identification information, display screen version information, and output state information.

In a display device control system or an electronic shelf label control system, performance space information may be replaced with or extended to store space information, display space information, warehouse space information, logistics space information, or facility space information. The store space information may include at least one of a store floor plan, display rack arrangement information, shelf position information, shelf tier information, product placement information, product category information, aisle information, rack information, refrigerated display case information, checkout counter surrounding area information, promotion zone information, and information output device arrangement information.

In a display device control system or an electronic shelf label control system, a transmission target spatial area may mean a store space, a display rack area, a shelf area, a product placement area, an information output device arrangement area, a display device arrangement area, or an electronic shelf label arrangement area determined as a target to which an output control packet or a display control packet is to be transmitted. The control device may determine a transmission target spatial area by mapping display update information, output update information, or update target indication information to the store space information, and may determine beam transmission conditions corresponding to the transmission target spatial area.

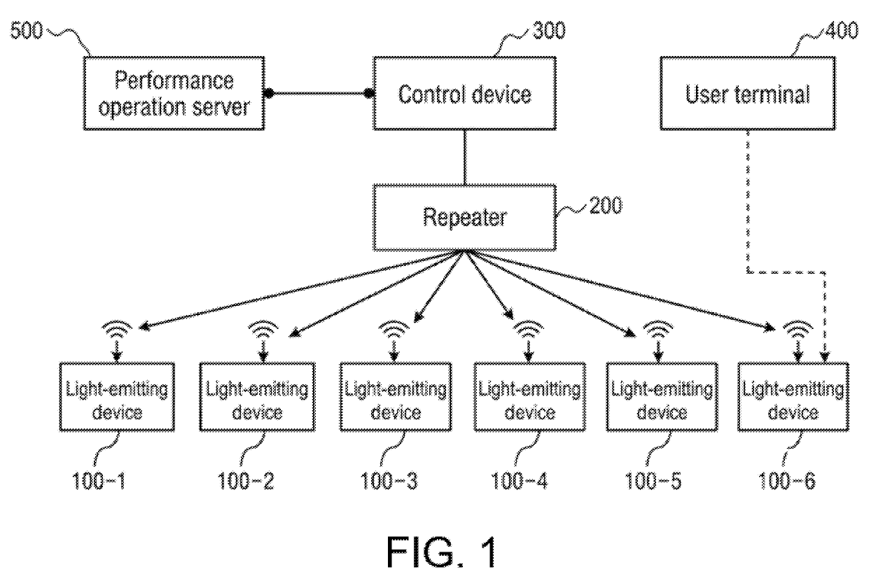

FIG. 1 is a diagram illustrating an overall configuration of a light-emitting device control system according to some exemplary embodiments. The light-emitting device control system of the present disclosure may be a system for controlling light emission operations of a plurality of light-emitting devices 100 based on performance production information. The light-emitting device control system may be used in at least one space among a concert hall, a stadium, an outdoor event space, and a fan meeting venue.

Referring to FIG. 1, the light-emitting device control system may include at least one of a plurality of light-emitting devices 100, a repeater 200, a control device 300, a user terminal 400, and a performance operation server 500.

The control device 300 may acquire performance production information from the performance operation server 500, the user terminal 400, a performance control program, or an external storage device. The control device 300 may generate a light emission control packet based on the performance production information, and determine a transmission method and a transmission condition based on a reception target range of the light emission control packet.

The repeater 200 may receive the light emission control packet and the transmission condition from the control device 300. The repeater 200 may transmit the light emission control packet to at least one of the plurality of light-emitting devices 100 according to the transmission condition. For example, the repeater 200 may transmit the light emission control packet targeting all light-emitting devices, a specific light-emitting device group, or an individual light-emitting device.

The plurality of light-emitting devices 100 may receive the light emission control packet from the repeater 200 or an external device. The light-emitting device 100 may determine whether the light emission control packet is a processing target packet based on information on a reception target range included in the light emission control packet. If the light emission control packet is a processing target packet, the light-emitting device 100 may determine an application timing of light emission control information based on execution time information and control a light source device at the application timing.

The user terminal 400 may perform at least one of initial setting of the light-emitting device 100, state confirmation, user input, confirmation of performance information, and confirmation of device status. The light-emitting device 100 may perform a light emission operation by receiving the light emission control packet from the repeater 200 even in a state in which it is not connected to the user terminal 400.

The performance operation server 500 may provide performance production information, performance progress time information, light emission effect information, or data linked with the performance control program to the control device 300. The control device 300 may generate a light emission control packet corresponding to a performance progress situation using the information provided from the performance operation server 500.

The light-emitting device control system of FIG. 1 may have a structure in which: the control device 300 determines a transmission method and a transmission condition based on a reception target range of a light emission control packet; the repeater 200 transmits the light emission control packet according to the determined transmission condition; and the light-emitting device 100 performs a light emission operation by determining whether the received light emission control packet is a processing target and an application timing thereof.

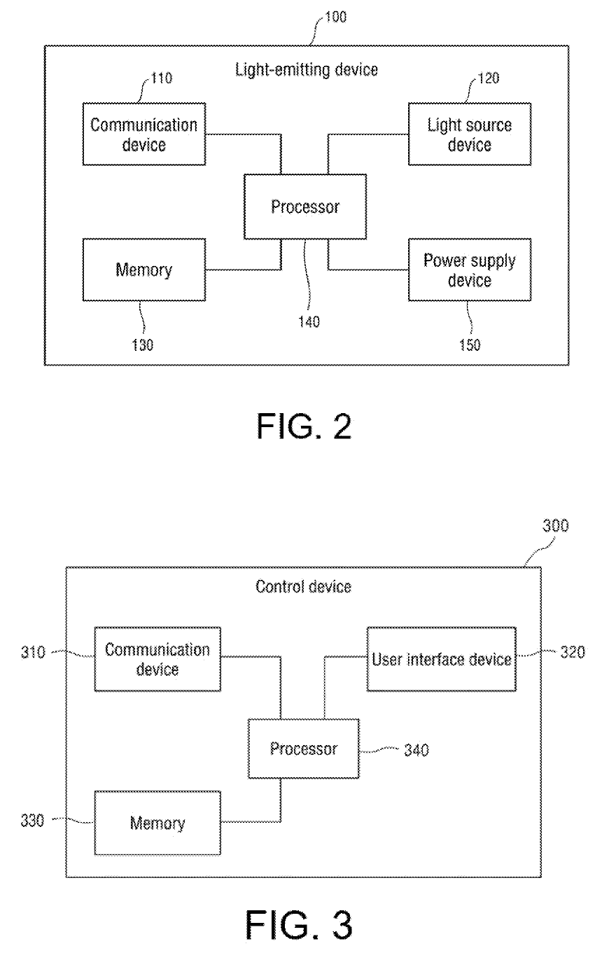

FIG. 2 is a block diagram illustrating a configuration of a light-emitting device 100 according to some exemplary embodiments. The light-emitting device 100 may be a device that receives a light emission control packet from an external device and emits light based on the received light emission control packet. The light-emitting device 100 may be carried by an audience member, disposed at a spectator seat, or installed at a specific position within a performance space in at least one space among a concert hall, a stadium, an outdoor event space, and a fan meeting venue. For example, the light-emitting device 100 may be implemented as at least one of a cheering stick, a portable lighting device, a wearable lighting device, a seat-disposed lighting device, and a wireless lighting device.

Referring to FIG. 2, the light-emitting device 100 may include at least one of a communication device 110, a light source device 120, a memory 130, a processor 140, and a power supply device 150. The communication device 110 may transmit and receive data to and from an external device. The light source device 120 may emit light under the control of the processor 140. The memory 130 may store information necessary for the operation of the light-emitting device 100. The processor 140 may process a light emission control packet and control a light emission operation of the light source device 120. The power supply device 150 may supply power to each component of the light-emitting device 100. The smart device connection device may communicate with a smart device of a user and receive user setting information from the smart device.

The communication device 110 may be a configuration for the light-emitting device 100 to communicate with at least one of a repeater 200, a control device 300, a user terminal 400, and another light-emitting device. For example, the communication device 110 may receive a light emission control packet from the repeater 200. The communication device 110 may communicate with the user terminal 400 to transmit and receive at least one of setting information, state information, performance information, user input information, and firmware update information of the light-emitting device 100.

The communication device 110 may be implemented as a single communication circuit or as a plurality of communication circuits supporting different communication methods. For example, the communication device 110 may support at least one of a long-range low-power wireless communication method, a sub-1GHz band wireless communication method, an IEEE 802.11ah-based Wi-Fi HaLow communication method, a short-range wireless communication method, a standard wireless LAN method, a Bluetooth communication method, and a wired communication method. The communication device 110 may receive a light emission control packet corresponding to a production change made during a performance in real-time or quasi-real-time using Wi-Fi HaLow communication.

The light source device 120 may be a configuration for performing a light emission operation of the light-emitting device 100. The light source device 120 may output a light emission effect corresponding to at least one of color, brightness, blinking, fading, a pattern, and a light emission maintenance time under the control of the processor 140. For example, the light source device 120 may emit light in a specific color, blink at a specific period, or change brightness for a predetermined time in accordance with a performance progress time.

The light source device 120 may include a single light source or a plurality of light sources. For example, the light source device 120 may include at least one of an LED (Light Emitting Diode), an RGB LED, a micro LED, an OLED (Organic Light Emitting Diode), a QLED (Quantum Dot Light Emitting Diode), a laser diode, a halogen lamp, an incandescent bulb, a fluorescent lamp, a light source driving circuit, a light diffusing member, and an optical cover. The light source device 120 may include a plurality of light sources corresponding to different colors, or may include a plurality of light sources disposed at different positions of the light-emitting device 100.

The light source device 120 may further include at least one optical component for controlling diffusion or focusing of light. For example, the light source device 120 may include at least one of a lens, a diffuser, and a reflector, and may irradiate light in a specific pattern or shape using the optical component. Accordingly, the light source device 120 may implement a more diverse and three-dimensional light emission production.

The memory 130 may be a configuration for storing information necessary for the operation of the light-emitting device 100. The memory 130 may store at least one of device identification information, current device correspondence information, a light emission control packet, light emission control information, execution time information, packet identification information, version information, error detection information, valid time information, processing result information, and a current light emission state. The memory 130 may also store instructions or a program that can be executed by the processor 140.

The memory 130 may store information received before or during a performance. For example, the memory 130 may store setting information received from the user terminal 400 or an external device before the start of a performance. The memory 130 may temporarily store a light emission control packet received from the repeater 200 during a performance. When execution time information represents an application timing corresponding to a reserved execution time or a performance progress time, the memory 130 may temporarily store the light emission control information until the application timing.

The current device correspondence information may be information for determining which light-emitting device group or target category the light-emitting device 100 currently corresponds to. The current device correspondence information may include at least one of information on a light-emitting device group to which the light-emitting device 100 currently belongs and current state information of the light-emitting device 100. The current device correspondence information may be updated based on at least one of a performance progress time, a previously received light emission control packet, group update information, and state information of the light-emitting device 100. For example, the light-emitting device 100 may update the current device correspondence information to belong to a first light-emitting device group in a first performance section and to belong to a second light-emitting device group in a second performance section.

The processor 140 may be a configuration for controlling the operation of the light-emitting device 100. The processor 140 may execute instructions stored in the memory 130 to control an operation of at least one of the communication device 110, the light source device 120, the memory 130, and the power supply device 150. For example, the processor 140 may be implemented as at least one of a microcontroller, a central processing unit (CPU), a digital signal processor (DSP), a dedicated circuit, and a programmable logic circuit.

Upon receiving a light emission control packet, the processor 140 may determine at least one of integrity, redundancy, and validity of the light emission control packet. For example, the processor 140 may determine the reliability of the light emission control packet based on at least one of packet identification information, version information, error detection information, and valid time information. The processor 140 may not process a light emission control packet in which an error is detected, an already processed light emission control packet, a previous version of a light emission control packet, or a light emission control packet for which a valid time has elapsed.

The processor 140 may determine whether the light emission control packet is a processing target packet based on information on a reception target range included in the light emission control packet. For example, the processor 140 may compare the information on the reception target range with at least one of device identification information and current device correspondence information. Based on a comparison result, the processor 140 may determine whether a light emission control packet corresponding to all light-emitting devices, a specific light-emitting device group, or an individual light-emitting device is applied to the light-emitting device 100.

If the light emission control packet is a processing target packet, the processor 140 may determine an application timing of the light emission control information based on execution time information. For example, the processor 140 may immediately apply the light emission control information if the execution time information indicates immediate execution. If the execution time information indicates an application timing corresponding to a reserved execution time or a performance progress time, the processor 140 may temporarily store the light emission control information in the memory 130 and apply the light emission control information at the application timing. The processor 140 may not apply the light emission control information if it is determined that the validity of the light emission control packet has been lost based on the execution time information or the valid time information.

The processor 140 may control the light source device 120 based on the light emission control information at the application timing. For example, the processor 140 may control the light source device 120 to emit light in a specific color based on the light emission control information. The processor 140 may also control the light source device 120 to output a designated brightness, a designated blinking period, a designated fade effect, or a designated pattern effect based on the light emission control information.

The processor 140 may generate processing result information of the light emission control packet. The processing result information may represent at least one of: whether the light emission control packet is received; whether it is a processing target packet; whether the light emission control information is applied; whether an error occurs; and a current light emission state. The processing result information may be stored in the memory 130 or may be transmitted to an external device through the communication device 110. The processing result information may be used for at least one of repeated transmission, re-transmission, calibration transmission, state confirmation, and synchronization calibration.

The power supply device 150 may be a configuration for supplying power to each component of the light-emitting device 100. The power supply device 150 may supply operating power to at least one of the communication device 110, the light source device 120, the memory 130, and the processor 140. For example, the power supply device 150 may include at least one of a primary battery, a secondary battery, a charging circuit, a power management circuit, and an external power connection terminal.

The power supply device 150 may adjust a power supply state based on at least one of a usage time, light emission brightness, a communication operation state, a reception standby state, and a remaining battery amount of the light-emitting device 100. For example, the power supply device 150 may adjust power consumption of the communication device 110 or the light source device 120 under the control of the processor 140. The power supply device 150 may supply power necessary for the communication device 110 while the light-emitting device 100 is in the reception standby state and may limit the power supply to the light source device 120.

The light-emitting device 100 may be connected to the user terminal 400. The user terminal 400 may be at least one of a smartphone, a tablet, a wearable device, and a portable computing device. For example, the communication device 110 may be connected to the user terminal 400 through a Bluetooth communication method or a standard wireless LAN method, and may be connected to the repeater 200 through a Wi-Fi HaLow communication method. The light-emitting device 100 may perform a light emission operation by receiving a light emission control packet from an external device even in a state in which it is not connected to the user terminal 400.

The light-emitting device control system may include at least one of a plurality of light-emitting devices 100-1, 100-2, 100-3, 100-4, 100-5, 100-6, a repeater 200, a control device 300, a user terminal 400, and a performance operation server 500.

The light-emitting device control system may be a system for controlling light emission operations of a plurality of light-emitting devices 100-1, 100-2, 100-3, 100-4, 100-5, 100-6 in at least one space among a concert hall, a stadium, an outdoor event space, and a fan meeting venue. The light-emitting device control system may control the plurality of light-emitting devices to output at least one of color, brightness, blinking, fading, and patterns in accordance with the performance progress time.

The control device 300 may acquire performance production information from at least one of the performance operation server 500, the user terminal 400, a performance control program, and an external storage device. The control device 300 may generate a light emission control packet based on the performance production information.

The performance operation server 500 may provide at least one of performance production information, performance progress time information, light emission effect information, and data linked with a performance control program to the control device 300. For example, the performance operation server 500 may provide at least one of a song start time, a scene transition time, performance section information, and production effect data to the control device 300. The control device 300 may generate a light emission control packet corresponding to a performance progress situation based on the information provided from the performance operation server 500.

The repeater 200 may receive a light emission control packet from the control device 300 and transmit the received light emission control packet to at least one of the plurality of light-emitting devices 100-1, 100-2, 100-3, 100-4, 100-5, 100-6. The repeater 200 may be connected to the control device 300 through at least one of a wired communication method, a wireless communication method, and a mixed wired/wireless communication method.

The plurality of light-emitting devices 100-1, 100-2, 100-3, 100-4, 100-5, 100-6 may receive light emission control packets from the repeater 200 or an external device. The plurality of light-emitting devices may emit light based on light emission control information included in the received light emission control packet. For example, light-emitting device 100-1 may emit light in a specific color based on the received light emission control packet, and light-emitting device 100-2 may emit light at a specific blinking period based on the received light emission control packet.

The user terminal 400 may perform at least one of initial setting of the light-emitting device, state verification, user input, verification of performance information, and verification of device status. The user terminal 400 may be connected to the light-emitting device through a wired communication method or a short-range wireless communication method. For example, the user terminal 400 may verify or update at least one of device identification information of the light-emitting device, user setting information, performance participation information, and device state information.

The user terminal 400 may be implemented as at least one of a smartphone, a tablet computer, a wearable device, a Personal Digital Assistant (PDA), a laptop computer, a smart watch, and a smart glass. However, the present disclosure is not limited thereto, and the user terminal 400 may be implemented as any computing device capable of executing an application for performing at least one of initial setting of the light-emitting device 100, state verification, and user input.

The light-emitting devices 100-1, 100-2, 100-3, 100-4, 100-5, 100-6 may perform light emission operations by receiving light emission control packets from the repeater 200 even in a state in which they are not connected to the user terminal 400. The user terminal 400 may be used for initial registration or auxiliary setting of the light-emitting device, and the transmission path of the light emission control packet during a performance may not necessarily be limited to passing through the user terminal 400.

The user terminal 400 may operate as a relay device that transmits state information of the light-emitting device 100 to the control device 300. For example, the user terminal 400 may collect, through a short-range wireless communication method, state information including at least one of a remaining battery level, a communication reception sensitivity, a current operation mode, and a communication connection state from the light-emitting device 100. The user terminal 400 may transmit the collected state information to the control device 300 through at least one of a cellular communication network and a Wi-Fi network. Through this transmission path, a bi-directional communication system may be established between the light-emitting device 100 and the control device 300 with the user terminal 400 interposed therebetween.

The control device 300 may dynamically modify the performance production information based on the state information received through the user terminal 400. For example, when state information indicating that a remaining battery level of a specific light-emitting device 100 is equal to or less than a reference value is received, the control device 300 may change the performance production information such that energy consumption of the specific light-emitting device 100 is reduced, and generate a light emission control packet based on the changed performance production information. As another example, the control device 300 may identify a light-emitting device 100 in which a communication reception sensitivity is equal to or less than a reference value based on the state information, and adjust at least one of a transmission method, a transmission repetition count, and a primary repeater for a light-emitting device group including the corresponding light-emitting device 100.

The control device 300 may acquire information on a plurality of light-emitting device groups and information on a plurality of repeaters, and generate light emission control packets based on performance production information. The control device 300 may determine a reception control interval corresponding to a target light-emitting device group among the plurality of light-emitting device groups and generate a transmission schedule for the repeater 200 such that transmission resources corresponding to the light emission control packets are arranged within the reception control interval. The control device 300 may transmit the light emission control packet and the transmission schedule to the repeater 200.

For example, the control device 300 may manage the plurality of light-emitting devices 100-1, 100-2, 100-3, 100-4, 100-5, 100-6 as one or more light-emitting device groups. The control device 300 may determine whether a specific light-emitting device group is within the transmittable range of the repeater 200. The control device 300 may generate a transmission schedule such that at least one of downlink transmission resources, uplink response resources, common transmission resources, and split transmission resources is arranged within a reception control interval corresponding to a specific light-emitting device group.

For example, when global synchronization of the performance is required, the control device 300 may arrange transmission resources of light emission control packets in a common reception control interval receivable by a plurality of light-emitting device groups in common. When differential control for a specific light-emitting device group is required, the control device 300 may arrange a plurality of split transmission resources within a reception control interval of the specific light-emitting device group. The repeater 200 may verify whether a transmission resource included in the transmission schedule is arranged within the reception control interval and transmit light emission control packets to the target light-emitting device group based on a result of the verification.

The light-emitting device control system of FIG. 1 may have a structure in which the control device 300 generates a transmission schedule that aligns reception control intervals for each light-emitting device group with transmission resources for each repeater, and the repeater 200 transmits light emission control packets according to the transmission schedule. The light-emitting devices 100-1, 100-2, 100-3, 100-4, 100-5, 100-6 may activate communication devices in reception control intervals corresponding to the light-emitting device groups to which they belong and control light source devices based on received light emission control packets.

The light-emitting device 100 may not necessarily be limited to including all of the components shown in FIG. 2. Depending on the implementation form, the light-emitting device 100 may include more components than the components shown in FIG. 2, or may include only some of the components shown in FIG. 2. For example, the light-emitting device 100 may further include at least one of a sensor, a vibration device, a display device, a speaker, an input device, a positioning device, a charging terminal, and a housing.

The light-emitting device 100 of FIG. 2 may not be limited to a device that simply receives and immediately executes a light emission control packet. The light-emitting device 100 may perform reliability determination of a light emission control packet, determination of whether it is a processing target packet, determination of an application timing based on execution time information, and control of a light source device at the application timing. By updating current device correspondence information according to a performance progress time or group update information, the light-emitting device 100 may selectively process light emission control packets corresponding to different light-emitting device groups according to a performance progress situation.

The light-emitting device 100 may include at least one of a communication device 110, a light source device 120, a memory 130, a processor 140, a power supply device 150, and a smart device connection device.

The light-emitting device 100 may be a device that receives a light emission control packet from a repeater or an external device and emits light based on the received light emission control packet. The light-emitting device 100 may be used in at least one space among a concert hall, a stadium, an outdoor event space, and a fan meeting venue.

The communication device 110 may be a component for the light-emitting device 100 to communicate with at least one of a repeater, a control device, a user terminal, and another light-emitting device. The communication device 110 may receive light emission control packets from the repeater. The communication device 110 may communicate with the user terminal to transmit and receive at least one of setting information of the light-emitting device 100, device identification information, performance information, user input information, and device state information.

The communication device 110 may be implemented as a single communication circuit, or may be implemented as a plurality of communication circuits supporting different communication methods. For example, the communication device 110 may support at least one of a long-range low-power wireless communication method, a sub-1GHz band wireless communication method, an IEEE 802.11ah-based Wi-Fi HaLow communication method, a short-range wireless communication method, a standard wireless LAN method, a Bluetooth communication method, and a wired communication method.

The communication device 110 may further include at least one of a signal amplifier and a filter to ensure stable communication in an environment in which a plurality of wireless signals are mixed, such as a performance space. The signal amplifier may amplify a reception signal strength of a light emission control packet received by the communication device 110, and the filter may remove a noise component or an interference component from the reception signal. The communication device 110 may further include an error detection function and an error correction function for a received signal. For example, the communication device 110 may detect an error of the light emission control packet based on at least one of a checksum, a cyclic redundancy check (CRC), and a forward error correction (FEC) code, and may correct at least a part of the detected error. Accordingly, reliability of data reception of the communication device 110 may be improved.

The processor 140 may control a channel switching operation of the communication device 110 based on RF information included in the light emission control packet. For example, when a reception signal strength of the communication device 110 is equal to or less than a reference threshold, the processor 140 may switch a communication channel of the communication device 110 to another communication channel indicated by the communication channel information. According to an embodiment, the processor 140 may sequentially attempt a plurality of candidate channels included in the communication channel information and select a channel having a reception signal strength equal to or greater than the reference threshold as an operation channel of the communication device 110. Accordingly, the light-emitting device 100 may autonomously maintain a stable communication state even in an environment in which a wireless communication state changes.

The smart device connection device may be a component for connecting the light-emitting device 100 to a smart device of a user. The smart device connection device may be implemented separately from the communication device 110 such that communication with at least one of a repeater, a control device, and another light-emitting device is performed by the communication device 110, and communication with a smart device of a user is performed by the smart device connection device. Depending on an implementation form, at least a part of the functions of the smart device connection device may be integrated into the communication device 110.

The smart device connection device may operate based on at least one short-range wireless communication method. For example, the smart device connection device may support at least one of a Bluetooth communication method, a Bluetooth Low Energy (BLE) communication method, a Zigbee communication method, a Near Field Communication (NFC) method, a Wi-Fi communication method, a Wi-Fi Direct communication method, and an Ultra-Wideband (UWB) communication method.

The smart device connection device may receive user setting information from the smart device of the user. The user setting information may include at least one of position identification information of the light-emitting device 100, light emission color information, operation cycle information, light emission brightness information, and light emission activation information. The processor 140 may generate control information based on at least one of the user setting information received through the smart device connection device and the light emission control packet received through the communication device 110.

The smart device connection device may perform a bi-directional communication function with the smart device. The smart device connection device may transmit state information of the light-emitting device 100 to the smart device. The state information may include at least one of a remaining battery level, a current operation mode, and a communication connection state of the light-emitting device 100. A user may verify a state of the light-emitting device 100 in real time using the smart device.

The light source device 120 may be a component for performing the light emission operation of the light-emitting device 100. The light source device 120 may output light emission effects corresponding to at least one of color, brightness, blinking, fading, patterns, and light emission maintenance time under the control of the processor 140. For example, the light source device 120 may emit light in a specific color, blink at a specific period, or change brightness for a predetermined time in accordance with the performance progress time.

The light source device 120 may include a single light source or a plurality of light sources. For example, the light source device 120 may include at least one of an LED (Light Emitting Diode), an RGB LED, a micro LED, an OLED (Organic Light Emitting Diode), a QLED (Quantum Dot Light Emitting Diode), a laser diode, a halogen lamp, an incandescent bulb, a fluorescent lamp, a light source driving circuit, a light diffusing member, and an optical cover. The light source device 120 may include a plurality of light sources corresponding to different colors, or may include a plurality of light sources disposed at different positions of the light-emitting device 100.

The light source device 120 may further include at least one optical component for controlling diffusion or focusing of light. For example, the light source device 120 may include at least one of a lens, a diffuser, and a reflector, and may irradiate light in a specific pattern or shape using the optical component. Accordingly, the light source device 120 may implement a more diverse and three-dimensional light emission production.

The memory 130 may be a component for storing information necessary for the operation of the light-emitting device 100. The memory 130 may store at least one of device identification information, light emission control packets, light emission control information, execution time information, packet identification information, error detection information, valid time information, processing result information, and a current light emission state. The memory 130 may also store instructions or a program that can be executed by the processor 140.

The memory 130 may store information received before or during a performance. For example, the memory 130 may store setting information received from a user terminal or an external device before the start of a performance. The memory 130 may temporarily store light emission control packets received from a repeater during a performance. When the execution time information represents a reserved execution time or an application timing corresponding to the performance progress time, the memory 130 may store light emission control information in a standby state until the application timing.

The processor 140 may be a component for controlling the operation of the light-emitting device 100. The processor 140 may execute instructions stored in the memory 130 to control the operation of at least one of the communication device 110, the light source device 120, the memory 130, and the power supply device 150. For example, the processor 140 may be implemented as at least one of a microcontroller, a central processing unit, a digital signal processor, a dedicated circuit, and a programmable logic circuit.

Upon receiving a light emission control packet, the processor 140 may determine at least one of the integrity, redundancy, and validity of the light emission control packet. For example, the processor 140 may determine the reliability of the light emission control packet based on at least one of packet identification information, version information, error detection information, and valid time information. The processor 140 may not process a light emission control packet in which an error is detected, an already processed light emission control packet, a previous version of a light emission control packet, or a light emission control packet for which the valid time has expired.

The processor 140 may determine whether the light emission control packet is a packet to be applied to the light-emitting device 100. For example, the processor 140 may compare information on a reception target range included in the light emission control packet with at least one of device identification information or device correspondence information stored in the memory 130. The processor 140 may determine whether the light emission control packet is a processing target packet corresponding to all light-emitting devices, a specific light-emitting device group, or an individual light-emitting device based on a result of the comparison.

The processor 140 may further use user setting information received through the smart device connection device when determining whether the light emission control packet is the processing target packet. For example, the processor 140 may compare position identification information of the light-emitting device 100 included in the user setting information with seat information or position information included in the light emission control packet. The processor 140 may determine that the light emission control packet is the processing target packet only when the position identification information of the light-emitting device 100 corresponds to the seat information or the position information included in the light emission control packet.

According to an embodiment, the processor 140 may generate the current device correspondence information stored in the memory 130 based on at least one of the user setting information received through the smart device connection device, a previously received light emission control packet, group update information, a performance progress time, and state information of the light-emitting device 100. Accordingly, an individual user may set the light-emitting device 100 to selectively respond to a light emission control packet corresponding to a specific seat, a specific group, or a specific state condition, independently of central control by the control device 300.

If the light emission control packet is a processing target packet, the processor 140 may determine an application timing of the light emission control information based on the execution time information. For example, the processor 140 may immediately apply light emission control information if the execution time information indicates immediate execution. If the execution time information indicates a reserved execution time or an application timing corresponding to the performance progress time, the processor 140 may store the light emission control information in the memory 130 in a standby state and apply it at the application timing. The processor 140 may not apply light emission control information if it is determined that the validity of the light emission control packet has been lost based on the execution time information or the valid time information.

The processor 140 may perform a fallback operation when a light emission control packet is not received from a repeater for at least a reference time period during operation in a real-time mode based on performance type information described below. For example, when a non-reception time of the light emission control packet through the communication device 110 is equal to or greater than the reference time period, the processor 140 may automatically switch the operation mode of the light-emitting device 100 from the real-time mode to the scenario mode. The reference time period may be set based on at least one of a transmission cycle of the light emission control packet, a priority of a performance section, and a network state.

Upon switching to the scenario mode, the processor 140 may continue a light emission operation based on the light emission scenario information stored in advance in the memory 130. For example, the processor 140 may identify a current performance progress time using at least one of an internal clock and a most recently received synchronization time, and may extract and execute light emission scenario information corresponding to the identified performance progress time. Accordingly, the light-emitting device 100 may maintain continuity of light emission production even in a communication interruption situation. When reception of light emission control packets is resumed, the processor 140 may switch the operation mode of the light-emitting device 100 back to the real-time mode based on performance type information included in a newly received light emission control packet.

The processor 140 may control the light source device 120 based on the light emission control information at the application timing. For example, the processor 140 may control the light source device 120 to emit light in a specific color based on the light emission control information. The processor 140 may also control the light source device 120 to output a designated brightness, a designated blinking period, a designated fade effect, or a designated pattern effect based on the light emission control information.

The light-emitting device 100 may activate the communication device 110 in a reception control interval corresponding to the light-emitting device group to which it belongs. The light-emitting device 100 may switch at least one of the communication device 110, the processor 140, and the light source device 120 to a low-power state in intervals other than the reception control interval. The reception control interval may be set for each light-emitting device group and may include at least one of a reception interval, a restricted access interval, and a common reception control interval.

For example, the memory 130 may store reception control interval information corresponding to the light-emitting device group to which the light-emitting device 100 belongs. The processor 140 may compare at least one of current time, performance progress time, and reception control interval information. The processor 140 may activate the communication device 110 if it is determined that the current time is included in the reception control interval. The processor 140 may switch the communication device 110 to a low-power state if it is determined that the current time is not included in the reception control interval.

For example, when the reception control interval is set as a reception interval, the processor 140 may activate the communication device 110 at the start timing of the reception interval and switch the communication device 110 to a low-power state after the end timing of the reception interval. The reception interval may be implemented as a wake-up interval corresponding to the Target Wake Time TWT of IEEE 802.11ah. The light-emitting device 100 may perform packet reception operations in intervals necessary for itself rather than activating the communication device 110 throughout the performance time.

For example, when the reception control interval is set as a restricted access interval, the processor 140 may activate the communication device 110 in the restricted access interval. The restricted access interval may be implemented as an interval corresponding to the Restricted Access Window RAW of IEEE 802.11ah. The light-emitting device 100 may receive light emission control packets or transmit reception state information in an interval in which communication access for the light-emitting device group to which it belongs is allowed.

The memory 130 may store device correspondence information. The device correspondence information may be information representing which light-emitting device group, subgroup, location, row, column, pattern index, mask, or state the light-emitting device 100 corresponds to. Device correspondence information may be stored before the start of a performance and may be updated during a performance based on at least one of the performance progress time, previously received light emission control packets, group update information, and state information of the light-emitting device 100.

When internal application criteria information is included in a light emission control packet, the processor 140 may compare the internal application criteria information with the device correspondence information stored in the memory 130. The processor 140 may select or calculate light emission control information to be applied to the light-emitting device 100 based on a result of the comparison. Internal application criteria information may be reference information for applying different light emission control information within a light-emitting device group.

For example, a light emission control packet may target one light-emitting device group while including different differential light emission control information for each subgroup. Internal application criteria information may be compared with at least one of subgroup identification information, device identification information, a location index, a row/column index, a pattern index, mask information, and state information. The processor 140 may select first differential light emission control information if the device correspondence information indicates subgroup G1-1, and may select second differential light emission control information if the device correspondence information indicates subgroup G1-2.

For example, when internal application criteria information includes a row/column index and a light emission pattern calculation rule, the processor 140 may compare the row/column index stored in the memory 130 with the internal application criteria information. The processor 140 may calculate at least one of a color value, a brightness value, a blinking period, and a light emission start timing based on a result of the comparison. A single light emission control packet may be transmitted in units of light-emitting device groups, and a plurality of light-emitting devices within a light-emitting device group may perform different light emission outputs.

The processor 140 may generate processing result information of a light emission control packet. Processing result information may represent at least one of whether a light emission control packet is received, whether it is a processing target packet, whether light emission control information is applied, whether an error occurs, current light emission state, and reception quality. Processing result information may be stored in the memory 130 or may be transmitted to a repeater or a control device through the communication device 110.

For example, the processor 140 may generate reception state information representing whether a light emission control packet has been normally received. The processor 140 may determine whether an error has occurred based on error detection information and include the occurrence of an error in the processing result information. The processor 140 may also include whether light emission control information has actually been applied or whether the current light emission state matches a target light emission state in the processing result information.

Processing result information or reception state information may be used to update a transmission schedule of a next cycle. For example, the control device may calculate a reception failure rate of a target light-emitting device group based on reception state information collected through uplink response resources. If the reception failure rate is equal to or higher than a reference value, the control device may increase at least one of the length of the reception control interval, the number of downlink transmission resources, the number of repeated transmissions, and backup transmission resources in the next cycle.

The power supply device 150 may be a component for supplying power to each component of the light-emitting device 100. The power supply device 150 may supply operating power to at least one of the communication device 110, the light source device 120, the memory 130, and the processor 140.

The power supply device 150 may adjust a power supply state based on at least one of the usage time of the light-emitting device 100, light emission brightness, communication operation state, reception standby state, and remaining battery capacity. For example, the processor 140 may control the power supply device 150 to supply power to the communication device 110 in a reception control interval. The processor 140 may control the power supply device 150 to reduce power consumption of the communication device 110 in non-reception intervals.

The light-emitting device 100 of FIG. 2 may not necessarily be limited to essentially including all of the components shown in FIG. 2. Depending on the implementation form, the light-emitting device 100 may include more components than the components shown in FIG. 2, or may include only some of the components shown in FIG. 2. For example, the light-emitting device 100 may further include at least one of a sensor, a vibration device, a display device, a speaker, an input device, a positioning device, a charging terminal, and a housing.

The light-emitting device 100 of FIG. 2 activates the communication device 110 in a reception control interval corresponding to a light-emitting device group and selects or calculates light emission control information to be applied to itself by comparing internal application criteria information with device correspondence information. The light-emitting device 100 may provide information necessary for updating a transmission schedule by generating reception state information or processing result information.

FIG. 3 is a block diagram illustrating a configuration of a control device 300 according to some exemplary embodiments. The control device 300 may be a device that acquires performance production information, generates a light emission control packet based on the performance production information, and determines a transmission method or a transmission condition of the light emission control packet. The control device 300 may be used as a device for controlling a plurality of light-emitting devices 100 in at least one space among a concert hall, a stadium, an outdoor event space, and a fan meeting venue.

Referring to FIG. 3, the control device 300 may include at least one of a communication device 310, a user interface device 320, a memory 330, and a processor 340. The communication device 310 may transmit and receive data to and from an external device. The user interface device 320 may receive an input from a performance operator or a director, or may output a state of a light-emitting device control system. The memory 330 may store information necessary for the operation of the control device 300. The processor 340 may perform at least one of processing performance production information, generating a light emission control packet, determining a transmission method, determining a transmission condition, and selecting a repeater.

The communication device 310 may be a configuration for the control device 300 to communicate with at least one of a performance operation server 500, a repeater 200, a user terminal 400, an external storage device, and another control device. The communication device 310 may receive performance production information from the performance operation server 500 or an external storage device, and may transmit a light emission control packet and a transmission condition to the repeater 200. For example, the communication device 310 may support at least one among a wired communication method, a wireless communication method, and a mixed wired/wireless communication method. For example, the communication device 310 may support at least one of Ethernet communication, wireless LAN communication, mobile network communication, dedicated control network communication, and lighting console linkage communication.

The user interface device 320 may be a configuration for processing input/output between the control device 300 and a user. The user interface device 320 may receive at least one of performance production information, a light emission control command, production target selection information, an emergency control command, and transmission condition adjustment information from a performance operator or a director. For example, the user interface device 320 may display at least one of a concert hall map, a spectator seat layout, light-emitting device arrangement information, repeater state information, a packet transmission state, and a reception state of light-emitting devices. The user interface device 320 may include at least one of a display, a touch screen, a keyboard, a mouse, a button, a jog dial, a voice input device, and a lighting console interface.

The memory 330 may be a configuration for storing information necessary for the operation of the control device 300. The memory 330 may store at least one of performance production information, performance progress time information, production target information, light emission effect information, a light emission control packet, a transmission condition, repeater information, light-emitting device information, information on a transmission result, and a subsequent transmission condition. The memory 330 may also store instructions or a program that can be executed by the processor 340.

The memory 330 may store reference information for selecting a reception target range or a repeater. For example, the memory 330 may store at least one of: correspondence information between a target area based on a performance space and a preset light-emitting device group; identification information of light-emitting device groups; identification information of individual light-emitting devices; state conditions of light-emitting devices; a transmittable range for each repeater; communication channel information for each repeater; and transmission history information for each repeater.

The processor 340 may be a configuration for controlling the operation of the control device 300. The processor 340 may execute instructions stored in the memory 330 to control an operation of at least one of the communication device 310, the user interface device 320, and the memory 330. The processor 340 may acquire performance production information from at least one of the performance operation server 500, the user interface device 320, a performance control program, and an external storage device.

The processor 340 may generate a light emission control packet based on the performance production information. For example, the processor 340 may generate execution time information based on the performance progress time information. The processor 340 may generate information on a reception target range based on the production target information. The processor 340 may generate light emission control information based on the light emission effect information. The processor 340 may construct a light emission control packet to include at least one of the generated execution time information, information on the reception target range, and the light emission control information.

The processor 340 may use the reference information stored in the memory 330 to generate information on the reception target range.

For example, when a target area based on a performance space represents a first block of spectator seats, a second block, a specific row, a specific column, an area around a stage, or an area around an entrance, the processor 340 may identify a light-emitting device group included in the target area based on correspondence information between target areas and light-emitting device groups. The processor 340 may generate information on a reception target range so as to include identification information of the identified light-emitting device group.

For example, when the production target information directly designates a specific light-emitting device group, the processor 340 may include identification information of the designated light-emitting device group in the information on the reception target range. When the production target information directly designates a specific light-emitting device, the processor 340 may include identification information of the individual light-emitting device in the information on the reception target range.

For example, the processor 340 may generate a reception target range based on a state condition of a light-emitting device. The state condition may include at least one of: a state in which a remaining battery amount is a reference value or less; a state in which a previous packet was not received; a state in which the number of error detections is a reference value or more; a state in which a current light emission state is different from a target light emission state; and a state in which communication quality is a reference value or less. The processor 340 may set a light-emitting device or a light-emitting device group satisfying the state condition as the reception target range.

For example, even in the same performance section, the processor 340 may generate a reception target range based on a target area based on a performance space for a first light emission control packet, and generate a reception target range based on a state condition of a light-emitting device for which reception failure has been confirmed for a second light emission control packet. The processor 340 may change a generation criterion of the reception target range according to a performance progress time or a transmission result.

The processor 340 may generate the information on the reception target range by using at least one of the above reference information independently or in combination.

The processor 340 may determine a transmission method based on the information on the reception target range included in the light emission control packet. For example, the processor 340 may select a transmission method receivable by all light-emitting devices for a light emission control packet targeting all light-emitting devices. The processor 340 may select a transmission method receivable by a light-emitting device group for a light emission control packet targeting the light-emitting device group. The processor 340 may select a transmission method receivable by an individual light-emitting device for a light emission control packet targeting the individual light-emitting device.

The processor 340 may determine a transmission condition to be applied to the repeater 200 based on the determined transmission method. The transmission condition may include at least one of a transmission method, a transmission target, a transmission timing, a transmission repetition count, a transmission priority, whether to re-transmit, and whether to perform calibration transmission. For example, the processor 340 may determine at least one of a transmission timing, a transmission repetition count, and a transmission priority of the light emission control packet based on a relationship between an application timing indicated by execution time information and a current performance progress time. The processor 340 may set a high transmission priority or an increased transmission repetition count for a light emission control packet having a short remaining time until the application timing.

For example, when the time remaining until the application timing of the light emission control information is a reference time or less, the processor 340 may increase the transmission priority and increase the transmission repetition count. The processor 340 may determine a plurality of repeaters as transmission targets when the reception target range corresponds to all light-emitting devices, and may determine a repeater corresponding to a transmittable range of a specific light-emitting device group as a transmission target when the reception target range corresponds to the specific light-emitting device group.

The processor 340 may activate a re-transmission status when reception failure is confirmed in the information on the transmission result, and may activate a calibration transmission status when the current performance progress time has progressed past the application timing of a previous light emission control packet.

The processor 340 may select at least one repeater 200 among a plurality of repeaters. For example, the processor 340 may select a repeater to transmit a light emission control packet based on a correspondence relationship between a reception target range and a transmittable range of each of the plurality of repeaters. When a target area based on a performance space is included in a transmittable range of a first repeater, the processor 340 may select the first repeater. The processor 340 may select a plurality of repeaters for a light emission control packet targeting all light-emitting devices, and may select a repeater corresponding to a reception target range for a light emission control packet targeting a light-emitting device group or an individual light-emitting device.

The processor 340 may transmit the light emission control packet and the transmission condition to the repeater 200 through the communication device 310. The repeater 200 may transmit the light emission control packet to at least one of the plurality of light-emitting devices 100 based on at least one of a transmission method, a transmission target, a transmission timing, a transmission repetition count, a transmission priority, and a transmission channel included in the transmission condition. For example, the repeater 200 may transmit the light emission control packet through a sub-1GHz band wireless communication method or an IEEE 802.11ah-based Wi-Fi HaLow communication method.

The processor 340 may determine whether a subsequent transmission is necessary and a subsequent transmission condition based on the information on the transmission result of the light emission control packet. For example, the processor 340 may determine whether repeated transmission, re-transmission, or calibration transmission is necessary based on at least one of reception state information of the light-emitting device 100, device state information, a current light emission state, transmission history information, and valid time information of the light emission control packet. The processor 340 may determine a re-transmission condition when reception failure is confirmed in a specific light-emitting device group. The processor 340 may also generate a calibration packet indicating a light emission state suitable for the current performance progress time and determine a transmission condition for the calibration packet.

The control device 300 may be implemented as a device physically separated from the repeater 200. The control device 300 may also be implemented as an integrated device including at least a portion of the functions of the repeater 200. If the control device 300 is separated from the repeater 200, the control device 300 may transmit the light emission control packet and the transmission condition to the repeater 200. If the control device 300 includes the functions of the repeater 200, the control device 300 may perform at least one of generating a light emission control packet, determining a transmission condition, and controlling transmission of the light emission control packet.

The control device 300 may not necessarily be limited to including all of the components shown in FIG. 3. Depending on the implementation form, the control device 300 may include more components than the components shown in FIG. 3, or may include only some of the components shown in FIG. 3. For example, the control device 300 may further include at least one of a clock device providing a performance reference time, an external storage device, a security module, a backup power supply device, and a lighting console connection device.

The control device 300 of FIG. 3 may not be limited to a device that simply delivers the same control information to a plurality of light-emitting devices 100. The control device 300 may generate a light emission control packet from performance production information, select a transmission method and a repeater based on a reception target range, and control the light emission control packet to be transmitted according to a transmission condition. The control device 300 may also determine a subsequent transmission condition for at least one of repeated transmission, re-transmission, and calibration transmission based on information on a transmission result.

The control device 300 may include at least one of a communication device 310, a user interface device 320, a memory 330, and a processor 340.

The control device 300 may be a device for acquiring performance production information and controlling a plurality of light-emitting devices based on the performance production information. The control device 300 may be used in at least one space among a concert hall, a stadium, an outdoor event space, and a fan meeting venue. The control device 300 may be linked with at least one of a performance operation server, a repeater, a user terminal, an external storage device, and a lighting console.

The communication device 310 may be a component for the control device 300 to transmit and receive data to and from an external device. The communication device 310 may receive performance production information from a performance operation server and transmit light emission control packets to a repeater. The communication device 310 may support at least one of a wired communication method, a wireless communication method, and a mixed wired/wireless communication method.

For example, the communication device 310 may receive at least one of performance progress time information, production target information, and light emission effect information from the performance operation server. The communication device 310 may transmit at least one of light emission control packets, transmission conditions, synchronization information, and calibration transmission instructions to the repeater. The communication device 310 may receive at least one of transmission result information, repeater state information, channel state information, and reception state information from the repeater.

The user interface device 320 may be a component for receiving an input from a performance operator or a director, or outputting a state of the light-emitting device control system. The user interface device 320 may receive at least one of performance production information, light emission control commands, production target selection information, emergency control commands, and transmission condition adjustment information. The user interface device 320 may display at least one of a concert hall map, a spectator seat layout, light-emitting device arrangement information, repeater state information, packet transmission state, and reception state of light-emitting devices.

For example, the user interface device 320 may receive an input for selecting a specific spectator seat area on a concert hall map. The user interface device 320 may provide the selected spectator seat area to the processor 340 as production target information. The user interface device 320 may also display a light-emitting device group with a high reception failure rate, a repeater with high congestion, or a repeater to which backup transmission resources are allocated.

The memory 330 may be a component for storing information necessary for the operation of the control device 300. The memory 330 may store at least one of performance production information, performance progress time information, production target information, light emission effect information, light emission control packets, information on light-emitting device groups, information on repeaters, reception control interval information, transmission resource information, and transmission schedules. The memory 330 may also store instructions or a program that can be executed by the processor 340.

The memory 330 may store correspondence relationships between light-emitting device groups and repeaters. For example, the memory 330 may store at least one of the location of a light-emitting device group, identification information of the light-emitting device group, the number of light-emitting devices belonging to the light-emitting device group, subgroup information of the light-emitting device group, and reception failure history of the light-emitting device group. The memory 330 may also store at least one of the location of a repeater, transmittable range of the repeater, congestion of the repeater, reception failure history of the repeater, supported communication methods of the repeater, and transmission resource division method of the repeater.

The processor 340 may be a component for controlling the operation of the control device 300. The processor 340 may execute instructions stored in the memory 330 to control the operation of at least one of the communication device 310, the user interface device 320, and the memory 330. The processor 340 may perform at least one of processing of performance production information, generation of light emission control packets, determination of target light-emitting device groups, determination of reception control intervals, generation of transmission schedules, and update of transmission schedules.

The processor 340 may generate light emission control packets based on performance production information. For example, the processor 340 may generate execution time information based on performance progress time information. The processor 340 may determine a target light-emitting device group based on production target information. The processor 340 may generate light emission control information based on light emission effect information. The processor 340 may configure a light emission control packet to include at least one of execution time information, transmission target information, light emission control information, priority information, and internal application criteria information.

The processor 340 may acquire information on a plurality of light-emitting device groups and information on a plurality of repeaters, and determine a reception control interval corresponding to a target light-emitting device group. The processor 340 may generate a transmission schedule such that a transmission resource corresponding to a light emission control packet is arranged within a reception control interval corresponding to the target light-emitting device group. A transmission schedule may represent at least one of an arrangement of transmission resources, transmission timing, transmission target, transmission channel, transmission repetition count, transmission priority, primary repeater, secondary repeater, and backup transmission resources, used by the repeater to transmit a light emission control packet.

For example, the processor 340 may compare the location of the target light-emitting device group with the transmittable range of each of the plurality of repeaters. The processor 340 may determine a first repeater as a primary repeater if the location of the target light-emitting device group is included in the transmittable range of the first repeater. If the reception failure history or congestion of the primary repeater is equal to or higher than a reference value, the processor 340 may determine another repeater as a secondary repeater.

For example, when a target light-emitting device group is included in the transmittable range of two or more repeaters, the processor 340 may compare at least one of congestion, reception failure history, transmittable range, and communication quality of each of the two or more repeaters. The processor 340 may determine a repeater with low congestion and little reception failure history as a primary repeater. The processor 340 may determine a repeater that can supplement a transmittable range different from that of the primary repeater as a secondary repeater and allocate backup transmission resources to the secondary repeater.

The processor 340 may determine whether a light emission control packet includes common light emission control information or a plurality of pieces of differential light emission control information. If the light emission control packet includes common light emission control information, the processor 340 may arrange a common transmission resource corresponding to the common light emission control information within the reception control interval. If the light emission control packet includes a plurality of pieces of differential light emission control information, the processor 340 may determine the length of the reception control interval or the number of transmission resources based on at least one of the data amount of the plurality of pieces of differential light emission control information, the number of subgroups to which the plurality of pieces of differential light emission control information are to be applied, and the size of internal application criteria information.

For example, when the entire target light-emitting device group needs to emit light in the same color, the processor 340 may include common light emission control information in the light emission control packet. The processor 340 may arrange one common transmission resource within the reception control interval. The repeater may transmit the light emission control packet through one common transmission resource, and a plurality of light-emitting devices belonging to the target light-emitting device group may receive the same light emission control information.

For example, when subgroups within a target light-emitting device group need to emit light in different colors or patterns, the processor 340 may include a plurality of pieces of differential light emission control information in the light emission control packet. The processor 340 may increase the number of split transmission resources as the number of subgroups increases. The processor 340 may increase the length of the reception control interval if the data amount of the differential light emission control information is larger than a reference data amount. The processor 340 may also increase the number of split transmission resources or the length of the reception control interval as the size of the internal application criteria information increases.

The processor 340 may arrange downlink transmission resources and uplink response resources within the reception control interval. Downlink transmission resources may be resources for the repeater to transmit light emission control packets. Uplink response resources may be communication resources for at least some light-emitting devices belonging to the target light-emitting device group to transmit reception state information or processing result information.

For example, the processor 340 may arrange a plurality of downlink transmission resources in the first half of the reception control interval and arrange uplink response resources in the second half of the reception control interval. The processor 340 may increase the number of downlink transmission resources if the reception failure history of the target light-emitting device group is high. The processor 340 may increase the length or number of uplink response resources if collection of reception state information is required.

The processor 340 may set the reception control interval as a reception interval or a restricted access interval. A reception interval may be an interval in which a light-emitting device belonging to a target light-emitting device group activates a communication device to receive light emission control packets. A restricted access interval may be an interval in which communication access of a light-emitting device belonging to a target light-emitting device group is allowed. A reception interval may be implemented as a wake-up interval corresponding to the TWT Target Wake Time of IEEE 802.11ah. A restricted access interval may be implemented as an interval corresponding to the RAW Restricted Access Window of IEEE 802.11ah.

For example, the processor 340 may set the reception control interval as a reception interval if the target light-emitting device group only needs to receive light emission control packets at a designated timing. When a plurality of light-emitting device groups are mixed within the same frequency resource or the same transmittable range of a repeater, the processor 340 may set the reception control interval as a restricted access interval so that only communication access for a specific light-emitting device group is allowed.

The processor 340 may use a common reception control interval based on priority or time remaining until execution. For example, if the time remaining until the execution timing of a light emission control packet is equal to or less than a reference time, the processor 340 may arrange transmission resources in a common reception control interval without waiting for a reception control interval for each target light-emitting device group. If the priority of a light emission control packet is equal to or higher than a reference priority, the processor 340 may arrange transmission resources in a common reception control interval receivable by a plurality of light-emitting device groups in common.

For example, when spontaneous production occurs during a performance or synchronization of all light-emitting devices is required, the processor 340 may select a common reception control interval. The processor 340 may arrange downlink transmission resources for common control in the common reception control interval and generate a transmission schedule such that the repeater transmits the same light emission control packet to a plurality of light-emitting device groups. A plurality of light-emitting device groups may receive the same light emission control packet in the common reception control interval.

The processor 340 may generate internal application criteria information for differential control within a light-emitting device group. Internal application criteria information may be reference information for causing a light-emitting device to select or calculate light emission control information to be applied to itself. Internal application criteria information may be compared with at least one of subgroup identification information, device identification information, location index, row/column index, pattern index, mask information, and state information.

For example, the processor 340 may divide one light-emitting device group G1 into subgroups G1-1, G1-2, and G1-3. The processor 340 may associate first differential light emission control information with subgroup G1-1, associate second differential light emission control information with subgroup G1-2, and associate third differential light emission control information with subgroup G1-3. The processor 340 may generate internal application criteria information so that it can be compared with subgroup identification information stored in the light-emitting device.

For example, the processor 340 may generate internal application criteria information for calculating color values for each light-emitting device using a row/column index or a location index. A light emission control packet may be transmitted in units of light-emitting device groups, and each light-emitting device within the light-emitting device group may select or calculate light emission control information to be applied to itself by comparing internal application criteria information with device correspondence information. The control device 300 can control differential light emission within a light-emitting device group without transmitting a separate packet for each individual light-emitting device.

The processor 340 may set a plurality of split transmission resources based on the data amount of the plurality of pieces of differential light emission control information or the number of subgroups to which the plurality of pieces of differential light emission control information are to be applied. Different pieces of differential light emission control information may be assigned to each of the plurality of split transmission resources. The processor 340 may determine the plurality of split transmission resources as any one of time division transmission resources, frequency division transmission resources, and spatial division transmission resources based on a transmission resource division method supported by the repeater or the target light-emitting device group.

For example, if the repeater supports only a time division method, the processor 340 may arrange a plurality of time slots within the reception control interval and assign different pieces of differential light emission control information to each time slot. If the repeater supports a frequency resource division method, the processor 340 may associate different frequency bands or subchannels with different subgroups. If the repeater supports spatial division transmission, the processor 340 may associate different beams or transmission directions with different subgroups.

The processor 340 may calculate a reception failure rate of a target light-emitting device group based on reception state information collected through uplink response resources. If the reception failure rate is equal to or higher than a reference value, the processor 340 may increase at least one of the length of the reception control interval, the number of downlink transmission resources, the number of repeated transmissions, and backup transmission resources in the next cycle.

For example, the processor 340 may calculate the number of light-emitting devices that have not transmitted a reception success response among light-emitting devices belonging to a target light-emitting device group. The processor 340 may calculate a reception failure rate by comparing the number of light-emitting devices that have not transmitted a reception success response with the total number of light-emitting devices belonging to the target light-emitting device group. If the reception failure rate is equal to or higher than a reference value, the processor 340 may increase the number of downlink transmission resources in the transmission schedule of the next cycle or add backup transmission resources to a secondary repeater.

For example, the processor 340 may determine that a cause of a high reception failure rate of a specific light-emitting device group is an increase in congestion of a repeater. The processor 340 may select a secondary repeater based on at least one of congestion, reception failure history, and transmittable range of repeaters. The processor 340 may arrange backup transmission resources through the secondary repeater in the transmission schedule of the next cycle.

The control device 300 may not necessarily be limited to essentially including all of the components shown in FIG. 3. Depending on the implementation form, the control device 300 may include more components than the components shown in FIG. 3, or may include only some of the components shown in FIG. 3. For example, the control device 300 may further include at least one of a clock device providing a performance reference time, an external storage device, a security module, a backup power supply device, and a lighting console connection device.

The control device 300 of FIG. 3 may generate a transmission schedule that aligns reception control intervals for each light-emitting device group with transmission resources for each repeater. The control device 300 may arrange common transmission resources or split transmission resources according to the types of common light emission control information and differential light emission control information. The control device 300 can improve reception stability of light emission control packets in large-scale performance spaces by updating a transmission schedule of a next cycle based on reception state information.

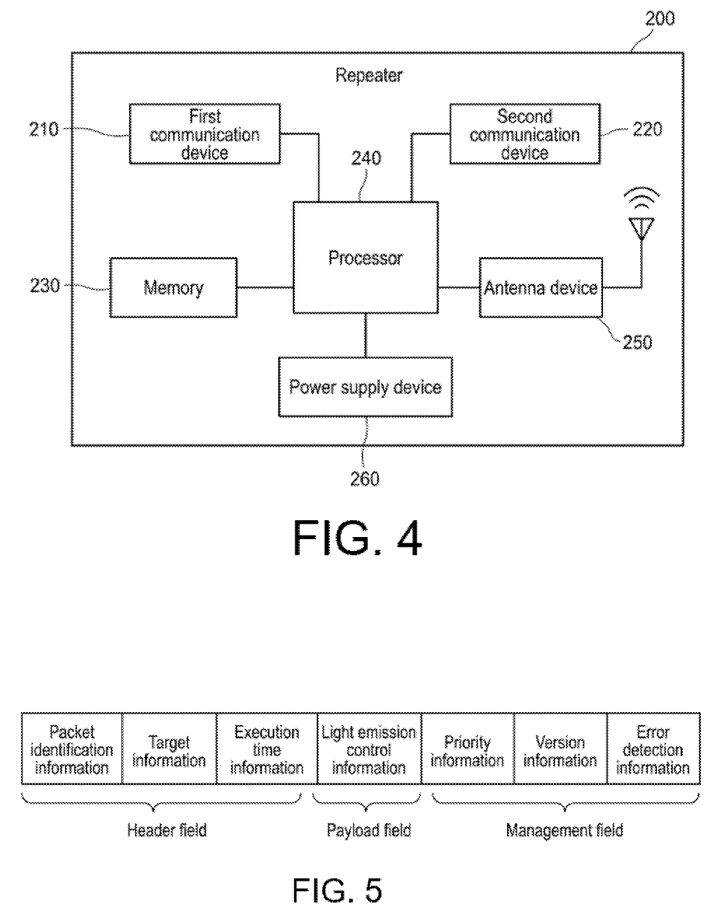

FIG. 4 is a block diagram illustrating a configuration of a repeater 200 according to some exemplary embodiments. The repeater 200 may be a device that receives a light emission control packet and a transmission condition from the control device 300 and transmits the light emission control packet to at least one of the plurality of light-emitting devices 100 based on the transmission condition. The repeater 200 may be installed in at least one space among a concert hall, a stadium, an outdoor event space, and a fan meeting venue, and may perform wireless communication with a plurality of light-emitting devices 100.

Referring to FIG. 4, the repeater 200 may include at least one of a first communication device 210, a second communication device 220, a memory 230, a processor 240, an antenna device 250, and a power supply device 260. The first communication device 210 may communicate with the control device 300 or an external device. The second communication device 220 may communicate with at least one of the plurality of light-emitting devices 100. The memory 230 may store information necessary for the operation of the repeater 200. The processor 240 may control a transmission operation of a light emission control packet. The antenna device 250 may be used for wireless transmission of the light emission control packet. The power supply device 260 may supply power to each component of the repeater 200.

The first communication device 210 may be a configuration for the repeater 200 to transmit and receive data to and from the control device 300. The first communication device 210 may receive at least one of a light emission control packet, a transmission condition, synchronization information, repeater control information, and a calibration transmission instruction from the control device 300. The first communication device 210 may transmit at least one of state information of the repeater 200, information on a transmission result, channel state information, reception state information of light-emitting devices, and transmission history information to the control device 300.

The first communication device 210 may support at least one among a wired communication method, a wireless communication method, and a mixed wired/wireless communication method. For example, the first communication device 210 may support at least one of Ethernet communication, wireless LAN communication, mobile network communication, dedicated control network communication, and inter-repeater communication. When a plurality of repeaters 200 are disposed in a performance space, the first communication device 210 may transmit and receive information for adjusting at least one of a transmission timing, a transmission target, a transmission channel, and a transmittable range with other repeaters.

The second communication device 220 may be a configuration for the repeater 200 to communicate with the light-emitting device 100. The second communication device 220 may transmit a light emission control packet to at least one of the plurality of light-emitting devices 100. The second communication device 220 may also receive at least one of processing result information, reception state information, device state information, and current light emission state information from the light-emitting device 100.

The second communication device 220 may support at least one of a long-range low-power wireless communication method, a sub-1GHz band wireless communication method, an IEEE 802.11ah-based Wi-Fi HaLow communication method, and a short-range wireless communication method. For example, the second communication device 220 may transmit a light emission control packet in at least one method among a method receivable by all light-emitting devices, a method receivable by a light-emitting device group, and a method receivable by an individual light-emitting device.

The first communication device 210 and the second communication device 220 may be implemented as separate communication circuits or may be integrated into a single communication device. For example, the repeater 200 may be connected to the control device 300 through a wired communication method via the first communication device 210, and may be connected to the light-emitting device 100 through a Wi-Fi HaLow communication method via the second communication device 220. As another example, the repeater 200 may be connected to the control device 300 through a wireless communication method and may be connected to the light-emitting device 100 through a sub-1GHz band wireless communication method.

The memory 230 may be a configuration for storing information necessary for the operation of the repeater 200. The memory 230 may store at least one of a light emission control packet, a transmission condition, repeater identification information, transmittable range information, transmission channel information, transmission timing information, transmission history information, light-emitting device group information, and repeater state information. The memory 230 may also store instructions or a program that can be executed by the processor 240.

The memory 230 may temporarily store a light emission control packet received from the control device 300. The memory 230 may temporarily store the light emission control packet so that it is transmitted through the second communication device 220 at a transmission timing indicated by a transmission condition. The memory 230 may store packet identification information and transmission history information for repeated transmission of the same light emission control packet or re-transmission of a previously transmitted light emission control packet.

The processor 240 may be a configuration for controlling the operation of the repeater 200. The processor 240 may process a light emission control packet and a transmission condition received via the first communication device 210. The processor 240 may control the second communication device 220 and the antenna device 250 to transmit the light emission control packet to at least one of the plurality of light-emitting devices 100.

The processor 240 may control at least one of a transmission method, a transmission target, a transmission timing, a transmission repetition count, a transmission priority, whether to re-transmit, and whether to perform calibration transmission of a light emission control packet according to a transmission condition. For example, the processor 240 may transmit a light emission control packet targeting all light-emitting devices over a wide transmittable range. The processor 240 may transmit a light emission control packet targeting a light-emitting device group through a specific transmittable range or a specific channel. The processor 240 may transmit a light emission control packet or a calibration packet targeting an individual light-emitting device in a method capable of communicating with the individual light-emitting device.

The processor 240 may adjust a transmission timing of a light emission control packet based on execution time information or a transmission condition. For example, the processor 240 may transmit the light emission control packet at a timing earlier than an application timing indicated by the execution time information. The processor 240 may transmit a light emission control packet having a high transmission priority before other light emission control packets. The processor 240 may transmit the same light emission control packet a plurality of times based on a transmission repetition count.

The processor 240 may perform a subsequent transmission operation based on at least one of reception state information of the light-emitting device 100, device state information, current light emission state information, or transmission history information. For example, the processor 240 may re-transmit a previously transmitted light emission control packet. The processor 240 may also transmit a calibration packet indicating a light emission state suitable for the current performance progress time. The processor 240 may adjust a transmission repetition count, a transmission channel, or a transmittable range targeting a light-emitting device group for which transmission failure or reception failure has been confirmed.

The antenna device 250 may be a configuration for the repeater 200 to wirelessly transmit a light emission control packet. The antenna device 250 may be connected to the second communication device 220 or may be implemented as a portion of the second communication device 220. The antenna device 250 may be used to deliver the light emission control packet to a wide transmittable range or a specific transmittable range.

The antenna device 250 may operate in at least one of an omnidirectional transmission mode, a directional transmission mode, and a beam pattern-based transmission mode. For example, the antenna device 250 may include at least one of an omnidirectional antenna, a directional antenna, a plurality of antenna elements, an antenna switching circuit, and a beam pattern forming circuit. The antenna device 250 may operate in the omnidirectional transmission mode when targeting all light-emitting devices or a wide performance space. The antenna device 250 may operate in the directional transmission mode or the beam pattern-based transmission mode when targeting a target area based on a specific performance space, a specific light-emitting device group, or a specific transmittable range.

The antenna device 250 may adjust a transmission direction or a beam pattern based on at least one of a concert hall structure, an installation position of the repeater 200, a reception target range, a transmittable range, and a channel state. For example, the antenna device 250 may use a wide radiation pattern for transmission targeting the entire concert hall, and may use a beam pattern directed toward a specific spectator seat area for transmission targeting the spectator seat area.

The power supply device 260 may be a configuration for supplying power to each component of the repeater 200. The power supply device 260 may supply operating power to at least one of the first communication device 210, the second communication device 220, the memory 230, the processor 240, and the antenna device 250. For example, the power supply device 260 may include at least one of an AC power input device, a DC power input device, a battery, a charging circuit, a power management circuit, and a backup power supply device. The power supply device 260 may receive power from a power line installed in a concert hall, and may include a battery or an auxiliary power source for mobile repeater implementation.

The repeater 200 may not necessarily be limited to including all of the components shown in FIG. 4. Depending on the implementation form, the repeater 200 may include more components than the components shown in FIG. 4, or may include only some of the components shown in FIG. 4. For example, the repeater 200 may further include at least one of a positioning device, a sensor, a cooling device, a display device, a security module, a backup communication device, an installation angle adjustment device, and a housing.

The repeater 200 may be implemented as a device physically separated from the control device 300. The repeater 200 may also be implemented as an integrated device including at least a portion of the functions of the control device 300. If the repeater 200 is separated from the control device 300, the repeater 200 may receive a light emission control packet and a transmission condition from the control device 300, and transmit the light emission control packet to the light-emitting device 100 according to the transmission condition. If the repeater 200 is implemented as an integrated device, the processor 240 may perform at least one of processing performance production information, generating a light emission control packet, determining a transmission condition, and controlling transmission of the light emission control packet.

The repeater 200 of FIG. 4 may not be limited to a simple delivery device. The repeater 200 may control a transmission range, a transmission timing, a transmission repetition count, a transmission priority, whether to re-transmit, and whether to perform calibration transmission of a light emission control packet according to a transmission condition received from the control device 300. The repeater 200 may increase the delivery stability of the light emission control packet using at least one of a Wi-Fi HaLow communication method, RF channel division, continuous transmission of the same information, and antenna beam pattern control.

The repeater 200 may include at least one of a first communication device 210, a second communication device 220, a memory 230, a processor 240, an antenna device 250, and a power supply device 260.

The repeater 200 may be a device for receiving a light emission control packet from a control device and transmitting the received light emission control packet to at least one of a plurality of light-emitting devices. The repeater 200 may be installed in at least one space among a concert hall, a stadium, an outdoor event space, and a fan meeting venue. The repeater 200 may be implemented as a device that delivers light emission control packets between the control device and the light-emitting device.

The first communication device 210 may be a component for the repeater 200 to transmit and receive data to and from the control device. The first communication device 210 may receive at least one of a light emission control packet, a transmission condition, a transmission schedule, synchronization information, and a calibration transmission instruction from the control device. The first communication device 210 may transmit at least one of repeater state information, transmission result information, channel state information, reception state information, and transmission history information to the control device.

The first communication device 210 may support at least one of a wired communication method, a wireless communication method, and a mixed wired/wireless communication method. For example, the first communication device 210 may support at least one of Ethernet communication, wireless LAN communication, mobile network communication, dedicated control network communication, and inter-repeater communication. When a plurality of repeaters 200 are arranged in a performance space, the first communication device 210 may transmit and receive information for adjusting at least one of a transmission timing, a transmission target, a transmission channel, and a transmittable range with other repeaters.

The second communication device 220 may be a component for the repeater 200 to communicate with a plurality of light-emitting devices. The second communication device 220 may transmit a light emission control packet to at least one of the plurality of light-emitting devices. The second communication device 220 may also receive at least one of processing result information, reception state information, device state information, and current light emission state information from the light-emitting device.

The second communication device 220 may support at least one of a long-range low-power wireless communication method, a sub-1GHz band wireless communication method, an IEEE 802.11ah-based Wi-Fi HaLow communication method, and a short-range wireless communication method. For example, the second communication device 220 may transmit a light emission control packet in at least one method among a method receivable by all light-emitting devices, a method receivable by a light-emitting device group, and a method receivable by an individual light-emitting device.

The first communication device 210 and the second communication device 220 may be implemented as separate communication circuits or may be integrated into a single communication device. For example, the repeater 200 may be connected to the control device through a wired communication method via the first communication device 210 and connected to light-emitting devices through a Wi-Fi HaLow communication method via the second communication device 220. As another example, the repeater 200 may be connected to the control device through a wireless communication method and connected to light-emitting devices through a sub-1GHz band wireless communication method.

The memory 230 may be a component for storing information necessary for the operation of the repeater 200. The memory 230 may store at least one of a light emission control packet, a transmission condition, a transmission schedule, repeater identification information, transmittable range information, transmission channel information, transmission timing information, transmission history information, light-emitting device group information, and repeater state information. The memory 230 may also store instructions or a program that can be executed by the processor 240.

The memory 230 may temporarily store a light emission control packet received from the control device. The memory 230 may store the light emission control packet in a standby state so that it is transmitted through the second communication device 220 at a transmission timing indicated by the transmission schedule. The memory 230 may store packet identification information and transmission history information for repeated transmission of the same light emission control packet or re-transmission of a previously transmitted light emission control packet.

The processor 240 may be a component for controlling the operation of the repeater 200. The processor 240 may process a light emission control packet and a transmission schedule received through the first communication device 210. The processor 240 may control the second communication device 220 and the antenna device 250 to transmit the light emission control packet to at least one of the plurality of light-emitting devices.

The processor 240 may control at least one of a transmission method, a transmission target, a transmission timing, a transmission repetition count, a transmission priority, a re-transmission status, and a calibration transmission status of a light emission control packet according to the transmission schedule. For example, the processor 240 may transmit a light emission control packet targeting all light-emitting devices with a wide transmittable range. The processor 240 may transmit a light emission control packet targeting a light-emitting device group through a specific transmittable range or a specific channel.

The antenna device 250 may be a configuration for the repeater 200 to wirelessly transmit a light emission control packet. The antenna device 250 may be connected to the second communication device 220 or may be implemented as a part of the second communication device 220. The antenna device 250 may be used to deliver the light emission control packet to a wide transmittable range or a specific transmittable range.

The antenna device 250 may operate in at least one of an omnidirectional transmission mode, a directional transmission mode, and a beam pattern-based transmission mode. For example, the antenna device 250 may include at least one of an omnidirectional antenna, a directional antenna, a plurality of antenna elements, an antenna switching circuit, and a beam pattern forming circuit. The antenna device 250 may operate in the omnidirectional transmission mode when targeting all light-emitting devices or a wide concert hall. The antenna device 250 may operate in the directional transmission mode or the beam pattern-based transmission mode when targeting a target area based on a specific concert hall space or a specific light-emitting device group.

The power supply device 260 may be a component for supplying power to each component of the repeater 200. The power supply device 260 may supply operating power to at least one of the first communication device 210, the second communication device 220, the memory 230, the processor 240, and the antenna device 250. For example, the power supply device 260 may include at least one of an AC power input device, a DC power input device, a battery, a charging circuit, a power management circuit, and a backup power supply device.

The repeater 200 may receive a light emission control packet and a transmission schedule from the control device and verify whether a transmission resource included in the transmission schedule is arranged within a reception control interval corresponding to a target light-emitting device group. The processor 240 may transmit the light emission control packet to the target light-emitting device group through the second communication device 220 based on a result of the verification.

For example, the transmission schedule may include at least one of a target light-emitting device group, a reception control interval, a downlink transmission resource, an uplink response resource, a transmission timing, a transmission repetition count, a transmission channel, and a transmission priority. The processor 240 may determine whether a transmission timing included in the transmission schedule corresponds to the current time or the current performance progress time. The processor 240 may transmit the light emission control packet if it is determined that the transmission resource is arranged within the reception control interval.

For example, the processor 240 may verify a start timing and an end timing of the reception control interval included in the transmission schedule. If a scheduled transmission timing of a light emission control packet is after the start timing of the reception control interval and before the end timing, the processor 240 may determine that the transmission resource is arranged within the reception control interval. If the scheduled transmission timing of the light emission control packet is outside the reception control interval, the processor 240 may wait to transmit the light emission control packet or transmit transmission schedule error information to the control device.

The processor 240 may control a transmission method of a light emission control packet differently according to a type of a transmission resource included in the transmission schedule. The transmission resource may include at least one of a common transmission resource, a split transmission resource, a downlink transmission resource, an uplink response resource, and a backup transmission resource. The processor 240 may control the transmission operation of the second communication device 220 based on the type of the transmission resource and the target light-emitting device group.

For example, if the transmission resource is a common transmission resource, the processor 240 may transmit the light emission control packet so that a plurality of light-emitting devices belonging to the target light-emitting device group can receive the same light emission control packet. If the transmission resource is a split transmission resource, the processor 240 may transmit the light emission control packet such that different pieces of differential light emission control information correspond to different split transmission resources. If the transmission resource is a backup transmission resource, the processor 240 may transmit the light emission control packet to supplement the transmission of a primary repeater or another repeater.

The processor 240 may transmit the light emission control packet in any one of a time division transmission resource method, a frequency division transmission resource method, and a spatial division transmission resource method based on the transmission schedule. A time division transmission resource may be a transmission resource using different time slots. A frequency division transmission resource may be a transmission resource using different frequency bands or subchannels. A spatial division transmission resource may be a transmission resource using different transmission directions, beams, antenna patterns, or spatial streams.

For example, if the transmission schedule designates a time division transmission resource, the processor 240 may transmit differential light emission control information corresponding to a first subgroup in a first time slot and transmit differential light emission control information corresponding to a second subgroup in a second time slot. If the transmission schedule designates a frequency division transmission resource, the processor 240 may transmit differential light emission control information corresponding to a first subgroup in a first subchannel and transmit differential light emission control information corresponding to a second subgroup in a second subchannel. If the transmission schedule designates a spatial division transmission resource, the processor 240 may transmit differential light emission control information corresponding to a first spatial area using a first beam and transmit differential light emission control information corresponding to a second spatial area using a second beam.

The second communication device 220 may transmit a light emission control packet using an IEEE 802.11ah-based Wi-Fi HaLow communication method. The repeater 200 can improve transmission stability for a plurality of light-emitting devices using at least one of long-range communication characteristics, sub-1GHz band communication characteristics, TWT-based wake-up control, RAW-based group access control, frequency resource division, and spatial resource division provided in the Wi-Fi HaLow communication method.

For example, if the reception control interval of the target light-emitting device group is set as a reception interval corresponding to TWT, the processor 240 may transmit a light emission control packet in accordance with the reception interval. If the reception control interval of the target light-emitting device group is set as a restricted access interval corresponding to RAW, the processor 240 may transmit a light emission control packet so that light-emitting devices belonging to the target light-emitting device group can perform communication access in the restricted access interval.

For example, if a frequency division transmission resource is designated, the processor 240 may transmit a light emission control packet corresponding to different subgroups using a plurality of subchannels or frequency bands. If a spatial division transmission resource is designated, the processor 240 may control the antenna device 250 to form different beams or transmission directions. The antenna device 250 may form a beam pattern corresponding to a location of the target light-emitting device group or a spatial area of a subgroup.

The antenna device 250 may include at least one of one or more omnidirectional antennas and one or more directional antennas. The omnidirectional antenna may be an antenna that radiates or receives a signal uniformly in all directions, and may form a signal coverage range having a circular or spherical shape around the antenna. The directional antenna may be an antenna that concentrates a signal in a specific direction, and may form a signal coverage range having a long and narrow beam pattern in the specific direction.

The omnidirectional antenna may be implemented as at least one of a dipole antenna, a monopole antenna, a loop antenna, a slot antenna, an inverted-F antenna, a chip antenna, and a patch antenna. The directional antenna may be implemented as at least one of a Yagi-Uda antenna, a parabolic antenna, a horn antenna, an array antenna, a log-periodic antenna, a helical antenna, and a microstrip patch array antenna. However, the present disclosure is not limited thereto, and the repeater 200 may selectively use a type of antenna having optimal performance based on at least one of a structure of a performance space and a communication environment.

The directional antenna may be implemented as a beamforming antenna. The beamforming antenna may electronically control a direction of a signal beam without physical rotation by adjusting at least one of a phase and an amplitude of each of a plurality of antenna elements. The processor 240 may control the beamforming antenna to change a direction of the signal beam in real time, and may precisely transmit a light emission control packet in accordance with a dynamically changing target spatial area.

The repeater 200 may operate the antenna device 250 in a hybrid scheme combining the omnidirectional antenna and the directional antenna. For example, in an initial communication setup stage or a global synchronization stage, the processor 240 may control the antenna device 250 to transmit a light emission control packet to all light-emitting devices 100 within a coverage range using the omnidirectional antenna. Subsequently, in a differential control stage for a specific light-emitting device group or a specific spatial area, the processor 240 may control the antenna device 250 to transmit a light emission control packet to a target spatial area using the directional antenna.

According to an embodiment, the processor 240 may select one of an omnidirectional transmission method and a directional transmission method based on at least one of information on a reception target range included in a light emission control packet, performance progress time information, and a result of determining spatial selectivity. For example, when a common command applied to all light-emitting devices in common, such as a performance start signal, a global synchronization signal, or an emergency control signal, is to be transmitted, the processor 240 may transmit the light emission control packet using the omnidirectional antenna. When different pieces of light emission control information are to be transmitted to each of a plurality of spatial areas, the processor 240 may transmit the light emission control packets using the directional antenna with a beam directed at each spatial area.

The processor 240 may receive reception state information or processing result information from a light-emitting device through an uplink response resource arranged within the reception control interval. The reception state information may include at least one of whether a packet is received, packet identification information, whether an error occurs, reception strength, signal quality, and whether it is a processing target packet. The processing result information may include at least one of whether light emission control information is applied, a current light emission state, and whether an error occurs.

For example, the processor 240 may store reception state information collected from an uplink response resource in the memory 230. The processor 240 may transmit the reception state information or the processing result information to the control device through the first communication device 210. The control device may calculate a reception failure rate of the target light-emitting device group based on the reception state information or the processing result information and update a transmission schedule of a next cycle.

For example, if it is confirmed that a reception failure of a specific light-emitting device group is repeated in the reception state information, the processor 240 may transmit transmission result information to the control device. Based on the transmission result information, the control device may increase at least one of a reception control interval length, a number of downlink transmission resources, a transmission repetition count, and a backup transmission resource in a next cycle. The repeater 200 may transmit the light emission control packet again in the next cycle according to an updated transmission schedule.

The processor 240 may perform different transmission operations depending on whether the repeater 200 operates as a primary repeater or a secondary repeater. A primary repeater may be a repeater determined to primarily perform transmission of a light emission control packet for a target light-emitting device group. A secondary repeater may be a repeater determined to supplement or back up the transmission of the primary repeater.

For example, if the repeater 200 is set as a primary repeater, the processor 240 may transmit a light emission control packet using a basic downlink transmission resource included in the transmission schedule. If the repeater 200 is set as a secondary repeater, the processor 240 may transmit a light emission control packet when a backup transmission resource is activated. When a backup transmission instruction is received from the control device, the processor 240 may transmit the light emission control packet at a transmission timing or on a transmission channel corresponding to the backup transmission resource.

For example, if a target light-emitting device group is included in a transmittable range of two or more repeaters, the control device may determine a primary repeater and a secondary repeater based on at least one of congestion, a reception failure history, a transmittable range, and communication quality of the repeaters. The processor 240 may use a basic transmission resource or a backup transmission resource based on role information assigned to the repeater 200. If congestion or reception failure of the primary repeater is confirmed, the secondary repeater may transmit the light emission control packet through a backup transmission resource.

The repeater 200 may not necessarily be limited to essentially including all of the components shown in FIG. 4. Depending on the implementation form, the repeater 200 may include more components than the components shown in FIG. 4, or may include only some of the components shown in FIG. 4. For example, the repeater 200 may further include at least one of a positioning device, a sensor, a cooling device, a display device, a security module, a backup communication device, an installation angle adjustment device, and a housing.

The repeater 200 of FIG. 4 verifies whether a transmission resource included in a transmission schedule is arranged within a reception control interval of a target light-emitting device group and transmits a light emission control packet based on a result of the verification. The repeater 200 can improve transmission stability of a light emission control packet using at least one of a common transmission resource, a split transmission resource, a downlink transmission resource, an uplink response resource, and a backup transmission resource. The repeater 200 can efficiently control a large-scale light-emitting device group using at least one of a Wi-Fi HaLow communication method, a TWT-compatible reception interval, a RAW-compatible restricted access interval, a frequency division transmission resource, and a spatial division transmission resource.

FIG. 5 is a diagram illustrating a structure of a light emission control packet according to some exemplary embodiments. The light emission control packet may be generated by the control device 300 and may be transmitted to at least one of the plurality of light-emitting devices 100 through the repeater 200. The light-emitting device 100 may receive the light emission control packet and control the light source device 120 based on information included in the light emission control packet.

Referring to FIG. 5, the light emission control packet may include at least one of packet identification information, information on a reception target range, execution time information, light emission control information, priority information, version information, error detection information, and valid time information. The types, order, lengths, and data formats of fields included in the light emission control packet may not be limited to the example shown in FIG. 5. For example, the light emission control packet may include some fields or omit some fields based on at least one of a type of performance production information, a transmission method, a transmission condition, an operation mode of the light-emitting device 100, and a transmission environment of the repeater 200.

The packet identification information may be information for identifying a light emission control packet. The packet identification information may be used to prevent the light-emitting device 100 from redundantly processing the same light emission control packet. The packet identification information may also be used to determine a transmission history of light emission control packets, whether reception is missing, whether re-transmission is necessary, or whether calibration transmission is necessary. For example, the packet identification information may include at least one of a packet number, a sequence number, a packet generation time, a packet group number, and performance section identification information.

The information on the reception target range may be information representing a range of light-emitting devices 100 to which a light emission control packet or light emission control information is to be applied. The information on the reception target range may be used as a reference for the control device 300 to determine a transmission method, and may be used as a reference for the light-emitting device 100 to determine whether a light emission control packet is a processing target packet. For example, the information on the reception target range may include at least one of a global target indication value, light-emitting device group identification information, individual light-emitting device identification information, target area information based on a performance space, seat information, transmittable range information, and a state condition of a light-emitting device.

The execution time information may be information representing a timing at which light emission control information is to be applied to the light-emitting device 100. The execution time information may be used to distinguish a reception timing of a light emission control packet from an actual application timing of the light emission control information. For example, the execution time information may include at least one of immediate execution information, a reserved execution time, an application timing corresponding to a performance progress time, a performance reference time, a scene start time, a valid time, an expiration time, and a delay tolerance value. The light-emitting device 100 may perform at least one of immediate application, application after standby storage, or non-application of the light emission control information based on the execution time information.

The performance type information may be information for determining an operation mode of the light-emitting device 100. The performance type information may indicate any one operation mode between a scenario mode and a real-time mode. The performance type information may be implemented as at least one of a flag bit and a data field having a predetermined value in a header or a payload of the light emission control packet, and the processor 140 may determine the operation mode by parsing the performance type information.

The scenario mode may be an operation mode in which the light-emitting device 100 executes light emission scenario information stored in advance in the memory 130. When the performance type information indicates the scenario mode, the processor 140 may extract light emission scenario information corresponding to a synchronization time included in the light emission control packet from the memory 130 and control the light source device 120 based on the extracted light emission scenario information. The synchronization time may include at least one of a timestamp representing a specific time point after the start of a performance, a scene start time, and a performance reference time. The light emission scenario information may be a set of data in which a change over time of at least one of a light emission color, brightness, a blinking period, and a pattern is defined in advance.

The real-time mode may be an operation mode in which the light-emitting device 100 operates based on light emission control information received in real time. When the performance type information indicates the real-time mode, the processor 140 may extract light emission control information included in the light emission control packet and control the light source device 120 in real time based on the extracted light emission control information. According to the real-time mode, the light-emitting device 100 may immediately change at least one of a light emission color, brightness, and a blinking pattern whenever a new light emission control packet is received.

According to an embodiment, the light emission scenario information stored in the memory 130 may enable a plurality of light-emitting devices 100 to perform a synchronized light emission operation without continuous communication with the control device 300 by being executed in accordance with the synchronization time included in the light emission control packet.

The light emission control information may be information for controlling the light source device 120 of the light-emitting device 100. The light emission control information may be used to output a visual effect corresponding to performance production information from the light-emitting device 100. For example, the light emission control information may include at least one of a color value, a brightness value, a blinking period, a blinking count, a fade-in time, a fade-out time, pattern identification information, an effect parameter, and a light emission maintenance time. The light-emitting device 100 may perform at least one of single-color light emission, multi-color light emission, blinking light emission, sequential light emission, fade light emission, and pattern light emission based on the light emission control information.

The light emission control packet may further include RF information. The RF information may be information related to a wireless communication environment between the repeater 200 and the light-emitting device 100. The RF information may include at least one of communication channel information of a wireless communication network and reception signal strength information. The communication channel information may designate a specific frequency channel to be used by the light-emitting device 100 for communication with the repeater 200. The reception signal strength information may be used as a reference for the light-emitting device 100 to determine a quality of a current communication state.

The priority information may be information for determining a transmission order or a processing order of light emission control packets. The repeater 200 may determine a transmission order among a plurality of light emission control packets based on the priority information. The light-emitting device 100 may also determine an application order among a plurality of processing target packets based on the priority information. For example, the priority information may be used to distinguish a processing order of at least one among real-time production change, emergency control, synchronization calibration, general production control, and subsequent transmission control.

The version information may be information for identifying a version of a light emission control packet, performance production information, light emission control information, or group update information. The light-emitting device 100 may determine whether the received light emission control packet is the latest information based on the version information. For example, the version information may include at least one of a packet structure version, a performance production information version, a light emission control information version, a group update information version, and a differential update version. The light-emitting device 100 may compare version information stored in the memory 130 with version information of the received light emission control packet and may not process a light emission control packet of a previous version.

The error detection information may be information for detecting a transmission error or data damage of a light emission control packet. The light-emitting device 100 may determine the integrity of the light emission control packet based on the error detection information. For example, the error detection information may include at least one of a checksum, a CRC (Cyclic Redundancy Check), a hash value, an error correction code, and a packet length verification value. The light-emitting device 100 may not process a light emission control packet in which an error is detected, or may transmit processing result information indicating whether an error occurred to an external device.

The valid time information may be information representing a time range in which a light emission control packet or light emission control information can be validly applied. The valid time information may be included as a portion of the execution time information or may be included as a separate field. The light-emitting device 100 may determine whether the light emission control packet is valid based on the valid time information. For example, the light-emitting device 100 may not determine a light emission control packet for which a valid time has elapsed as a processing target packet, or may not apply light emission control information even for a light emission control packet determined as a processing target packet.

The light emission control packet may be configured in different forms according to a reception target range or a transmission method. For example, a light emission control packet targeting all light-emitting devices may include information on a reception target range representing all light-emitting devices and common light emission control information. A light emission control packet targeting a light-emitting device group may include light-emitting device group identification information or target area information based on a performance space. A light emission control packet targeting an individual light-emitting device may include individual light-emitting device identification information and individual light emission control information.

The light emission control packet may have different structures according to an operation mode. For example, a light emission control packet of a scenario mode may include information indicating a start, stop, or application timing of a specific operation using pre-entered performance information or operation information for each performance. A light emission control packet of a real-time mode may include light emission control information generated during a performance and information on a reception target range. A light emission control packet of a calibration mode may be configured as a calibration packet indicating a light emission state corresponding to a current performance progress time.

After receiving a light emission control packet, the processor 140 of the light-emitting device 100 may process information included in the light emission control packet sequentially or in parallel. For example, the processor 140 may determine at least one of integrity, redundancy, and validity of the light emission control packet based on at least one of packet identification information, version information, error detection information, and valid time information. The processor 140 may determine whether the light emission control packet is a processing target packet based on the information on the reception target range. If the light emission control packet is a processing target packet, the processor 140 may determine an application timing of the light emission control information based on the execution time information, and control the light source device 120 based on the light emission control information at the application timing.

The light emission control packet may not necessarily be limited to including all of the fields shown in FIG. 5. Depending on the implementation form, the light emission control packet may include more fields than the fields shown in FIG. 5, or may include only some of the fields shown in FIG. 5. For example, the light emission control packet may further include at least one of mode information, transmittable range information, transmission channel information, reception standby time information, re-transmission information, calibration information, group update information, current device correspondence information update information, and transmission condition information.

The light emission control packet of FIG. 5 may not be limited to a simple control message delivering only light emission control information. The light emission control packet includes at least one of light emission control information, information on a reception target range, execution time information, and valid time information, thereby supporting both the determination of a transmission method by the control device 300 and the determination of a processing target packet by the light-emitting device 100. The light emission control packet may be used for at least one of real-time production according to performance progress time, selective transmission by target category, synchronization of execution timing, repeated transmission, re-transmission, and calibration transmission.

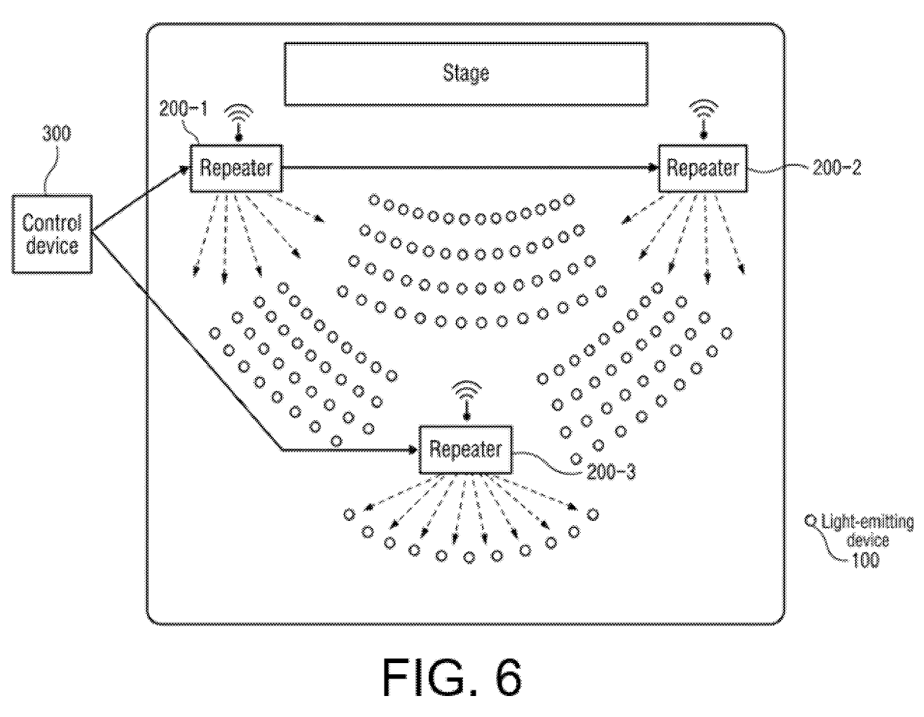

FIG. 6 is a diagram illustrating an embodiment of light-emitting device arrangement and packet transmission within a concert hall according to some exemplary embodiments. A light-emitting device control system may transmit a light emission control packet to a plurality of light-emitting devices 100 disposed in a performance space, and may control the light-emitting devices to perform a light emission operation based on light emission control information included in the light emission control packet. The performance space may include at least one among a concert hall, a stadium, an outdoor event space, and a fan meeting venue.

Referring to FIG. 6, a control device 300, a plurality of repeaters 200-1, 200-2, and 200-3, and a plurality of light-emitting devices 100 may be disposed in the performance space. The plurality of light-emitting devices 100 may be carried by audience members, disposed at spectator seats, or installed at a specific position within the performance space. The plurality of repeaters 200-1, 200-2, and 200-3 may be disposed at different positions based on at least one of a structure of the performance space, distribution of the light-emitting devices 100, a reception target range, and a transmittable range.

The control device 300 may be connected to the plurality of repeaters 200-1, 200-2, and 200-3 through at least one method among a wired communication method, a wireless communication method, and a mixed wired/wireless communication method. The control device 300 may generate a light emission control packet based on performance production information, and determine a transmission method, a transmission condition, and a repeater to transmit the light emission control packet based on a reception target range of the light emission control packet.

The control device 300 may select at least one repeater based on a correspondence relationship between a reception target range and a transmittable range of each of the plurality of repeaters. For example, a first repeater 200-1 may correspond to light-emitting devices 100 disposed in a first area of the performance space. A second repeater 200-2 may correspond to light-emitting devices 100 disposed in a second area of the performance space. A third repeater 200-3 may correspond to light-emitting devices 100 disposed in a third area of the performance space.

For example, each of the plurality of repeaters 200-1, 200-2, and 200-3 may have a transmittable range corresponding to a different block, floor, or row of spectator seats, or a different area relative to the performance space. When the reception target range corresponds to a first block, the control device 300 may select the first repeater 200-1 having the first block as its transmittable range.

For example, when the reception target range spans across a plurality of transmittable ranges, the control device 300 may select a plurality of repeaters together. The control device 300 may set different transmission conditions for each selected repeater based on at least one of a transmittable range for each repeater, a channel state, a transmission history, and a congestion state.

The plurality of repeaters 200-1, 200-2, and 200-3 may receive a light emission control packet and a transmission condition from the control device 300. The plurality of repeaters 200-1, 200-2, and 200-3 may transmit the light emission control packet to at least one of the plurality of light-emitting devices 100 based on the transmission condition. For example, the plurality of repeaters 200-1, 200-2, and 200-3 may transmit the same light emission control packet in different transmittable ranges. As another example, the plurality of repeaters 200-1, 200-2, and 200-3 may transmit different light emission control packets to different light-emitting device groups.

The plurality of repeaters 200-1, 200-2, and 200-3 may apply a transmission method corresponding to the reception target range. For example, a light emission control packet targeting all light-emitting devices may be transmitted over a wide transmittable range through the plurality of repeaters 200-1, 200-2, and 200-3. A light emission control packet targeting a specific light-emitting device group may be transmitted through a repeater corresponding to the light-emitting device group. A light emission control packet targeting an individual light-emitting device may be transmitted through a repeater capable of communicating with the individual light-emitting device.

The repeaters 200-1, 200-2, and 200-3 may transmit the light emission control packet through a sub-1GHz band wireless communication method or an IEEE 802.11ah-based Wi-Fi HaLow communication method. The repeaters 200-1, 200-2, and 200-3 may adjust at least one of a transmission timing, a transmission repetition count, a transmission priority, a transmission channel, whether to re-transmit, and whether to perform calibration transmission according to the transmission condition.

The light-emitting device 100 may receive the light emission control packet from at least one among the repeaters 200-1, 200-2, and 200-3. The light-emitting device 100 may determine whether the light emission control packet is a processing target packet based on information on a reception target range included in the light emission control packet. If the light emission control packet is a processing target packet, the light-emitting device 100 may determine an application timing of light emission control information based on execution time information, and control the light source device 120 based on the light emission control information at the application timing.

For example, at a performance start timing, the control device 300 may generate a light emission control packet targeting all light-emitting devices. The plurality of repeaters 200-1, 200-2, and 200-3 may transmit the light emission control packet targeting all light-emitting devices within their respective transmittable ranges. The plurality of light-emitting devices 100 may perform a light emission operation at an application timing corresponding to the same performance progress time based on the execution time information.

As another example, during a performance, the control device 300 may generate a light emission control packet targeting a specific light-emitting device group or a target area based on a specific performance space. The control device 300 may select a specific repeater based on a correspondence relationship between the reception target range and the transmittable range of the repeaters 200-1, 200-2, and 200-3. The selected repeater may transmit the light emission control packet to the specific light-emitting device group according to a transmission condition. A light-emitting device 100 belonging to the specific light-emitting device group may perform at least one of a color change, a brightness change, a blinking operation, a fade operation, and a pattern output based on the light emission control information.

The light-emitting device control system of FIG. 6 may determine a packet transmission target based on a transmission condition and information on a reception target range of a light emission control packet, without fixedly depending on seat information or ticket information. For example, the control device 300 may identify a light-emitting device group based on correspondence information between a preset light-emitting device group and a target area based on a performance space. The control device 300 may also identify a light-emitting device group requiring calibration based on a reception state or a current light emission state of the light-emitting device.

The control device 300 may determine a re-transmission condition or a calibration transmission condition targeting a light-emitting device 100 or a light-emitting device group for which reception failure has been confirmed. The repeaters 200-1, 200-2, and 200-3 may transmit the same light emission control packet a plurality of times or may transmit a calibration packet indicating a light emission state corresponding to the current performance progress time according to the transmission condition.

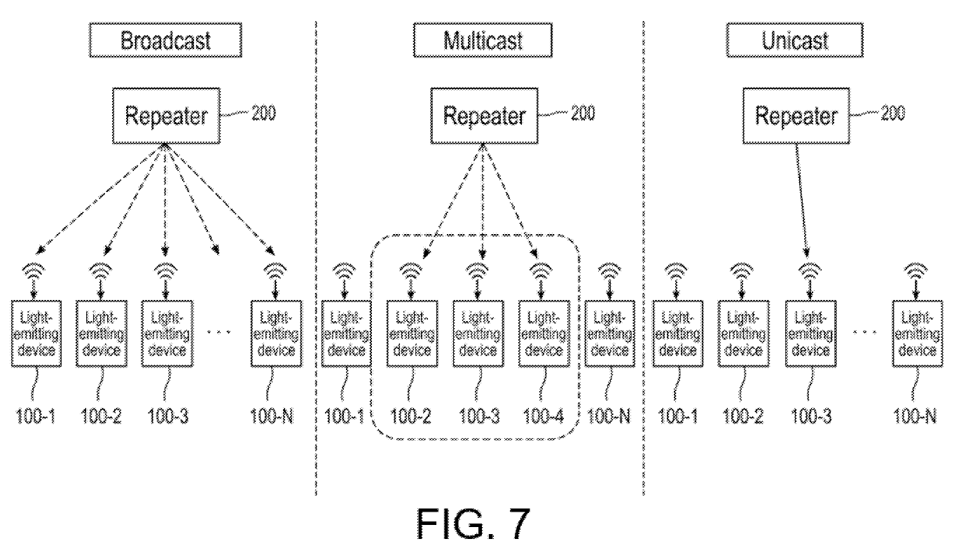

FIG. 7 is a diagram illustrating an embodiment of selecting a transmission method for a light emission control packet according to some exemplary embodiments. A light-emitting device control system may select a transmission method for a light emission control packet based on at least one of information on a reception target range of the light emission control packet, execution time information, priority information, a packet size, transmission history information, and light-emitting device state information.

Referring to FIG. 7, a control device 300 may generate a light emission control packet based on performance production information. The light emission control packet may include light emission control information and information on a reception target range. The control device 300 may determine which target category among all light-emitting devices, a light-emitting device group, and an individual light-emitting device to transmit the light emission control packet to, based on the information on the reception target range.

The control device 300 may select a transmission method based on the determined target category. The transmission method may include at least one of a method receivable by all light-emitting devices, a method receivable by a light-emitting device group, and a method receivable by an individual light-emitting device.

For example, the method receivable by all light-emitting devices may be used for at least one of performance start synchronization, global color change, global brightness change, global blinking, and global turning-off. The method receivable by a light-emitting device group may be used to control a target area based on a specific performance space, a specific light-emitting device group, or a light-emitting device group that will output the same light emission effect. The method receivable by an individual light-emitting device may be used for at least one of setting update, state confirmation, missing packet calibration, and individual light emission control for individual light-emitting devices.

The control device 300 may determine a transmission condition based on a correspondence relationship between a reception target range and a transmission method. The transmission condition may include at least one of a transmission method, a transmission target, a transmission timing, a transmission repetition count, a transmission priority, whether to re-transmit, and whether to perform calibration transmission. For example, when the reception target range corresponds to all light-emitting devices, the control device 300 may determine the transmission condition to transmit the light emission control packet over a wide transmittable range. When the reception target range corresponds to a light-emitting device group, the control device 300 may determine the transmission condition to use a repeater 200 or a transmittable range corresponding to the light-emitting device group. When the reception target range corresponds to an individual light-emitting device, the control device 300 may determine the transmission condition to use a repeater 200, a transmission channel, or a transmission repetition condition capable of communicating with the individual light-emitting device.

The transmission method may not necessarily be limited to being uniformly determined by fixed group information. The control device 300 may dynamically determine the transmission method based on at least one of performance progress time, a production target, execution time information, priority information, information on a transmission result, and state information of a light-emitting device. For example, the control device 300 may cause the same light-emitting device 100 to correspond to different light-emitting device groups according to a performance progress time. The control device 300 may set a light-emitting device group requiring calibration as a reception target range based on a reception failure, an error state, or a current light emission state of the light-emitting device 100. The control device 300 may select a transmission method wider than the reception target range for a light emission control packet for emergency control, or may increase the transmission repetition count.

The repeater 200 may transmit the light emission control packet in a selected transmission method based on the transmission condition received from the control device 300. For example, the repeater 200 may transmit the light emission control packet through an IEEE 802.11ah-based Wi-Fi HaLow communication method. The repeater 200 may transmit the light emission control packet using at least one of broadcasting, group-unit transmission, individual transmission, RF channel division, continuous transmission of the same information, and beam pattern-based transmission. The repeater 200 may apply an omnidirectional transmission mode for a wide transmittable range, and may apply a directional transmission mode or a beam pattern-based transmission mode for a target area based on a specific performance space.

The light-emitting device 100 may determine whether a light emission control packet is a processing target packet based on information on a reception target range included in the received light emission control packet. For example, when information on the reception target range indicates a target category corresponding to all light-emitting devices, the light-emitting device 100 may determine the light emission control packet as a processing target packet. When information on the reception target range indicates a target category corresponding to a light-emitting device group, the light-emitting device 100 may determine whether it is a processing target packet based on current device correspondence information. When information on the reception target range indicates a target category corresponding to an individual light-emitting device, the light-emitting device 100 may determine whether it is a processing target packet based on device identification information.

The control device 300 may generate a plurality of light emission control packets from one piece of performance production information. For example, the control device 300 may simultaneously generate a light emission control packet targeting all light-emitting devices and a light emission control packet targeting a specific light-emitting device group. The control device 300 may also generate a calibration packet targeting an individual light-emitting device to calibrate a reception state of some light-emitting devices 100. The plurality of light emission control packets may be transmitted in different orders or in different transmission methods based on at least one of execution time information, priority information, and transmission conditions.

In the embodiment of FIG. 7, the light-emitting device control system may select a transmission method based on transmission conditions and information on a reception target range of a light emission control packet, without fixedly depending on seat information or ticket information. The light-emitting device control system may selectively use at least one of: a method receivable by all light-emitting devices; a method receivable by a light-emitting device group; and a method receivable by an individual light-emitting device, even during the same performance.

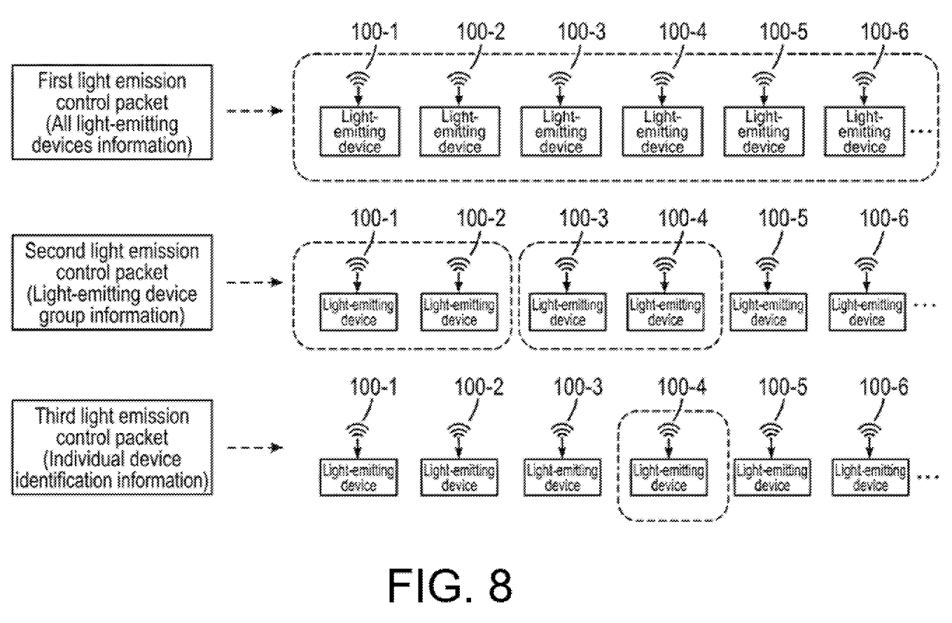

FIG. 8 is a diagram illustrating an embodiment of an application range of a light emission control packet based on information on a reception target range according to some exemplary embodiments. A light emission control packet may include light emission control information and information on a reception target range. After receiving the light emission control packet, the light-emitting device 100 may determine whether the light emission control packet is a processing target packet based on the information on the reception target range.

Referring to FIG. 8, the light emission control packet may have a target category corresponding to at least one of all light-emitting devices, a light-emitting device group, and an individual light-emitting device. For example, a first light emission control packet may have a target category corresponding to all light-emitting devices. A second light emission control packet may have a target category corresponding to a light-emitting device group. A third light emission control packet may have a target category corresponding to an individual light-emitting device.

In the embodiment of FIG. 8, after the light emission control packet is transmitted, the light-emitting device 100 may compare information on a reception target range with at least one of device identification information and current device correspondence information. Based on a comparison result, the light-emitting device 100 may determine whether the received light emission control packet is a processing target packet applied to the light-emitting device 100.

The information on the reception target range may be information representing a range of light-emitting devices 100 to which light emission control information is to be applied. The information on the reception target range may include at least one of a global target indication value, light-emitting device group identification information, individual light-emitting device identification information, target area information based on a performance space, seat information, transmittable range information, and a state condition of a light-emitting device. For example, the global target indication value may indicate that light emission control information is applied to all of the plurality of light-emitting devices 100. The light-emitting device group identification information may indicate that light emission control information is applied to a specific light-emitting device group. The individual light-emitting device identification information may indicate that light emission control information is applied to a specific light-emitting device 100.

For example, when information on a reception target range includes light-emitting device group identification information corresponding to a first block based on a performance space, a light-emitting device 100 having current device correspondence information corresponding to the first block may determine the light emission control packet as a processing target packet. A light-emitting device 100 having current device correspondence information not corresponding to the first block may not process the light emission control packet.

For example, when information on a reception target range indicates a light-emitting device group in a reception failure state, a light-emitting device 100 that has stored reception failure information or error state information of a previous light emission control packet as current device correspondence information may determine a re-transmission packet or a calibration packet as a processing target packet.

For example, when information on a reception target range includes individual light-emitting device identification information, a light-emitting device 100 whose device identification information matches the individual light-emitting device identification information may determine the light emission control packet as a processing target packet, and a light-emitting device 100 whose device identification information does not match may not process the light emission control packet.

Current device correspondence information may be information for determining which light-emitting device group or state condition the light-emitting device 100 currently corresponds to. The current device correspondence information may include at least one of information on a light-emitting device group to which the light-emitting device 100 currently belongs and current state information of the light-emitting device 100. The current device correspondence information may be updated based on at least one of a performance progress time, a previously received light emission control packet, group update information, and state information of the light-emitting device 100. For example, one light-emitting device 100 may correspond to a first light-emitting device group in a first performance section, and may correspond to a second light-emitting device group in a second performance section.

For example, when the performance progress time is changed from the first performance section to the second performance section, the light-emitting device 100 may update the current device correspondence information from the first light-emitting device group to the second light-emitting device group. When receiving a light emission control packet including group update information, the light-emitting device 100 may store light-emitting device group identification information designated by the group update information as current device correspondence information.

For example, when the light-emitting device 100 fails to normally process a previous light emission control packet, it may record a reception failure state in the current device correspondence information. When the remaining battery amount is a reference value or less, the light-emitting device 100 may record a low-power state in the current device correspondence information. The control device 300 may identify a light-emitting device group targeting re-transmission or calibration using the state information included in the current device correspondence information.

A first light emission control packet may be generated targeting all light-emitting devices. The first light emission control packet may include information on a reception target range indicating a target category corresponding to all light-emitting devices. For example, the first light emission control packet may be used for at least one of performance start synchronization, global color change, global brightness change, global blinking, and global turning-off. Upon receiving the first light emission control packet, the light-emitting device 100 may determine the first light emission control packet as a processing target packet regardless of detailed values of device identification information or current device correspondence information.

A second light emission control packet may be generated targeting a light-emitting device group. The second light emission control packet may include information on a reception target range representing a target category corresponding to a light-emitting device group. The light-emitting device 100 may determine whether the second light emission control packet is a processing target packet by comparing information on a reception target range of the second light emission control packet with current device correspondence information. For example, the light-emitting device group may be at least one of: a set of light-emitting devices 100 disposed in a target area based on a specific performance space; a set of light-emitting devices 100 to output the same light emission effect in a specific performance scene; and a set of light-emitting devices 100 having the same reception state or error state.

A third light emission control packet may be generated targeting an individual light-emitting device. The third light emission control packet may include information on a reception target range representing a target category corresponding to an individual light-emitting device. The light-emitting device 100 may determine whether the third light emission control packet is a processing target packet by comparing information on a reception target range of the third light emission control packet with device identification information. For example, the third light emission control packet may be used for at least one of setting update, state confirmation, missing packet calibration, individual light emission control, and calibration packet transmission for individual light-emitting devices.

A light emission control packet may include execution time information and light emission control information together with information on a reception target range. If the light emission control packet is a processing target packet, the light-emitting device 100 may determine an application timing of light emission control information based on execution time information. The light-emitting device 100 may control the light source device 120 based on the light emission control information at the application timing. For example, the light-emitting device 100 may immediately apply light emission control information if the execution time information indicates immediate execution. If the execution time information indicates an application timing corresponding to a reserved execution time or a performance progress time, the light-emitting device 100 may temporarily store the light emission control information in the memory 130 and apply the light emission control information at the application timing.

A light-emitting device group may not be limited to a group fixed by seat information or ticket information. A light-emitting device group may be determined based on at least one of a target area based on a performance space, identification information of a light-emitting device group, identification information of an individual light-emitting device, a state condition of a light-emitting device, group update information, and a previously received light emission control packet. For example, the control device 300 may set a light-emitting device group corresponding to a first area in a specific performance section as a first light-emitting device group, and may set a light-emitting device group for which reception failure has been confirmed in another performance section as a second light-emitting device group. The light-emitting device 100 may update current device correspondence information after receiving a light emission control packet including group update information.

In the embodiment of FIG. 8, a light emission control packet may jointly define light emission control information and a reception target range to which the light emission control information is to be applied. The control device 300 may determine a transmission method based on information on a reception target range, and the light-emitting device 100 may determine whether a light emission control packet is a processing target packet based on information on a reception target range. The light-emitting device control system may selectively control at least one of all light-emitting devices, a light-emitting device group, and an individual light-emitting device.

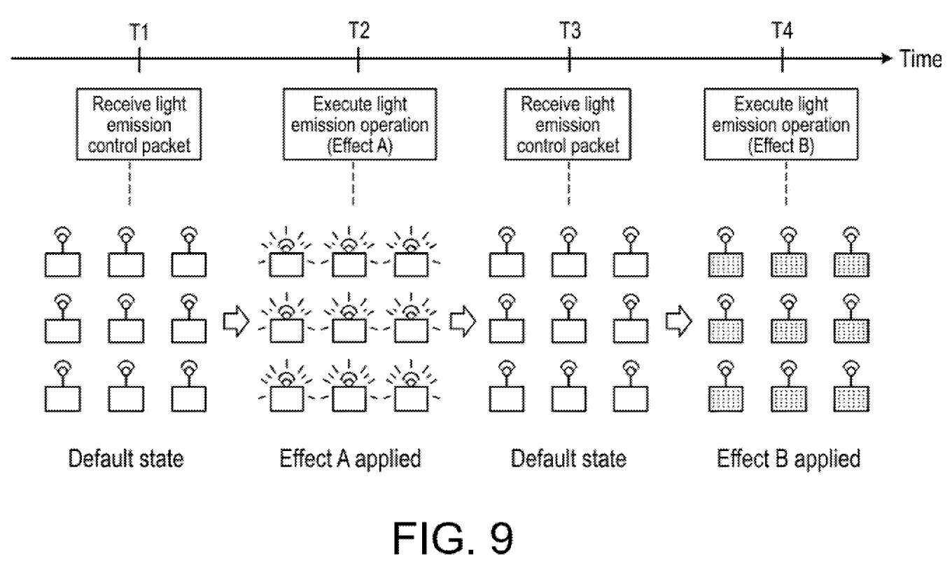

FIG. 9 is a diagram illustrating an embodiment of a light emission operation based on execution time information according to some exemplary embodiments. A light-emitting device control system may control an application timing of light emission control information based on execution time information included in a light emission control packet. The light-emitting device 100 may process a reception timing of a light emission control packet and an application timing of light emission control information by distinguishing them from each other.

Referring to FIG. 9, a light-emitting device 100 may receive a first light emission control packet at a first timing T1 and apply first light emission control information included in the first light emission control packet at a second timing T2. The light-emitting device 100 may receive a second light emission control packet at a third timing T3 and apply second light emission control information included in the second light emission control packet at a fourth timing T4. The first light emission control information and the second light emission control information may indicate different light emission effects.

In the embodiment of FIG. 9, after receiving a light emission control packet in advance, the light-emitting device 100 may determine an application timing of light emission control information based on execution time information. Execution time information may represent at least one of immediate execution, a reserved execution time, an application timing corresponding to a performance progress time, a valid time, and an expiration time. The light-emitting device 100 may perform at least one among immediate application, application after standby storage, and non-application of light emission control information by comparing execution time information with a current performance progress time or an internal reference time.

For example, when execution time information indicates immediate execution, the light-emitting device 100 may immediately apply light emission control information after determining whether a light emission control packet is a processing target packet. When execution time information indicates an application timing corresponding to a reserved execution time or a performance progress time, the light-emitting device 100 may temporarily store light emission control information in a memory 130 and apply the light emission control information at the application timing. When execution time information includes a valid time or an expiration time and indicates that validity of a light emission control packet has been lost, the light-emitting device 100 may not apply light emission control information.

A first light emission control packet may include first execution time information and first light emission control information. The light-emitting device 100 may receive the first light emission control packet at a first timing T1 and apply the first light emission control information at a second timing T2 indicated by the first execution time information. For example, the first light emission control information may indicate at least one of global color change, output of a specific brightness, a blinking operation, a fade operation, and a pattern output.

A second light emission control packet may include second execution time information and second light emission control information. The light-emitting device 100 may receive the second light emission control packet at a third timing T3 and apply the second light emission control information at a fourth timing T4 indicated by the second execution time information. For example, the second light emission control information may indicate at least one among a color, brightness, a blinking period, a fade time, and a pattern effect different from those of the first light emission control information.

The light-emitting device 100 may determine an application order of a plurality of pieces of light emission control information based on application timings indicated by execution time information rather than a reception order of light emission control packets. For example, when an application timing of a later-received light emission control packet is earlier than that of an earlier-received light emission control packet, the light-emitting device 100 may apply light emission control information of the later-received light emission control packet first. The light-emitting device 100 may adjust an application order among a plurality of light emission control packets based on at least one of execution time information, priority information, valid time information, and an expiration time.

The control device 300 may determine a transmission condition of a light emission control packet based on a relationship between an application timing indicated by execution time information and a current performance progress time. Transmission conditions may include at least one of a transmission timing, a transmission repetition count, and a transmission priority. For example, the control device 300 may control a first light emission control packet to be transmitted at a first timing T1 so that all light-emitting devices 100 perform a first light emission operation at a second timing T2. The control device 300 may control a second light emission control packet to be transmitted at a third timing T3 so that a specific light-emitting device group performs a second light emission operation at a fourth timing T4.

The repeater 200 may transmit a light emission control packet based on transmission conditions. For example, the repeater 200 may transmit a light emission control packet before an application timing. The repeater 200 may transmit the same light emission control packet a plurality of times based on a transmission repetition count. The repeater 200 may transmit a light emission control packet for emergency control or synchronization calibration before other light emission control packets based on transmission priorities.

The light-emitting device control system of FIG. 9 may not be limited to a structure that performs a light emission operation only with identification information of a specific stored scenario and a start instruction. The light-emitting device control system may apply a light emission control packet generated during a performance or a light emission control packet generated before a performance according to execution time information. The light-emitting device 100 may determine an application timing of light emission control information based on execution time information for a light emission control packet determined as a processing target packet, and control a light source device 120 at the application timing.

According to the embodiment of FIG. 9, a plurality of light-emitting devices 100 may perform a light emission operation in accordance with the same application timing corresponding to a performance progress time, even if reception timings of light emission control packets are different from each other. Through this, the light-emitting device control system may align light emission timings of a plurality of light-emitting devices 100 in a large-scale performance space and stably implement light emission production corresponding to a performance progress time.

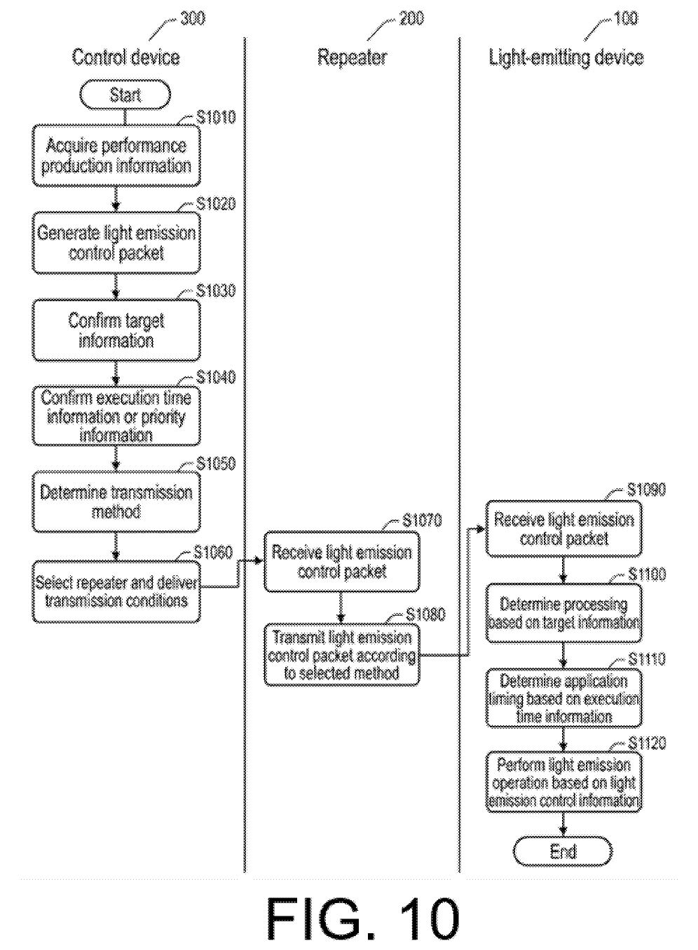

FIG. 10 is a flowchart illustrating a flow of determining and applying a transmission method for a light emission control packet according to some exemplary embodiments. The flow of FIG. 10 may be divided into operations of a control device 300, a repeater 200, and a light-emitting device 100. The control device 300 may generate a light emission control packet based on performance production information, and determine a transmission method based on information on a reception target range included in the light emission control packet. The repeater 200 may transmit a light emission control packet according to transmission conditions. The light-emitting device 100 may determine whether a received light emission control packet is a processing target packet, and determine an application timing of light emission control information based on execution time information.

In step S1010, the control device 300 may acquire performance production information. Performance production information may include at least one of performance progress time information, production target information, and light emission effect information. For example, the control device 300 may acquire performance production information from at least one of a performance operation server 500, a user interface device 320, an external storage device, and a performance control program.

In step S1020, the control device 300 may generate a light emission control packet based on performance production information. For example, the control device 300 may generate execution time information based on performance progress time information, generate information on a reception target range based on production target information, and generate light emission control information based on light emission effect information. A light emission control packet may include at least one of execution time information, information on a reception target range, and light emission control information.

In step S1030, the control device 300 may confirm information on a reception target range included in the light emission control packet. For example, the control device 300 may confirm whether the light emission control packet is applied to all light-emitting devices, a specific light-emitting device group, or a specific light-emitting device.

In step S1040, the control device 300 may confirm at least one of execution time information, priority information, and valid time information. For example, the control device 300 may determine whether light emission control information is information to be immediately applied, information to be applied at a reserved execution time, information to be applied at an application timing corresponding to a performance progress time, or information regarding emergency control or calibration control.

In step S1050, the control device 300 may determine a transmission method for the light emission control packet. The control device 300 may determine one of a plurality of transmission methods corresponding to different reception target ranges based on information on a reception target range. For example, the control device 300 may select one of a method receivable by all light-emitting devices, a method receivable by a light-emitting device group, and a method receivable by an individual light-emitting device. Depending on embodiments, the transmission method may be implemented as at least one of a broadcast method, a multicast method, and a unicast method.

In step S1060, the control device 300 may determine transmission conditions and select at least one repeater 200. Transmission conditions may include at least one of a transmission method, a transmission target, a transmission timing, a transmission repetition count, a transmission priority, whether to re-transmit, and whether to perform calibration transmission. For example, the control device 300 may select a repeater 200 to transmit a light emission control packet based on a correspondence relationship between a reception target range and a transmittable range of each of a plurality of repeaters.

In step S1070, the control device 300 may transmit a light emission control packet and transmission conditions to the selected repeater 200. The repeater 200 may receive the light emission control packet and the transmission conditions. The repeater 200 may store the light emission control packet in a memory 230 until a transmission timing indicated by a transmission condition.

In step S1080, the repeater 200 may transmit the light emission control packet based on transmission conditions. The repeater 200 may transmit the light emission control packet to at least one of a plurality of light-emitting devices 100 according to at least one of a transmission method, a transmission target, a transmission timing, a transmission repetition count, and a transmission priority. For example, the repeater 200 may transmit the light emission control packet through a sub-1GHz band wireless communication method or an IEEE 802.11ah-based Wi-Fi HaLow communication method.

In step S1090, the light-emitting device 100 may receive a light emission control packet from a repeater 200 or an external device. The light-emitting device 100 may temporarily store the received light emission control packet in a memory 130. The light-emitting device 100 may determine at least one of integrity, redundancy, and validity of the light emission control packet based on at least one of packet identification information, version information, error detection information, and valid time information.

In step S1100, the light-emitting device 100 may determine whether a light emission control packet is a processing target packet. The light-emitting device 100 may compare information on a reception target range included in the light emission control packet with at least one of device identification information and current device correspondence information. The light-emitting device 100 may determine whether a light emission control packet corresponding to all light-emitting devices, a specific light-emitting device group, or an individual light-emitting device is applied to the light-emitting device 100 based on a comparison result.

In step S1110, the light-emitting device 100 may determine an application timing of light emission control information based on execution time information. For example, when execution time information indicates immediate execution, the light-emitting device 100 may immediately apply light emission control information. When execution time information indicates an application timing corresponding to a reserved execution time or a performance progress time, the light-emitting device 100 may temporarily store light emission control information in a memory 130 and apply the light emission control information at the application timing. When it is determined that validity of a light emission control packet has been lost based on execution time information or valid time information, the light-emitting device 100 may not apply light emission control information.

In step S1120, the light-emitting device 100 may control a light source device 120 based on light emission control information at an application timing. For example, the light-emitting device 100 may perform at least one of color change, brightness change, a blinking operation, a fade operation, and a pattern output. The light-emitting device 100 may also generate processing result information representing at least one of: whether a light emission control packet is received; whether it is a processing target packet; whether light emission control information is applied; whether an error occurs; and a current light emission state.

In the flow of FIG. 10, some steps may be omitted or the order may be changed. For example, the control device 300 may perform confirmation of information on a reception target range in step S1030 and confirmation of execution time information or priority information in step S1040 in parallel. The control device 300 may also perform selection of a repeater in step S1060 before or after determination of a transmission method in step S1050. When a repeater 200 includes at least a portion of functions of the control device 300, the repeater 200 may perform at least one of steps S1020 to S1060.

In the embodiment of FIG. 10, the control device 300 may dynamically determine a transmission method or transmission conditions based on at least one of performance production information, information on a reception target range, execution time information, priority information, information on a transmission result, and state information of a light-emitting device. The light-emitting device 100 may control a light source device 120 after determining whether a light emission control packet is a processing target packet and an application timing of light emission control information.

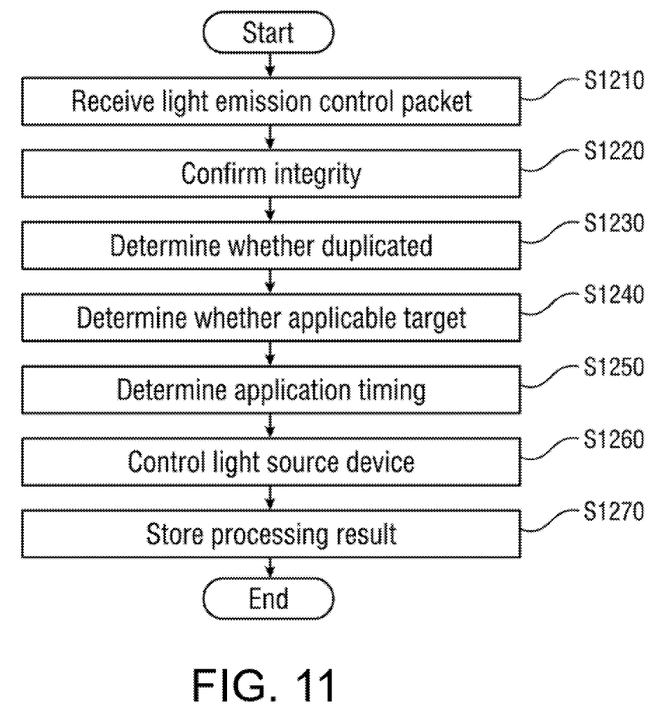

FIG. 11 is a flowchart illustrating a flow of processing a light emission control packet by a light-emitting device 100 according to some exemplary embodiments. The flow of FIG. 11 may represent a process in which a light-emitting device 100, having received a light emission control packet from an external device, determines whether the light emission control packet can be processed and controls a light source device 120 based on light emission control information.

In the embodiment of FIG. 11, the light-emitting device 100 may not be limited to performing a light emission operation immediately after receiving a light emission control packet. The light-emitting device 100 may apply light emission control information after determining at least one of integrity, redundancy, validity, whether it is a processing target packet, and an application timing.

In step S1210, the light-emitting device 100 may receive a light emission control packet from an external device. For example, a communication device 110 of the light-emitting device 100 may receive a light emission control packet from a repeater 200. A light emission control packet may include at least one of packet identification information, information on a reception target range, execution time information, light emission control information, priority information, version information, error detection information, and valid time information.

In step S1220, the light-emitting device 100 may determine at least one of integrity, redundancy, and validity of the light emission control packet. For example, a processor 140 may determine whether a transmission error or data damage occurred based on error detection information. The processor 140 may determine whether it is an already processed packet or a packet of a previous version based on packet identification information or version information. The processor 140 may determine whether a valid time of a light emission control packet has elapsed based on valid time information. The light-emitting device 100 may not process a packet in which an error is detected, a redundant packet, a previous version packet, or a packet for which a valid time has elapsed.

In step S1230, the light-emitting device 100 may determine whether a light emission control packet is a processing target packet. A processor 140 may compare information on a reception target range with at least one of device identification information and current device correspondence information. For example, when information on a reception target range indicates a target category corresponding to all light-emitting devices, the processor 140 may determine the light emission control packet as a processing target packet. When information on a reception target range indicates a target category corresponding to a light-emitting device group, the processor 140 may determine whether it is a processing target packet based on current device correspondence information. When information on a reception target range indicates a target category corresponding to an individual light-emitting device, the processor 140 may determine whether it is a processing target packet based on device identification information.

In step S1240, the light-emitting device 100 may determine an application timing of light emission control information based on execution time information. For example, when execution time information indicates immediate execution, the processor 140 may immediately apply light emission control information. When execution time information indicates an application timing corresponding to a reserved execution time or a performance progress time, the processor 140 may temporarily store light emission control information in a memory 130 and apply the light emission control information at the application timing. When validity of a light emission control packet has been lost, the processor 140 may not apply light emission control information.

In step S1250, the light-emitting device 100 may control a light source device 120 based on light emission control information at an application timing. Light emission control information may include at least one of a color value, a brightness value, a blinking period, a blinking count, a fade-in time, a fade-out time, pattern identification information, an effect parameter, and a light emission maintenance time. For example, the processor 140 may control the light source device 120 to emit light in a specific color. The processor 140 may also control the light source device 120 to emit light according to a designated brightness, a blinking period, a fade time, or a pattern effect.

In step S1260, the light-emitting device 100 may generate processing result information. Processing result information may represent at least one of: whether a light emission control packet is received; whether it is a processing target packet; whether light emission control information is applied; whether an error occurs; and a current light emission state. For example, the processor 140 may include packet identification information of a normally processed light emission control packet in processing result information. The processor 140 may also include, in the processing result information, whether an error occurred in the received light emission control packet.

In step S1270, the light-emitting device 100 may store processing result information in a memory 130 or transmit it to an external device through a communication device 110. Processing result information may be used for at least one of redundant packet determination, re-transmission packet processing, calibration packet processing, device state confirmation, and determination of subsequent transmission conditions. For example, a control device 300 may determine subsequent transmission conditions for repeated transmission, re-transmission, or calibration transmission based on processing result information collected from light-emitting devices 100.

In the flow of FIG. 11, some steps may be omitted or the order may be changed. For example, the light-emitting device 100 may perform at least one of integrity determination, redundancy determination, validity determination, and processing target packet determination in different orders. The light-emitting device 100 may simplify some determination steps and prioritize application of light emission control information for a light emission control packet including priority information for emergency control.

The light-emitting device 100 of FIG. 11 may not be limited to a structure of emitting light in a pre-set color to confirm whether setting data is received. The light-emitting device 100 may determine whether to process a light emission control packet and an application timing based on at least one of packet identification information, version information, error detection information, valid time information, information on a reception target range, and execution time information. The light-emitting device 100 may apply light emission control information for a light emission control packet determined as a processing target packet, and store processing result information or transmit it to an external device.

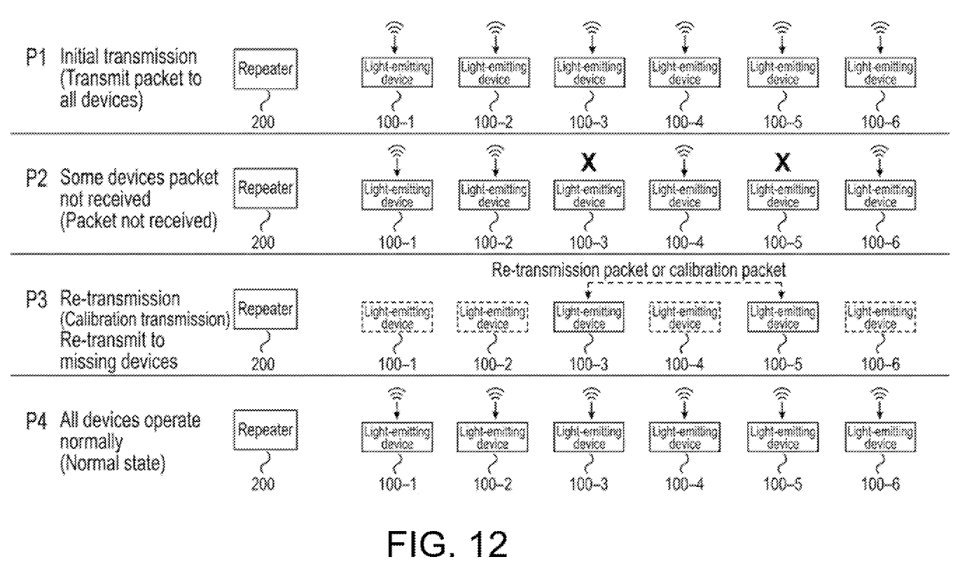

FIG. 12 is a diagram illustrating embodiments of repeated transmission, re-transmission, and calibration transmission according to some exemplary embodiments. After transmitting a light emission control packet, a light-emitting device control system may determine whether a subsequent transmission is necessary and subsequent transmission conditions based on information on a transmission result. Subsequent transmission conditions may include at least one of a repeated transmission condition for the same light emission control packet, a re-transmission condition for a previously transmitted light emission control packet, and a transmission condition for a calibration packet indicating a light emission state corresponding to a current performance progress time.

In the embodiment of FIG. 12, when packet loss, reception failure, error occurrence, or light emission state inconsistency occurs in some light-emitting devices 100, a control device 300 or a repeater 200 may perform subsequent transmission based on information on a transmission result. Repeated transmission may be an operation of transmitting the same light emission control packet a plurality of times. Re-transmission may be an operation of re-transmitting a previously transmitted light emission control packet. Calibration transmission may be an operation of transmitting a calibration packet indicating a light emission state corresponding to a current performance progress time.

In section P1 of FIG. 12, a repeater 200 may transmit a light emission control packet received from a control device 300 to at least one of a plurality of light-emitting devices 100. A light emission control packet may include at least one of information on a reception target range, execution time information, light emission control information, packet identification information, priority information, and valid time information. For example, the repeater 200 may transmit a light emission control packet targeting all light-emitting devices over a wide transmittable range, and may transmit a light emission control packet targeting a light-emitting device group or an individual light-emitting device in a selected transmission method.

In section P2 of FIG. 12, some light-emitting devices 100 may fail to normally process a light emission control packet. For example, some light-emitting devices 100 may fail to receive a light emission control packet due to a communication environment, reception sensitivity, a power state, temporary shielding, or a congestion state. As another example, even if receiving a light emission control packet, some light-emitting devices 100 may not apply light emission control information when integrity of the light emission control packet is not confirmed based on error detection information.

The control device 300 may determine whether a subsequent transmission is necessary based on information on a transmission result. Information on a transmission result may include at least one of packet identification information of a light emission control packet, transmission history information, reception state information collected from light-emitting devices 100, device state information of light-emitting devices 100, and valid time information of a light emission control packet. For example, the control device 300 may determine a reception failure ratio of a specific light-emitting device group based on processing result information received from light-emitting devices 100. The repeater 200 may also determine reception failure of an individual light-emitting device when a response is not received from the individual light-emitting device.

The control device 300 may determine subsequent transmission conditions based on at least one of information on a transmission result, execution time information, priority information, and a current performance progress time. For example, when priority of a light emission control packet targeting all light-emitting devices is high, the control device 300 may determine a repeated transmission condition for the same light emission control packet. When reception failure is confirmed in a specific light-emitting device group, the control device 300 may determine a re-transmission condition for a previously transmitted light emission control packet. When a current performance progress time has already changed, the control device 300 may determine a transmission condition for a calibration packet indicating a light emission state corresponding to the current performance progress time, instead of repeating the entire missing previous light emission operation.

In section P3 of FIG. 12, the repeater 200 may perform at least one of repeated transmission, re-transmission, and calibration transmission based on subsequent transmission conditions. For example, the repeater 200 may repeatedly transmit a light emission control packet having the same packet identification information or related packet identification information. The repeater 200 may re-transmit a previously transmitted light emission control packet targeting a specific light-emitting device group. The repeater 200 may also transmit a calibration packet indicating a light emission state corresponding to a current performance progress time targeting a specific light-emitting device or a specific light-emitting device group.

For example, when reception confirmation information for a light emission control packet targeting all light-emitting devices is not sufficiently collected, the control device 300 may determine a repeated transmission condition for the same light emission control packet. When a reception failure ratio of a specific light-emitting device group is a reference value or more, the control device 300 may determine a re-transmission condition targeting the specific light-emitting device group.

A calibration packet may include light emission control information indicating a light emission state corresponding to a current performance progress time. A calibration packet may include at least one of information on a reception target range, execution time information, light emission control information, packet identification information, version information, and valid time information. For example, a calibration packet may indicate to perform a light emission operation after a current point in time, without indicating to re-perform the entire missing previous light emission operation. A calibration packet may indicate at least one of color, brightness, blinking, fading, and a pattern corresponding to a current performance progress time.

For example, when a confirmed point of reception failure has passed an original application timing of light emission control information, the control device 300 may generate a calibration packet indicating a light emission state corresponding to a current performance progress time instead of re-executing a previous light emission operation from the beginning. A calibration packet may indicate at least one of a light emission state after a current point in time, a remaining light emission maintenance time, or a light emission state of a next performance section.

In section P4 of FIG. 12, the light-emitting device 100 may perform a light emission operation based on a re-transmitted light emission control packet or a calibration packet. The light-emitting device 100 may determine whether to process a re-transmitted light emission control packet or a calibration packet based on at least one of packet identification information, version information, error detection information, valid time information, information on a reception target range, and execution time information. For example, the light-emitting device 100 may not process a re-transmission packet that overlaps with an already processed light emission control packet. When a calibration packet is determined as a processing target packet, the light-emitting device 100 may determine an application timing of light emission control information based on execution time information. The light-emitting device 100 may control a light source device 120 to a light emission state suitable for a current performance progress time based on light emission control information included in the calibration packet.

Repeated transmission, re-transmission, and calibration transmission may be performed in combination with transmission methods. For example, the control device 300 or the repeater 200 may repeatedly transmit the same light emission control packet in a method receivable by all light-emitting devices to increase reception stability for all light-emitting devices. When missing reception is confirmed in a specific light-emitting device group, the control device 300 or the repeater 200 may transmit a re-transmission packet in a method receivable by the light-emitting device group. When reception failure or light emission state inconsistency of an individual light-emitting device is confirmed, the control device 300 or the repeater 200 may transmit a calibration packet in a method receivable by the individual light-emitting device.

The repeater 200 may transmit a light emission control packet or a calibration packet according to subsequent transmission conditions. For example, the repeater 200 may increase delivery possibility of a light emission control packet or a calibration packet using at least one of a Wi-Fi HaLow communication method, RF channel division, continuous transmission of the same information, and beam pattern-based transmission.

In the embodiment of FIG. 12, some operations may be omitted or the order may be changed. For example, the control device 300 or the repeater 200 may perform repeated transmission based on priority information or transmission history information of a light emission control packet without receiving response information from a light-emitting device 100. The control device 300 or the repeater 200 may transmit a re-transmission packet targeting an entire specific light-emitting device group without specifying individual light-emitting devices for which reception failure has been confirmed. The control device 300 may generate a calibration packet after confirming a current light emission state of the light-emitting device 100.

A light-emitting device control system of FIG. 12 may determine subsequent transmission conditions based on information on a transmission result of a light emission control packet, and reduce possibility of missing light emission control packets in a large-scale performance space through at least one of repeated transmission, re-transmission, and calibration transmission. The light-emitting device control system may calibrate a light emission state of a light-emitting device 100 based on a light emission state corresponding to a current performance progress time even when packet loss occurs. Through this, a plurality of light-emitting devices 100 may stably perform light emission operations corresponding to performance production information.

A light-emitting control system, a light-emitting device 100, a repeater 200, a control device 300, and a user terminal 400 described in the present disclosure may be implemented as hardware components, software components, and/or a combination of hardware components and software components. Furthermore, the present disclosure may be provided in the form of a computer program stored in a computer-readable storage medium so as to perform operation methods of the light-emitting control system, the light-emitting device 100, the repeater 200, the control device 300, and the user terminal 400. In addition, the present disclosure can be written as a program that can be executed on a computer, and can be implemented in a general-purpose digital computer that operates such a program using a computer-readable storage medium.

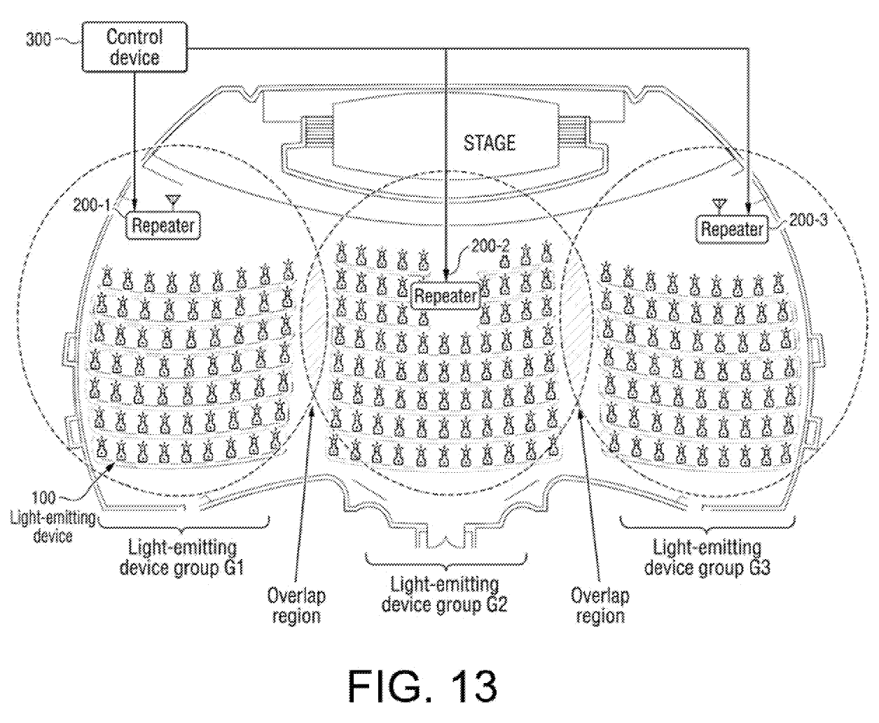

FIG. 13 is a diagram illustrating an arrangement of a plurality of repeaters and a plurality of light-emitting device groups within a performance space according to an embodiment. Referring to FIG. 13, a control device 300, a plurality of repeaters 200-1, 200-2, 200-3, a plurality of light-emitting devices 100, and a plurality of light-emitting device groups G1, G2, G3 may be arranged in a performance space. Light-emitting device groups G1, G2, G3 may be sets of a plurality of light-emitting devices 100 arranged in different target areas based on the performance space.

The plurality of repeaters 200-1, 200-2, 200-3 may have different transmittable ranges. A first repeater 200-1 may have a transmittable range corresponding to light-emitting device group G1, a second repeater 200-2 may have a transmittable range corresponding to light-emitting device group G2, and a third repeater 200-3 may have a transmittable range corresponding to light-emitting device group G3. The transmittable range may be determined based on at least one of an installation position of a repeater, an antenna direction, a transmission output, a channel state, a concert hall structure, and an obstacle position.

Control device 300 may determine a repeater corresponding to a target light-emitting device group by comparing the location of each light-emitting device group with the transmittable range of each of the plurality of repeaters. The location of a light-emitting device group may be determined based on at least one of reference coordinates of the light-emitting device group, center coordinates, a spectator seat area, a peripheral area, and light-emitting device distribution information.

For example, control device 300 may select, as candidate repeaters, repeaters capable of covering the entirety or at least a reference ratio of the target light-emitting device group. Control device 300 may determine, as a primary repeater, a repeater having the lowest congestion among candidate repeaters, a repeater having the least reception failure history, or a repeater having communication quality of at least a reference value. When two or more candidate repeaters satisfy the primary repeater condition, control device 300 may select a primary repeater based on at least one of a distance from the target light-emitting device group, an overlap degree of transmittable ranges, remaining transmission resources, and a reception success rate of a previous cycle. Control device 300 may determine, as a secondary repeater, a repeater that covers a part of an area excluded from the transmittable range of the primary repeater, a repeater having lower congestion than the primary repeater, or a repeater having a high reception success rate in a specific spatial area. Control device 300 may allocate backup transmission resources to the secondary repeater when the reception failure rate is at least a reference value or when reception failure devices are concentrated in a specific spatial area.

For example, control device 300 may determine first repeater 200-1 as a primary repeater corresponding to light-emitting device group G1 when the center coordinates of light-emitting device group G1 are within the transmittable range of first repeater 200-1 and at least a reference ratio of a peripheral area of light-emitting device group G1 is included in the transmittable range of first repeater 200-1.

Overlapping areas in FIG. 13 may be areas where the transmittable ranges of two or more repeaters overlap. A light-emitting device or a light-emitting device group located in an overlapping area may be a candidate target capable of receiving a light emission control packet from two or more repeaters. When a target light-emitting device group is included in transmittable ranges of two or more repeaters, control device 300 may determine a primary repeater and a secondary repeater based on at least one of congestion or reception failure history of each of the two or more repeaters.

For example, light-emitting device group G2 may be included in both the transmittable range of first repeater 200-1 and the transmittable range of second repeater 200-2. Control device 300 may determine second repeater 200-2 as a primary repeater when the congestion of first repeater 200-1 is at least a reference value and the congestion of second repeater 200-2 is less than a reference value. Control device 300 may determine first repeater 200-1 as a secondary repeater and allocate backup transmission resources for light-emitting device group G2 to first repeater 200-1.

Control device 300 may generate a transmission schedule for each repeater based on at least one of the location of each light-emitting device group, the transmittable range of each repeater, an overlapping area, congestion, and reception failure history. A transmission schedule may be generated such that a transmission resource corresponding to a light emission control packet is arranged within a reception control interval of a target light-emitting device group. A transmission schedule may include at least one of a target light-emitting device group, a primary repeater, a secondary repeater, a transmission resource, a reception control interval, a transmission timing, a transmission repetition count, a transmission priority, and a backup transmission resource.

For example, control device 300 may allocate a light emission control packet for light-emitting device group G1 to first repeater 200-1, allocate a light emission control packet for light-emitting device group G2 to second repeater 200-2, and allocate a light emission control packet for light-emitting device group G3 to third repeater 200-3. When light-emitting device group G1 and light-emitting device group G2 are close to an overlapping area, control device 300 may temporally isolate transmission resources such that transmission timings of first repeater 200-1 and second repeater 200-2 do not overlap. As another example, when first repeater 200-1 and second repeater 200-2 are capable of using different channels, control device 300 may arrange transmission resources in different frequency bands or subchannels.

Light-emitting device groups in FIG. 13 may not be limited to groups fixed by seat information. A light-emitting device group may be set based on at least one of a target area based on a performance space, a light emission effect, a performance section, a reception state, a device state, and communication quality. The structure of FIG. 13 is not limited to simply arranging a plurality of repeaters by area, but may represent a structure using correspondence relationships between light-emitting device groups and repeaters as a criterion for generating a transmission schedule. Control device 300 may improve a delivery possibility of a light emission control packet even when congestion or reception failure of a specific repeater occurs by setting backup transmission resources using an overlapping area.

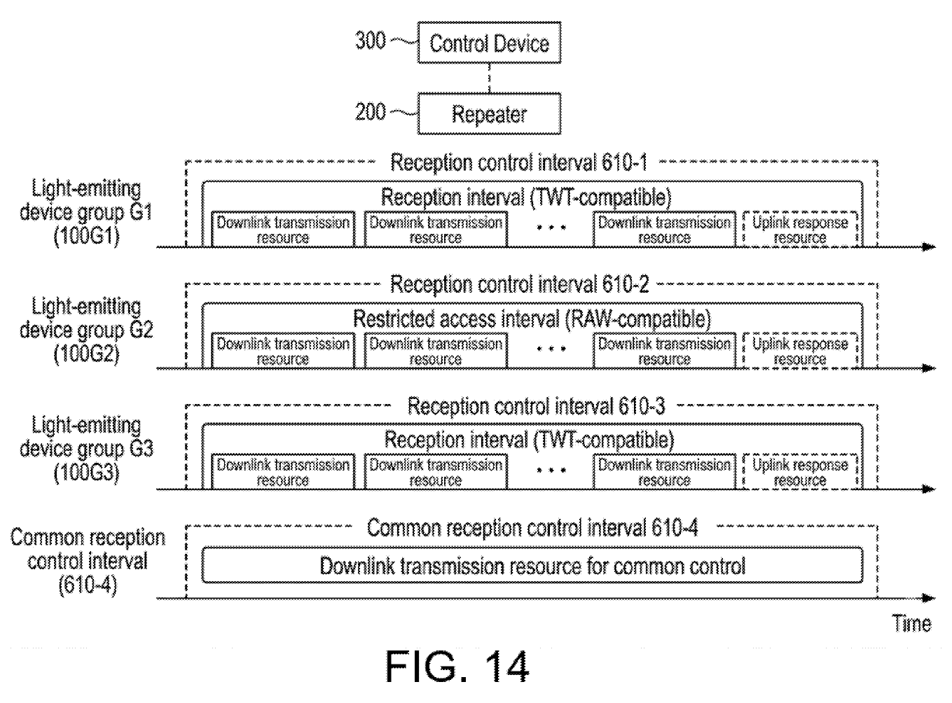

FIG. 14 is a diagram illustrating reception control intervals for each of a plurality of light-emitting device groups according to an embodiment. Referring to FIG. 14, reception control intervals 610-1, 610-2, 610-3 respectively corresponding to light-emitting device group G1 100G1, light-emitting device group G2 100G2, and light-emitting device group G3 100G3 may be set along a time axis. A common reception control interval 610-4 may be set as a reception control interval receivable by a plurality of light-emitting device groups in common.

The reception control intervals 610-1, 610-2, 610-3, 610-4 may be time intervals for controlling communication operations for each light-emitting device group. A reception control interval may be set as an interval in which a light-emitting device activates a communication device to receive a light emission control packet, or may be set as an interval in which communication access of a light-emitting device belonging to a light-emitting device group is allowed. Control device 300 may determine a reception control interval corresponding to a target light-emitting device group and generate a transmission schedule such that a transmission resource corresponding to a light emission control packet is arranged within the reception control interval.

For example, when determining a reception control interval corresponding to a target light-emitting device group, control device 300 may consider at least one of a time remaining until an execution timing of a light emission control packet, a priority of the light emission control packet, the number of light-emitting devices belonging to the target light-emitting device group, a reception failure history of the target light-emitting device group, and a transmittable time of a repeater corresponding to the target light-emitting device group. Control device 300 may arrange a transmission resource in a reception control interval close to a current performance progress time or in the common reception control interval 610-4 when the time remaining until the execution timing is short or the priority of the light emission control packet is high. Control device 300 may increase at least one of a length of a reception control interval, the number of downlink transmission resources, or a repetition count when the number of light-emitting devices belonging to the target light-emitting device group is large or a reception failure history is extensive. Control device 300 may determine a primary repeater by comparing a location of a target light-emitting device group with a transmittable range of each of a plurality of repeaters, and determine a secondary repeater or a backup transmission resource based on congestion or a reception failure history when the target light-emitting device group is included in transmittable ranges of two or more repeaters.

The reception control interval 610-1 corresponding to light-emitting device group G1 100G1 may be set as a reception interval. The reception interval may be an interval in which a light-emitting device belonging to light-emitting device group G1 activates a communication device to receive a light emission control packet. For example, the reception control interval 610-1 may be implemented as a wake-up interval corresponding to the Target Wake Time TWT of IEEE 802.11ah. A light-emitting device belonging to light-emitting device group G1 may activate a communication device in the reception control interval 610-1 and reduce power consumption of the communication device at times other than the reception control interval 610-1.

The reception control interval 610-2 corresponding to light-emitting device group G2 100G2 may be set as a restricted access interval. The restricted access interval may be an interval in which communication access of a light-emitting device belonging to light-emitting device group G2 is allowed. For example, the reception control interval 610-2 may be implemented as an interval corresponding to the Restricted Access Window RAW of IEEE 802.11ah. Control device 300 may set a restricted access interval such that only communication access of light-emitting device group G2 is allowed when light-emitting device group G2 shares the same communication resource with another light-emitting device group.

The reception control interval 610-3 corresponding to light-emitting device group G3 100G3 may be set as a reception interval. Control device 300 may determine the reception control interval 610-3 based on at least one of a required timing for light-emitting device group G3 to receive a light emission control packet, a time remaining until an execution timing, a reception failure history of light-emitting device group G3, and a transmittable time of a repeater corresponding to light-emitting device group G3. For example, when sufficient time remains until the execution timing of the light emission control packet, control device 300 may set the reception control interval 610-3 of light-emitting device group G3 to be temporally separated from reception control intervals of other light-emitting device groups.

Each reception control interval 610-1, 610-2, 610-3 may include one or more downlink transmission resources. A downlink transmission resource may be a resource for repeater 200 to transmit a light emission control packet to a target light-emitting device group. Each reception control interval may further include an uplink response resource. An uplink response resource may be a resource for a light-emitting device to transmit reception state information or processing result information to repeater 200 or control device 300. Control device 300 may generate a transmission schedule such that a downlink transmission resource and an uplink response resource are arranged together within a reception control interval.

For example, a downlink transmission resource may be arranged at a timing earlier than an uplink response resource. After receiving a light emission control packet through a downlink transmission resource, a light-emitting device may transmit reception state information including at least one of whether a packet is received, whether an error occurs, whether light emission control information is applied, or reception quality in an uplink response resource. Control device 300 may adjust a reception control interval length, the number of downlink transmission resources, a repetition count, or a backup transmission resource of a next cycle based on the reception state information collected from uplink response resources.

For example, control device 300 may arrange a plurality of downlink transmission resources in a first half of the reception control interval 610-1 and arrange an uplink response resource in a second half of the reception control interval 610-1. A light-emitting device belonging to light-emitting device group G1 may receive a light emission control packet in a downlink transmission resource and transmit reception state information in an uplink response resource. The reception state information may include at least one of whether a packet is received, whether an error occurs, reception strength, signal quality, whether it is a processing target packet, and whether light emission control information is applied.

The common reception control interval 610-4 may be a reception control interval receivable by a plurality of light-emitting device groups G1, G2, and G3 in common. The common reception control interval 610-4 may be understood as one of sub-concepts of a reception control interval. The common reception control interval 610-4 is not a separate concept parallel to the reception control intervals 610-1, 610-2, 610-3, but may be a reception control interval set to correspond to a plurality of light-emitting device groups in common. Control device 300 may arrange a transmission resource corresponding to a light emission control packet in the common reception control interval 610-4 when a time remaining until an execution timing of the light emission control packet is equal to or less than a reference time or a priority of the light emission control packet is equal to or higher than a reference priority.

For example, when spontaneous production, global synchronization, emergency light-off, or global color change is required during a performance, control device 300 may use the common reception control interval 610-4 without waiting for a reception control interval for each light-emitting device group. Control device 300 may arrange a downlink transmission resource for common control in the common reception control interval 610-4. Repeater 200 may transmit a light emission control packet applied in common to a plurality of light-emitting device groups through the downlink transmission resource for common control.

Control device 300 may adjust a length of a reception control interval and the number of transmission resources according to a nature of a light emission control packet. For example, when a light emission control packet includes common light emission control information applied in common to a target light-emitting device group, control device 300 may arrange one common transmission resource within a reception control interval. When a light emission control packet includes a plurality of pieces of differential light emission control information, control device 300 may increase a length of a reception control interval or the number of transmission resources based on at least one of a data amount of the differential light emission control information, the number of subgroups to which the differential light emission control information is to be applied, and a size of internal application criteria information.

According to the structure of FIG. 14, reception timings of packets for a plurality of light-emitting device groups may be distinguished using reception control intervals for each light-emitting device group. Control device 300 may set at least one of a reception interval, a restricted access interval, and a common reception control interval according to a situation. Repeater 200 may transmit a light emission control packet in a downlink transmission resource within a reception control interval according to a transmission schedule, and a light-emitting device may transmit reception state information or processing result information in an uplink response resource.

For example, control device 300 may set a reception control interval as a reception interval when it is necessary to reduce power consumption of a target light-emitting device group. When set as a reception interval, a light-emitting device may activate a communication device at a start timing of the reception interval and switch the communication device to a low-power state after the end of the reception interval. Control device 300 may set a reception control interval as a restricted access interval when it is necessary to reduce communication collisions between a plurality of light-emitting device groups or allow response transmission of a specific light-emitting device group. When set as a restricted access interval, a light-emitting device belonging to a target light-emitting device group may receive a light emission control packet or transmit reception state information, and communication access of other light-emitting device groups may be restricted.

Such a structure can reduce communication congestion in a large-scale light-emitting device environment, reduce unnecessary reception standby time of light-emitting devices, and enable subsequent transmission control based on a reception failure rate.

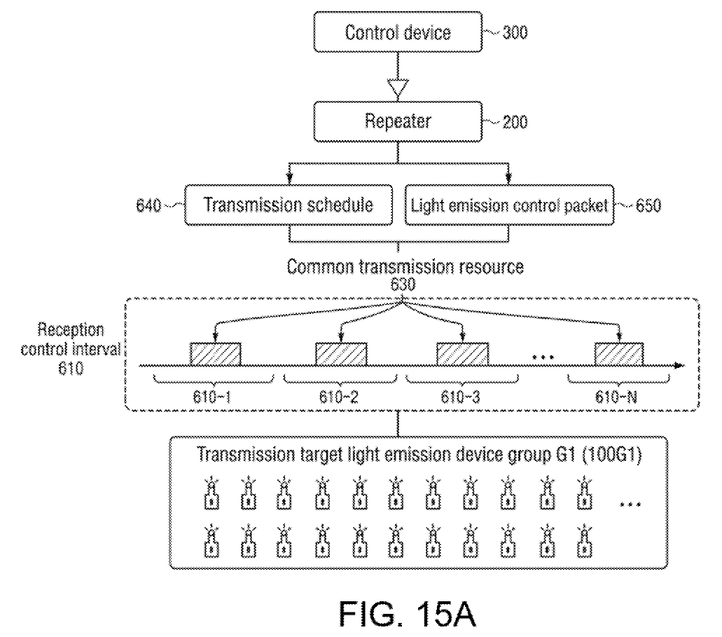

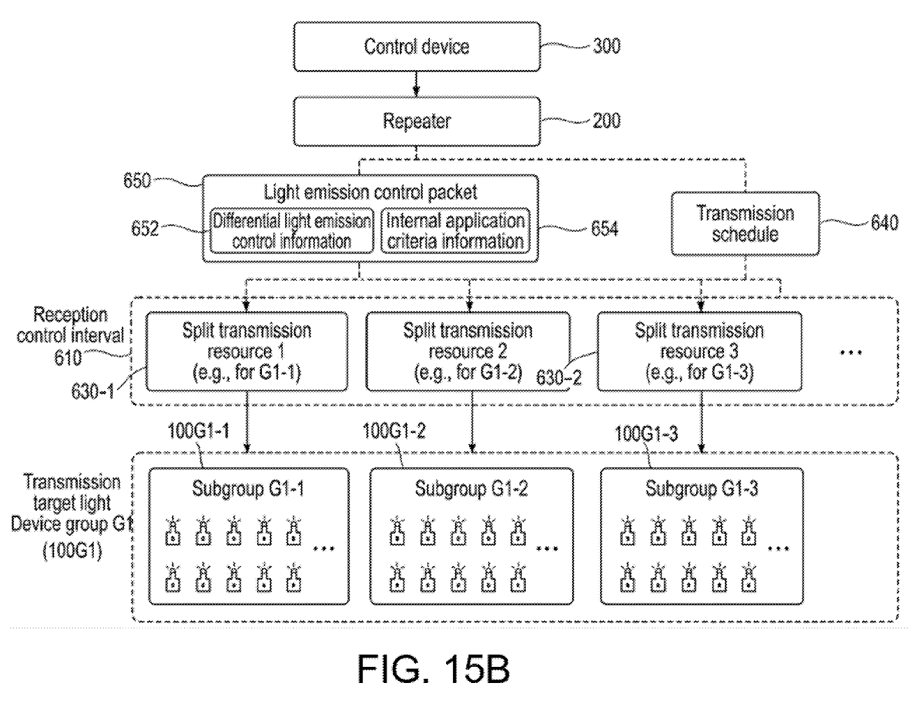

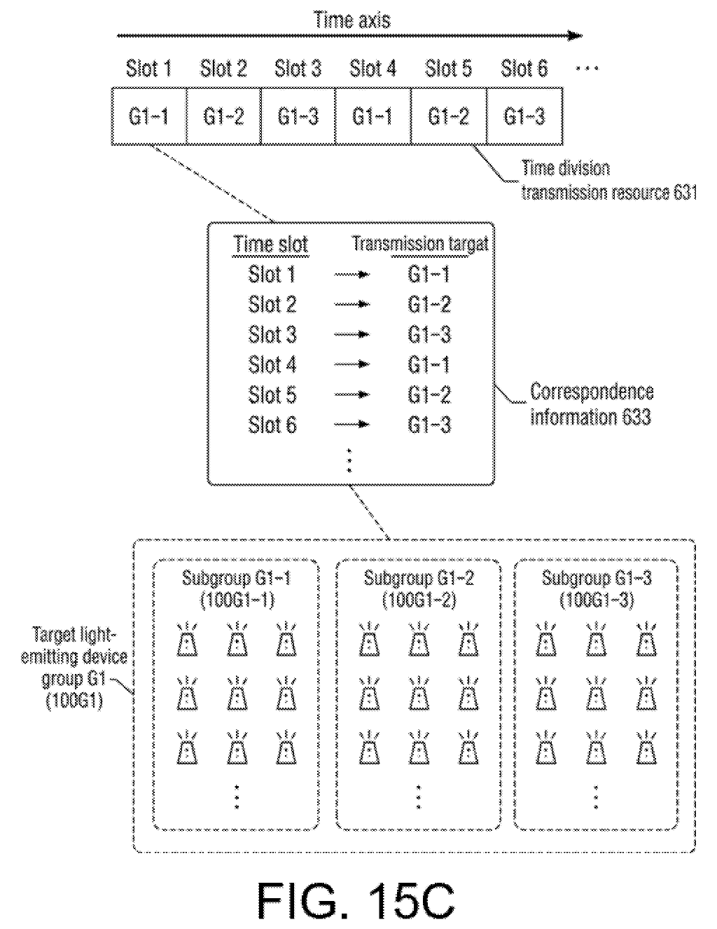

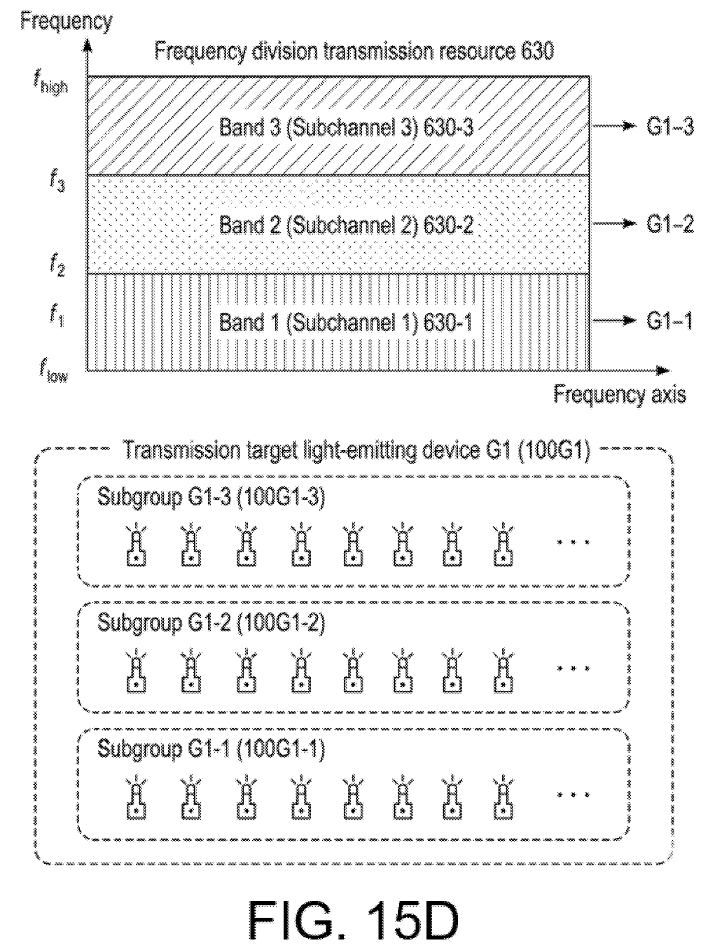

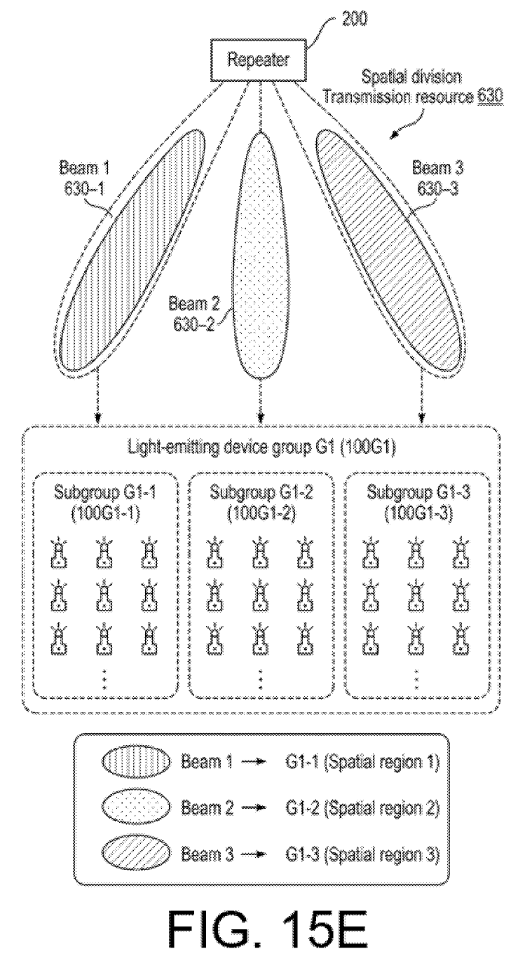

FIG. 15A is a diagram illustrating a transmission structure of a light emission control packet 650 using a common transmission resource 630 according to an embodiment. Referring to FIG. 15A, control device 300 may transmit light emission control packet 650 to target light-emitting device group G1 100G1 through repeater 200. At this time, control device 300 may generate a transmission schedule 640 separately from light emission control packet 650. Transmission schedule 640 may be information indicating in which reception control interval 610 or in which common transmission resource 630 the light emission control packet 650 is arranged. FIG. 15A may describe a structure in which light emission control packet 650 applied in common to an entire light-emitting device group is arranged in and transmitted through a plurality of common transmission resources 630.

Reception control interval 610 may be a time interval in which a light-emitting device belonging to light-emitting device group G1 100G1 activates a communication device to receive a packet. Common transmission resource 630 may be one or more transmission resources arranged within reception control interval 610. In FIG. 15A, an example in which common transmission resources 630 are arranged at a plurality of positions within reception control interval 610, for example, 610-1, 610-2, 610-3, and 610-N, may be shown. Control device 300 may arrange light emission control packet 650 in common transmission resource 630 rather than a differential transmission resource when light emission control packet 650 is applied in common to all light-emitting devices of target light-emitting device group G1 100G1. For example, control information applied uniformly to an entire light-emitting device group, such as global light-on, global light-off, global color change, global brightness adjustment, or a synchronized blinking effect, may be transmitted using common transmission resource 630.

Control device 300 may use a plurality of criteria when generating transmission schedule 640. For example, control device 300 may determine the number, arrangement position, repetition count, or interval of common transmission resources 630 based on at least one of a priority of light emission control packet 650, a data amount of light emission control packet 650, a time remaining until an execution timing, a reception failure history of target light-emitting device group G1 100G1, and a channel usage state of repeater 200. For example, when the time remaining until the execution timing is short, control device 300 may intensively arrange common transmission resources 630 in the first half of reception control interval 610. For example, for a light-emitting device group that had a high reception failure rate, the same light emission control packet 650 may be repeatedly arranged in a plurality of common transmission resources 630. Such a structure may increase a possibility of re-reception through a subsequent common transmission resource 630 even if some of the light-emitting devices belonging to target light-emitting device group G1 100G1 fail to receive an initial transmission.

Each light-emitting device belonging to light-emitting device group G1 100G1 may activate a communication device according to stored reception control interval 610 information or pre-received schedule information. A light-emitting device may receive light emission control packet 650 in common transmission resource 630 within reception control interval 610. For example, after checking identification information, execution time information, or error detection information of the received light emission control packet 650, a light-emitting device may apply light emission control information included in the packet when it is determined to be a valid packet. For example, when a plurality of common transmission resources 630 exist within one reception control interval 610, a light-emitting device may operate based on a packet normally received for the first time, and subsequent identical packets may be ignored or utilized for verifying a reception state. As such, common transmission resource 630 can perform common control for an entire light-emitting device group with a simple structure while increasing reception reliability through repeated transmission.

The structure of FIG. 15A may be particularly effective in a situation where differential control is not required. By using common transmission resource 630, one light emission control packet 650 can be delivered to the entirety of light-emitting device group G1 100G1 without being split into a plurality of subgroups, and thus the structure of transmission schedule 640 can be simplified. For example, when there is no differential light emission control information or internal application criteria information is not required, control device 300 may preferentially generate transmission schedule 640 centered on common transmission resource 630. For example, a global light-on preparation operation immediately before the start of a performance, a global light-off operation immediately after the end of a performance, or group-unit synchronization control for a specific scene transition may be implemented with a structure as shown in FIG. 15A. Such a structure can simplify packet design, reduce a transmission burden of repeater 200, and enable rapid control in units of light-emitting device groups.

FIG. 15B is a diagram illustrating a linkage structure between a light emission control packet 650 and a transmission schedule 640 for differential light emission control according to an embodiment. Referring to FIG. 15B, control device 300 may perform control on target light-emitting device group G1 100G1 through repeater 200. Light-emitting device group G1 100G1 may include at least one of a plurality of subgroups G1-1 100G1-1, G1-2 100G1-2, and G1-3 100G1-3. Instead of giving the same control to an entire light-emitting device group, control device 300 may include differential light emission control information 652 in light emission control packet 650 in order to apply different controls for each subgroup. In addition, control device 300 may generate transmission schedule 640 separately from light emission control packet 650, and assign split transmission resources 1, 2, and 3 within reception control interval 610 for each subgroup based on transmission schedule 640.

Light emission control packet 650 may include differential light emission control information 652 and internal application criteria information 654. Differential light emission control information 652 may include at least one of different light emission colors, brightness, blinking patterns, operation timings, durations, and scene identification information for each subgroup. Internal application criteria information 654 may be reference information for a receiving light-emitting device to determine a control to be applied to itself. For example, internal application criteria information 654 may include at least one of subgroup identification information, device identification information, device location information, seat block information, repeater connection information, or pre-stored group correspondence information. Transmission schedule 640 may indicate at which positions within reception control interval 610 the split transmission resource 1, split transmission resource 2, and split transmission resource 3 are arranged. Control device 300 may systematically set which differential control is delivered to which subgroup by combining the content of light emission control packet 650 and the content of transmission schedule 640.

Reception control interval 610 may be a time interval in which a light-emitting device belonging to light-emitting device group G1 100G1 activates a communication device to receive a packet. In FIG. 15B, split transmission resource 1, split transmission resource 2, and split transmission resource 3 are arranged within reception control interval 610, and an example in which each split transmission resource respectively corresponds to subgroups G1-1 100G1-1, G1-2 100G1-2, and G1-3 100G1-3 may be shown. Control device 300 may determine the number, length, repetition count, or arrangement order of split transmission resources based on at least one of a data amount of differential light emission control information 652, the number of subgroups to which differential light emission control information 652 is to be applied, a size of internal application criteria information 654, a time remaining until an execution timing, or past reception success rates. For example, when the number of subgroups increases, control device 300 may increase the number of split transmission resources. For example, when the size of internal application criteria information 654 increases, control device 300 may increase the length of a specific split transmission resource or repeatedly arrange the same control in a plurality of resources.

For example, when a plurality of pieces of differential light emission control information respectively correspond to different subgroups, control device 300 may preferentially determine the number of split transmission resources to correspond to the number of subgroups. When a data amount of each piece of differential light emission control information exceeds a reference data amount transmittable in one split transmission resource, control device 300 may increase the length of the split transmission resource corresponding to the differential light emission control information, or arrange the same differential light emission control information by dividing it into two or more split transmission resources. When the data amount increases because internal application criteria information includes a plurality of row/column indices, location indices, or mask information, control device 300 may increase the overall length of the reception control interval or additionally arrange a transmission resource dedicated to internal application criteria information.

Each light-emitting device may determine which subgroup it belongs to based on stored group information or received internal application criteria information 654. A light-emitting device may preferentially receive a split transmission resource that is likely to correspond to itself within reception control interval 610. After receiving the packet, the light-emitting device may select or calculate a part applied to itself among differential light emission control information 652. For example, a light-emitting device belonging to subgroup G1-2 100G1-2 compares the subgroup identification information included in internal application criteria information 654 with its own stored information, and may apply differential light emission control information 652 received through split transmission resource 2 to its own light emission operation. For example, when information for a plurality of subgroups is included together in one light emission control packet 650, a light-emitting device may extract only control information corresponding to itself while excluding control information irrelevant to itself. Such a structure may enable applying different light emission effects by zone, seat block, or production pattern even within the same light-emitting device group.

The structure of FIG. 15B can support detailed performance production that is difficult to implement with common control alone. By using split transmission resources 630-1, 630-2, and 630-3, the inside of one light-emitting device group G1 100G1 can be divided into a plurality of subgroups to efficiently deliver different light emission controls, and by using internal application criteria information 654, a light-emitting device can accurately select the control to be applied to itself without a separate complex external instruction. For example, it may be possible to produce an effect of giving wave effects of different colors to the left, center, and right spectator seats of a stage, an effect of lighting at different brightness levels at the same timing, or an effect of sequential lighting with a time difference. In addition, if transmission schedule 640 and light emission control packet 650 are operated separately, adaptability to changes in the communication environment can be improved because only the arrangement of split transmission resources can be adjusted while maintaining the packet content. As a result, the structure of FIG. 15B can increase the flexibility of differential control, the scalability of transmission design, and the possibility of concurrent group-unit control and subgroup-unit control.

FIG. 15C is a diagram illustrating a transmission structure of differential light emission control information using a time division transmission resource 631 according to an embodiment. Specifically, FIG. 15C is a diagram illustrating a structure for sequentially controlling a plurality of subgroups G1-1 100G1-1, G1-2 100G1-2, and G1-3 100G1-3 within one target light-emitting device group G1 100G1 using time division transmission resource 631 and correspondence information 633 according to an embodiment. Referring to FIG. 15C, slots 1 to 6 may be arranged along a time axis, and different subgroups or repeated subgroups may be designated as transmission targets in each slot. Control device 300 may set a transmission resource corresponding to a light emission control packet as a time division transmission resource 631, and include correspondence information 633 defining a transmission target for each slot in a transmission schedule. Correspondence information 633 may be information representing a relationship between a time slot and a transmission target, and may be used as a criterion for repeater 200 to determine in which time slot and to which subgroup to transmit a light emission control packet. For example, slot 1 corresponds to subgroup G1-1 100G1-1, slot 2 corresponds to subgroup G1-2 100G1-2, and slot 3 corresponds to subgroup G1-3 100G1-3. For example, slots 4 to 6 may again correspond to subgroups G1-1 100G1-1, G1-2 100G1-2, and G1-3 100G1-3 in the same order, and a repeated arrangement may be used for improving reception stability or for distributed transmission of differential light emission control information.

Control device 300 may determine a number of slots, a slot length, a slot order, or a repetition cycle of time division transmission resource 631 based on at least one of a number of subgroups, a data amount of differential light emission control information, a size of internal application criteria information, a time remaining until an execution timing, a reception failure history, or repeater congestion. For example, when a data amount of light emission control information to be applied to a specific subgroup is large, control device 300 may increase a slot length corresponding to the specific subgroup or allocate a plurality of slots. For example, when a reception failure history of subgroup G1-2 100G1-2 is at least a reference value, control device 300 may additionally arrange a slot corresponding to subgroup G1-2 100G1-2 or set a shorter repetition cycle. A light-emitting device may activate a communication device in a time slot corresponding to a subgroup to which it belongs, and select or calculate light emission control information to be applied to itself based on internal application criteria information or subgroup identification information included in a received light emission control packet. When time division transmission resource 631 and correspondence information 633 are used together, differential control for each subgroup can be performed while maintaining one light-emitting device group G1 100G1 as a communication management unit, unnecessary reception standby time can be reduced, and transmission resource collisions in a large-scale performance space can be reduced.

FIG. 15D is a diagram illustrating a transmission structure of differential light emission control information using a frequency division transmission resource 630 according to an embodiment. Specifically, FIG. 15D may be a diagram illustrating a structure for allocating different frequency bands to a plurality of subgroups G1-1 100G1-1, G1-2 100G1-2, and G1-3 100G1-3 within one target light-emitting device group G1 100G1 using frequency division transmission resource 630 according to an embodiment. Referring to FIG. 15D, a frequency axis may have a range from a lower limit frequency f_low to an upper limit frequency f_high, and frequency division transmission resource 630 may be divided into Band 1 (subchannel 1, 630-1), Band 2 (subchannel 2, 630-2), and Band 3 (subchannel 3, 630-3). Control device 300 may associate different frequency bands with different subgroups based on a control necessity for each subgroup included in target light-emitting device group G1 100G1. Band 1 630-1 corresponds to subgroup G1-1 100G1-1, Band 2 630-2 corresponds to subgroup G1-2 100G1-2, and Band 3 630-3 corresponds to subgroup G1-3 100G1-3. For example, control device 300 may determine a width for each band, a transmission order for each band, and a repetition count for each band based on at least one of a data amount of light emission control information to be applied to each subgroup, a time remaining until an execution timing, a reception failure history for each subgroup, communication quality for each subgroup, and the number of supported channels of the repeater.

Control device 300 may generate a transmission schedule to transmit differential light emission control information for each subgroup in parallel using frequency division transmission resource 630 while maintaining target light-emitting device group G1 100G1 as one communication management unit. Repeater 200 may transmit a light emission control packet corresponding to subgroup G1-1 100G1-1 through Band 1 630-1, transmit a light emission control packet corresponding to subgroup G1-2 100G1-2 through Band 2 630-2, and transmit a light emission control packet corresponding to subgroup G1-3 100G1-3 through Band 3 630-3 based on a correspondence relationship for each band included in the transmission schedule. For example, when subgroups G1-1 100G1-1, G1-2 100G1-2, and G1-3 100G1-3 need to output at least one of different colors, brightness, blinking periods, and pattern effects, each subgroup may receive a light emission control packet in a frequency band allocated to itself, and select or calculate light emission control information to be applied to itself based on internal application criteria information or subgroup identification information included in the received light emission control packet. By using frequency division transmission resource 630, light emission control packets for a plurality of subgroups can be distributedly transmitted within the same time interval, transmission delay can be reduced, and real-time performance of differential control for a large-scale light-emitting device group can be improved.

FIG. 15E is a diagram illustrating a transmission structure of differential light emission control information using a spatial division transmission resource 630 according to an embodiment. Specifically, FIG. 15E is a diagram illustrating a structure in which repeater 200 transmits beams divided into different spatial areas to a plurality of subgroups G1-1 100G1-1, G1-2 100G1-2, and G1-3 100G1-3 within one light-emitting device group G1 100G1 using spatial division transmission resource 630 according to an embodiment. Referring to FIG. 15E, repeater 200 may form beam 1 630-1, beam 2 630-2, and beam 3 630-3, and each beam may be set to correspond to a different spatial area 1, spatial area 2, and spatial area 3.

Control device 300 may determine a beam shape, a beam direction, a beam width, transmission power for each beam, and a corresponding subgroup for each beam of spatial division transmission resource 630 based on at least one of location information of each subgroup included in light-emitting device group G1 100G1, an arrangement range for each subgroup, an installation position of repeater 200, antenna characteristics, communication quality information, and light emission production information. Repeater 200 may associate beam 1 630-1 with subgroup G1-1 100G1-1, associate beam 2 630-2 with subgroup G1-2 100G1-2, and associate beam 3 630-3 with subgroup G1-3 100G1-3 based on the determined spatial division transmission resource 630. For example, when it is necessary to differently perform light emission production corresponding to a left side, a center, and a right side of a stage, control device 300 may distinguish subgroups arranged in each spatial area and control repeater 200 to form a beam corresponding to each spatial area.

In the structure illustrated in FIG. 15E, repeater 200 may deliver differential light emission control information to a plurality of subgroups using spatially separated beams even within the same time interval or overlapping transmission intervals. A light-emitting device may receive a light emission control packet through a beam transmitted to a spatial area where it is located, and select or calculate light emission control information to be applied to itself based on at least one of internal application criteria information, subgroup identification information, and spatial area information included in the received light emission control packet. For example, it may be set to apply a first color and a first brightness to subgroup G1-1 100G1-1, apply a second color and a second blinking pattern to subgroup G1-2 100G1-2, and apply a third color and a third operation timing to subgroup G1-3 100G1-3.

By using spatial division transmission resource 630, independent control in units of subgroups can be possible even within the same light-emitting device group G1 100G1, differential transmission for each spatial area can be performed without an increase in frequency resources or time resources, and transmission efficiency and control precision can be improved by reducing unnecessary packet reception between adjacent subgroups.

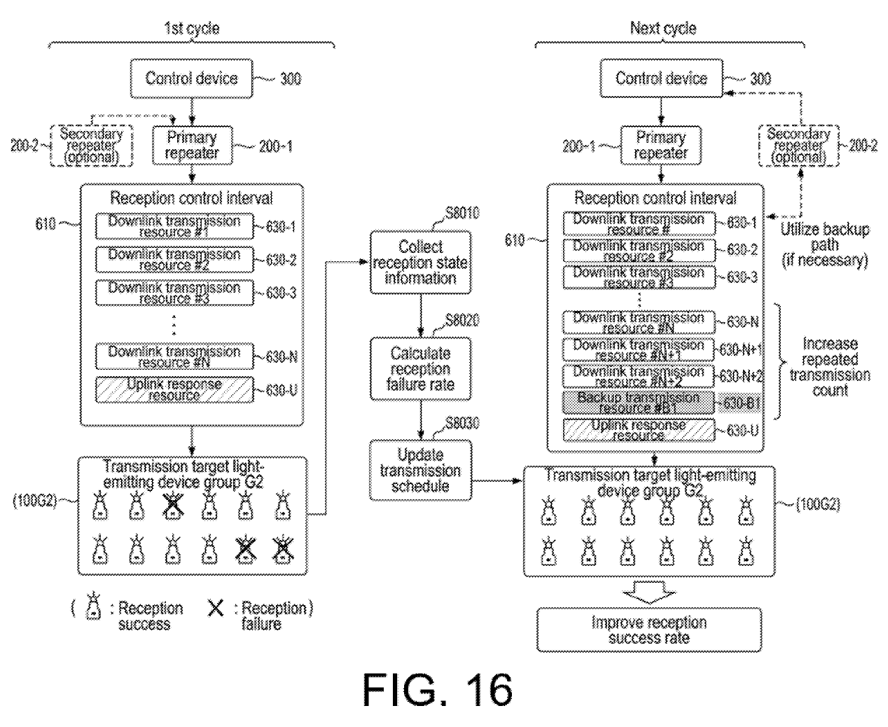

FIG. 16 is a diagram illustrating a transmission schedule update structure based on reception state information according to an embodiment. Referring to FIG. 16, in a first cycle, control device 300 may transmit a light emission control packet using downlink transmission resources 630-1 to 630-N within a reception control interval 610 corresponding to target light-emitting device group G2 100G2 through a primary repeater 200-1. The reception control interval 610 may include a downlink transmission resource and an uplink response resource 630-U, and the uplink response resource 630-U may be a resource for at least some light-emitting devices belonging to light-emitting device group G2 100G2 to transmit reception state information. For example, a light-emitting device may generate, as the reception state information, at least one of whether a light emission control packet is received, whether an error occurs, reception strength, signal quality, whether it is a processing target packet, and whether light emission control information is applied.

In step S810, control device 300 may collect reception state information of light-emitting devices belonging to the target light-emitting device group G2 100G2 through the uplink response resource 630-U. The reception state information may be collected through the primary repeater 200-1, and the primary repeater 200-1 may transmit the collected reception state information to the control device 300. For example, control device 300 may collect at least one of whether reception is successful for each light-emitting device, whether reception fails, whether an error is detected, reception strength, signal quality, and processing result information.

In step S820, control device 300 may calculate a reception failure rate of the target light-emitting device group G2 100G2 based on the collected reception state information. For example, control device 300 may compare a total number of light-emitting devices belonging to target light-emitting device group G2 100G2 with a number of light-emitting devices that have transmitted reception state information indicating a reception success. Control device 300 may calculate a number of reception failure devices by excluding the number of light-emitting devices indicating a reception success from the total number of light-emitting devices, and calculate a reception failure rate by comparing the number of reception failure devices with the total number of light-emitting devices. For example, when 85 light-emitting devices out of 100 light-emitting devices belonging to target light-emitting device group G2 100G2 indicate a reception success, control device 300 may calculate 15 light-emitting devices as reception failure devices and calculate a reception failure rate as 15%.

In step S830, control device 300 may update a transmission schedule of a next cycle based on the calculated reception failure rate. A transmission schedule update may include at least one of increasing a length of the reception control interval 610, adding downlink transmission resources 630-N+1 and 630-N+2, increasing a transmission repetition count, adding a backup transmission resource 630-B1, and utilizing a backup path using a secondary repeater 200-2. For example, control device 300 may increase the number of downlink transmission resources when the reception failure rate is at least a first reference value, and allocate the backup transmission resource 630-B1 to the secondary repeater 200-2 when the reception failure rate is at least a second reference value. For example, when it is determined that reception failure devices are concentrated in a specific spatial area, control device 300 may utilize a backup path through the secondary repeater 200-2 instead of increasing the transmission repetition count of the primary repeater 200-1.

In the next cycle of FIG. 16, the primary repeater 200-1 may repeatedly transmit a light emission control packet using the increased downlink transmission resources 630-N+1 and 630-N+2 according to the updated transmission schedule, and the secondary repeater 200-2 may transmit a light emission control packet using the backup transmission resource 630-B1 if necessary. The structure of FIG. 16 may be characterized in that a closed-loop control is performed, including collecting reception state information in step S810, calculating a reception failure rate in step S820, and updating a transmission schedule in step S830, rather than merely performing a one-way transmission of light emission control packets. For example, control device 300 may transmit the same light emission control packet or a calibration packet using the increased downlink transmission resources and the backup transmission resource in the next cycle, and improve a reception success rate of light-emitting device group G2 100G2. Such a structure can increase control stability in units of light-emitting device groups even when at least one of congestion in a performance space, a shaded area, a repeater load, and a temporary decrease in communication quality occurs.

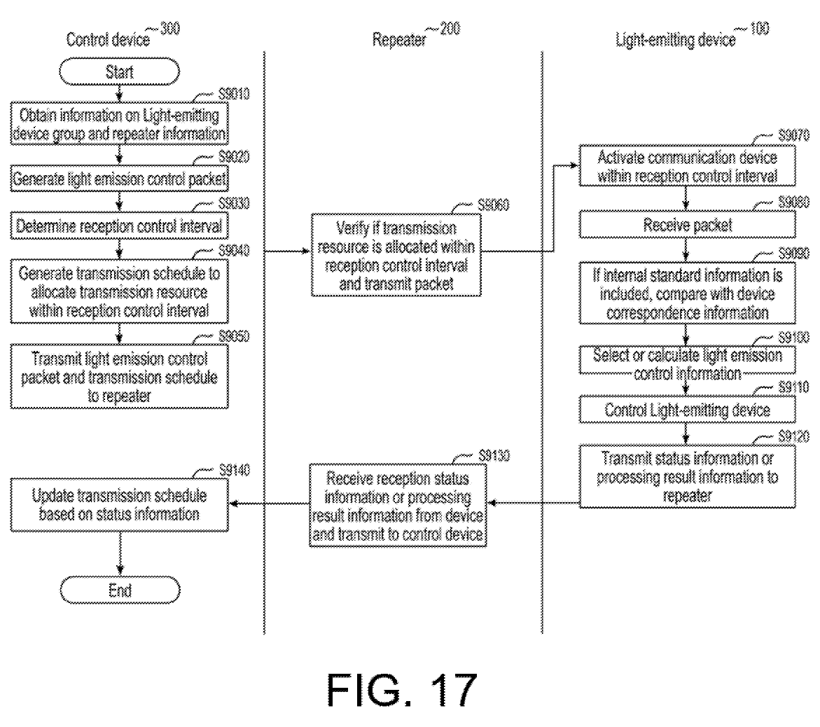

FIG. 17 is a flowchart illustrating a light emission control method based on operations among a control device 300, a repeater 200, and a light-emitting device 100 according to an embodiment. FIG. 17 may represent a closed-loop control procedure in which an arrangement of transmission resources, packet reception, light emission control, a reply of reception state information, and a transmission schedule update are sequentially linked, rather than a simple packet delivery process.

In step S9010, control device 300 may acquire at least one of performance production information, information on a light-emitting device group, and information on a repeater. For example, control device 300 may acquire at least one of scene information of a performance, an execution timing, production priority, a location of a light-emitting device group, a number of devices for each light-emitting device group, an arrangement state of repeaters, and a reception result of a previous cycle. In step S9020, control device 300 may generate a light emission control packet based on the performance production information. In step S9030, control device 300 may determine a reception control interval corresponding to a target light-emitting device group. The determination of the reception control interval may be performed based on at least one of a size of a light-emitting device group, repeater coverage, a performance progress timing, control priority, and an expected traffic volume. In step S9040, control device 300 may generate a transmission schedule such that a transmission resource is arranged within the reception control interval. In step S9050, control device 300 may transmit the light emission control packet and the transmission schedule to the repeater 200. For example, control device 300 may generate a transmission schedule to arrange a first transmission resource in a first time interval for a specific light-emitting device group and to arrange a second transmission resource in a second time interval for another light-emitting device group.

In step S9060, repeater 200 may verify whether the transmission resource is arranged within the reception control interval and transmit the light emission control packet based on a result of the verification. In step S9070, light-emitting device 100 may activate a communication device in the reception control interval. In step S9080, light-emitting device 100 may receive the light emission control packet. In step S9090, light-emitting device 100 may compare internal application criteria information with device correspondence information when the internal application criteria information is included in the light emission control packet. In step S9100, light-emitting device 100 may select or calculate light emission control information based on a result of the comparison. In step S9110, light-emitting device 100 may control the light-emitting device according to the selected or calculated light emission control information. Even when receiving the same light emission control packet, light-emitting device 100 may apply different light emission control information according to a result of comparing the internal application criteria information and the device correspondence information. In step S9120, light-emitting device 100 may transmit reception state information or processing result information to the repeater 200.

In step S9130, repeater 200 may transmit the reception state information or the processing result information received from the light-emitting device 100 to the control device 300. In step S9140, control device 300 may update the transmission schedule based on the reception state information. For example, control device 300 may adjust at least one of a transmission repetition count, a transmission timing, a number of transmission resources, a repeated transmission interval, and a secondary transmission path based on at least one of whether reception is successful, a reception failure rate, signal quality, whether a response is made for each device, and whether a processing result matches.

The method of FIG. 17 can configure an entire procedure from a generation of a light emission control packet to a transmission schedule update as one continuous control flow and can improve control reliability in that a transmission structure can be adaptively adjusted according to a change in a performance environment or a change in a communication state. For example, when reception failure is repeated in some light-emitting devices, control device 300 can increase a reception success rate by increasing a transmission repetition count or rearranging other transmission resources in a next control cycle.

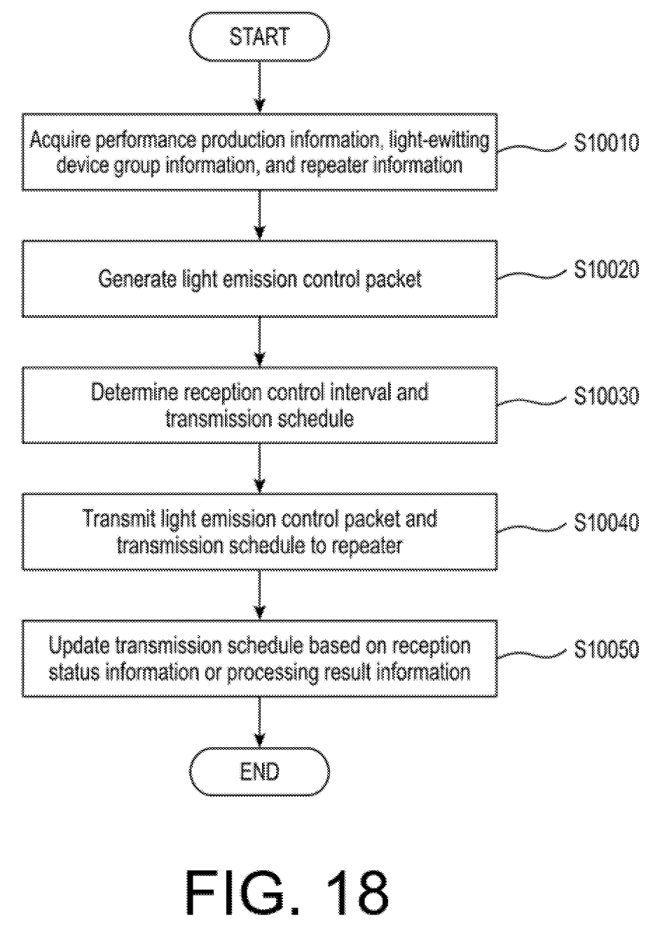

FIG. 18 is a flowchart illustrating a method for generating and updating a transmission schedule performed by a control device 300 according to an embodiment.

In step S10010, control device 300 may acquire at least one of performance production information, information on a light-emitting device group, and information on a repeater.

In step S10020, control device 300 may generate a light emission control packet based on the performance production information.

In step S10030, control device 300 may determine a reception control interval and a transmission schedule corresponding to a target light-emitting device group. Control device 300 may determine at least one of a length of the reception control interval, a number of transmission resources, an arrangement order of the transmission resources, a primary repeater, a secondary repeater, or a backup transmission resource based on at least one of a result of comparing a location of the target light-emitting device group with a transmittable range of a repeater, a time remaining until an execution timing of the light emission control packet, a priority of the light emission control packet, a data amount of differential light emission control information, a number of subgroups, and a past reception failure rate.

In step S10040, control device 300 may transmit the light emission control packet and the transmission schedule to a repeater. For example, the transmission schedule may be information defined such that a transmission resource corresponding to the light emission control packet is arranged within the reception control interval, and may include at least one of a target light-emitting device group, a transmission resource, a transmission timing, a transmission repetition count, a transmission priority, a primary repeater, and a secondary repeater.

In step S10050, control device 300 may update the transmission schedule based on reception state information or processing result information. For example, when a reception failure rate is at least a reference value, control device 300 may increase at least one of the length of the reception control interval, a number of downlink transmission resources, a transmission repetition count, and a backup transmission resource in a next cycle.

The method of FIG. 18 integrates the initial generation of a transmission schedule based on performance production information and the subsequent update of the schedule based on reception results into a single control flow of the control device 300, thereby increasing transmission stability for a large-scale light-emitting device group and real-time performance of differential control.

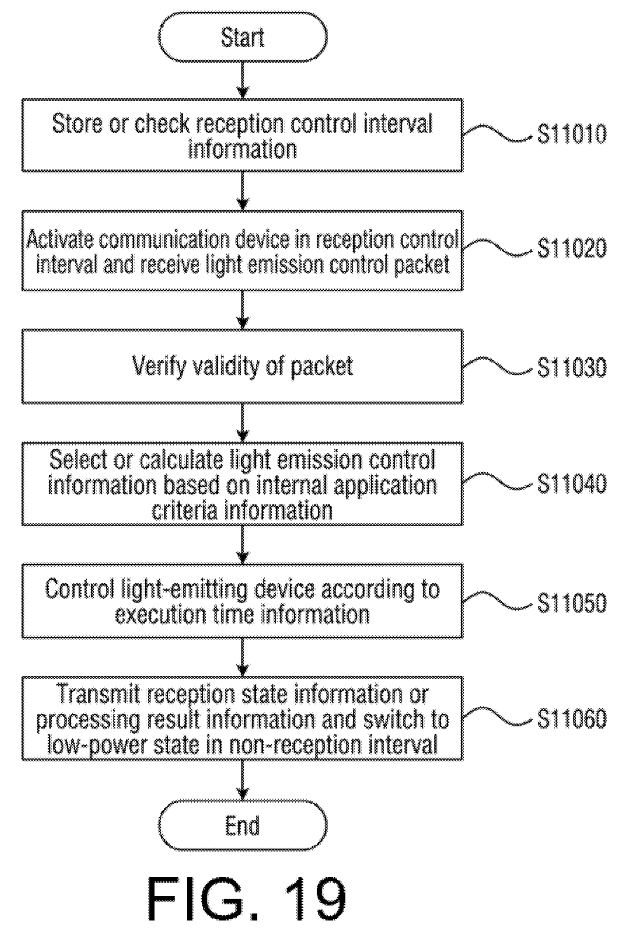

FIG. 19 is a flowchart illustrating a method for processing a light emission control packet performed by a light-emitting device 100 according to an embodiment.

In step S11010, light-emitting device 100 may store or check reception control interval information corresponding to a light-emitting device group to which light-emitting device 100 belongs.

In step S11020, light-emitting device 100 may activate a communication device in a reception control interval and receive a light emission control packet. The reception control interval may include at least one of a reception interval, a restricted access interval, or a common reception control interval. Light-emitting device 100 may activate the communication device only in the reception control interval and reduce power consumption of the communication device in non-reception intervals.

In step S11030, light-emitting device 100 may verify validity of the received light emission control packet. For example, light-emitting device 100 may determine whether the light emission control packet is a processing target packet based on at least one of packet identification information, error detection information, valid time information, execution time information, and transmission target information.

In step S11040, light-emitting device 100 may select or calculate light emission control information based on internal application criteria information when the internal application criteria information is included in the light emission control packet. Light-emitting device 100 may determine the light emission control information to be applied to itself by comparing the internal application criteria information with device correspondence information stored in a memory. For example, the device correspondence information may include at least one of light-emitting device group identification information, subgroup identification information, device identification information, a location index, a row/column index, a pattern index, mask information, and state information. When light-emitting device 100 belongs to a subgroup G1-2, light-emitting device 100 may select differential light emission control information corresponding to the subgroup G1-2 based on the internal application criteria information.

In step S11050, light-emitting device 100 may control a light source device based on the selected or calculated light emission control information according to execution time information. For example, light-emitting device 100 may immediately apply light emission control information when immediate execution information is included, and when a reserved execution time is included, light-emitting device 100 may store the light emission control information in a standby state until the reserved execution time and then control the light source device.

In step S11060, light-emitting device 100 may transmit reception state information or processing result information to a repeater or a control device, and switch to a low-power state in a non-reception interval.

The method of FIG. 19 allows light-emitting device 100 to perform differential control for each light-emitting device 100 or each subgroup according to the internal application criteria information while operating the communication device in accordance with the reception control interval. Such a structure can reduce unnecessary reception standby time, implement different light emission effects within one light-emitting device group, and enable a subsequent transmission schedule update based on reception state information or processing result information.

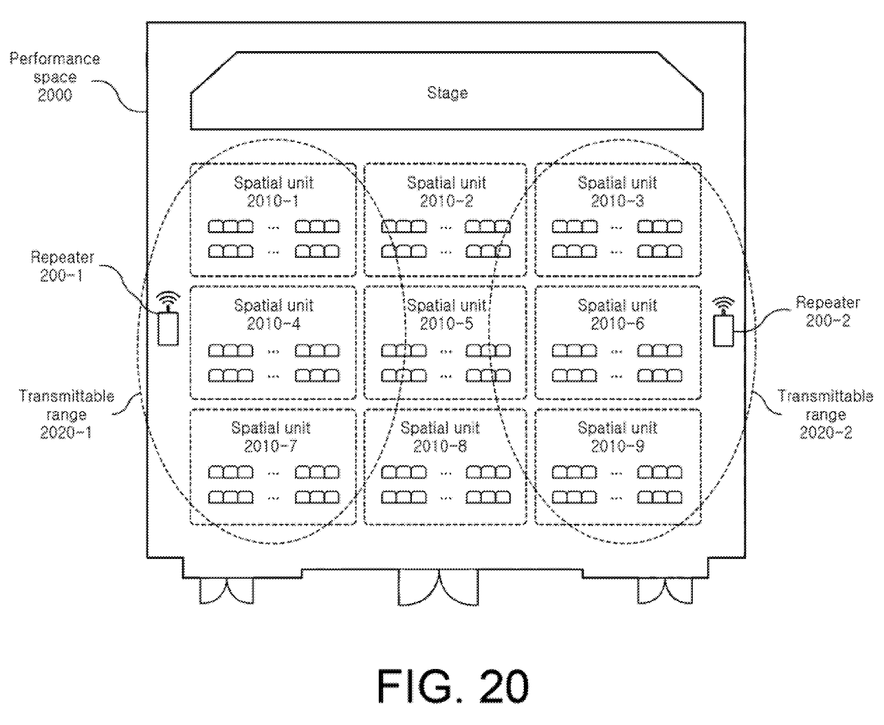

FIG. 20 is a diagram illustrating an arrangement of spatial units and transmittable ranges 2020-1, 2020-2 of a plurality of repeaters 200-1, 200-2 within a performance space 2000, according to an embodiment. In FIG. 20, the performance space 2000 may be illustrated in a structure including a stage and an audience area, and the audience area may be expressed as being divided into a plurality of spatial units 2010-1 to 2010-9. FIG. 20 may be a diagram for explaining a process in which a control device maps performance production information to performance space information and searches for or selects a repeater and a beam transmission profile corresponding to a target spatial area.

The performance space 2000 may be at least one of a concert hall, a stadium, a fan meeting venue, and an outdoor event space. The audience area within the performance space 2000 may be divided into a plurality of spatial units 2010-1 to 2010-9 according to control purposes. A spatial unit may be used as a reference unit to reflect both the arrangement state of light-emitting devices and a transmission control unit. For example, one spatial unit may correspond to at least one of a seat block, a set of seat rows, a set of seat columns, a zone for each floor, and a virtual partitioned area.

The plurality of spatial units 2010-1 to 2010-9 in FIG. 20 may be set according to spatial unit definition information included in the performance space information. The control device may partition the performance space 2000 into a plurality of areas of the same size or different sizes based on the spatial unit definition information. For example, an area in front of the stage may be divided into finer units, and the rear audience seat area may be divided into relatively larger units. The control device may set the size or boundary of a spatial unit based on at least one of the precision of performance production, the density of light-emitting devices, and an arrangement state of repeaters.

Each spatial unit 2010-1 to 2010-9 may correspond to a light-emitting device or a light-emitting device group. The control device may identify which light-emitting device or light-emitting device group is arranged in a specific spatial unit based on spatial correspondence information. For example, spatial unit 2010-4 may correspond to a light-emitting device group arranged in the left middle audience seats, and spatial unit 2010-8 may correspond to a light-emitting device group arranged in the center bottom audience seats. When production target indication information is given as at least one of a space name, a seat block name, and a coordinate range, the control device may convert the indication target into at least one of the plurality of spatial units based on the spatial correspondence information.

In FIG. 20, a plurality of repeaters 200-1, 200-2 and transmittable ranges 2020-1, 2020-2 corresponding to each repeater may be shown together. The transmittable range may be higher-level concept information representing a reference range in which a repeater can cause a light emission control packet to reach. The control device may determine which repeater's transmittable range includes each spatial unit based on transmission reference information. For example, at least one of the spatial units in the left area 2010-1, 2010-4, 2010-7 may be included in the transmittable range 2020-1 of the repeater 200-1, and at least one of the spatial units in the right area 2010-3, 2010-6, 2010-9 may be included in the transmittable range 2020-2 of the repeater 200-2.

The transmittable ranges of the plurality of repeaters may overlap with each other. In FIG. 20, it may be understood as an embodiment in which at least one of the spatial units in the center area 2010-2, 2010-5, 2010-8 is included in both transmittable ranges of the repeater 200-1 and the repeater 200-2. When the target spatial area can be covered by two or more repeaters, the control device may search for a plurality of candidate repeaters and a plurality of candidate beam transmission profiles. In the searching step, repeaters that can include the spatial unit may be found first, and in the selecting step, an appropriate profile may be selected again from the plurality of searched beam transmission profiles.

The control device may determine the target spatial area by mapping production target indication information included in the performance production information to performance space information. For example, when the production target indication information indicates a center front area, the control device may determine at least one of spatial unit 2010-2 and spatial unit 2010-5 as the target spatial area. For example, when the production target indication information indicates a right entire area, the control device may determine an area including at least one of spatial unit 2010-3, spatial unit 2010-6, and spatial unit 2010-9 as the target spatial area. The control device may configure the set of spatial units differently depending on whether the production target indication information indicates one continuous area or a plurality of separated areas.

The control device may search for a beam transmission profile for each repeater with respect to the identified target spatial area. The transmittable range shown in FIG. 20 may be used as a higher-level criterion for searching for candidate repeaters, and an actual beam transmission profile may correspond to a more subdivided estimated coverage area within the transmittable range. For example, the repeater 200-1 may have at least one of a left-extended profile, a center-focused profile, and a downward-extended profile, and the repeater 200-2 may have at least one of a right-extended profile, a center-focused profile, and an upward-extended profile. The control device may search for candidate beam transmission profiles based on which spatial unit set constitutes the target spatial area.

To select a final profile among the plurality of searched beam transmission profiles, the control device may calculate at least one of a target area inclusion ratio and a non-applied area inclusion ratio. The target area inclusion ratio may be calculated based on at least one of the number of spatial units, the number of light-emitting devices, and an area ratio included in the estimated coverage area among the target spatial area. The non-applied area inclusion ratio may be calculated based on the degree to which the estimated coverage area includes adjacent spatial units that are not targets of transmission. For example, the control device may select profiles having a target area inclusion ratio equal to or greater than a first reference value as primary candidates, and then select a profile having a lower non-applied area inclusion ratio among the selected candidates; as another example, it may select a profile based on an evaluation value reflecting both ratios.

The structure of FIG. 20 may also be used as a basis for generating a result of determining spatial selectivity. The control device may generate the result of determining spatial selectivity based on at least one of an area ratio occupied by the target spatial area in the entire performance space 2000, the number of separated spatial units, a necessity to limit leakage into non-applied spatial areas, and a priority of a light emission control packet. For example, when the target spatial area includes most of the spatial units, it may generate a determination result corresponding to an all-transmission condition. For example, when the target spatial area is limited to some spatial units on the left or right, it may generate a determination result corresponding to a selected-area-limited transmission condition, and when it includes separated spatial units on both the left and right sides, it may generate a determination result corresponding to a multiple-separated-area transmission condition.

An embodiment in which the target spatial area is determined by a user interface input may also be described in FIG. 20. For example, when an operator selects some blocks in front of the stage by dragging on a venue map displayed on the user interface device, the control device converts the selected screen coordinates into performance space coordinates and then identifies spatial units that overlap with the converted coordinates. The control device determines the identified spatial units as the target spatial area and can search for a repeater and a beam transmission profile that can include those spatial units. Using this structure, manual production changes or emergency control inputs during a performance can be quickly reflected on a spatial unit basis.

By using the embodiment of FIG. 20, the control device can interpret the spatial meaning of performance production information at the spatial unit level and perform spatial-selective transmission control by selecting an appropriate target among a plurality of repeaters and a plurality of beam transmission profiles. The control device can reduce transmission to unnecessary non-applied spatial areas and increase the reachability of packets to the target spatial area. Furthermore, since candidate repeaters or candidate beam transmission profiles can be flexibly explored by utilizing overlapping coverage areas, stable spatial-based light emission control can be supported even when there is at least one of a venue structure change, a production change, and a communication quality variation.

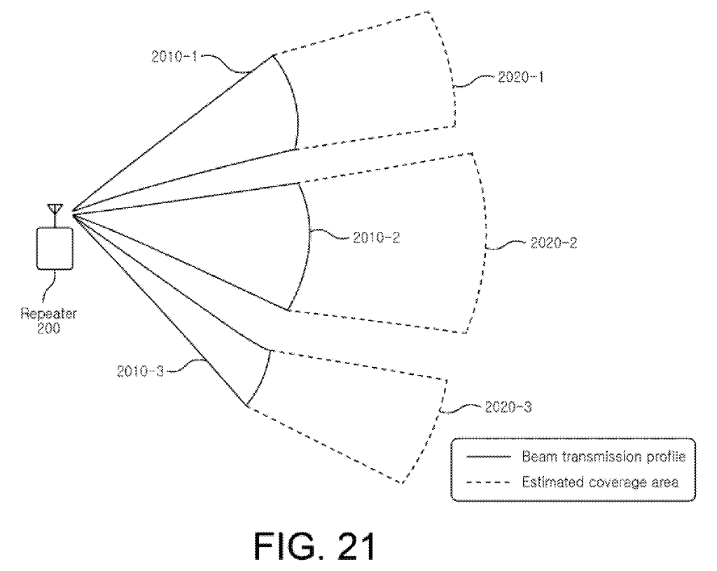

FIG. 21 is a diagram illustrating a plurality of beam transmission profiles 2010-1, 2010-2, 2010-3 and a plurality of estimated coverage areas 2020-1, 2020-2, 2020-3 of a repeater 200, according to an embodiment. In FIG. 21, areas shown with solid lines may represent beam transmission profiles that the repeater 200 can form. Areas shown with dotted lines may indicate estimated coverage areas where a light emission control packet is expected to reach when each beam transmission profile is applied.

A beam transmission profile 2010-1, 2010-2, 2010-3 represents a transmission state that the repeater 200 can form by controlling an antenna device. Beam transmission profiles can be distinguished by at least one of a main transmission direction, beam width, transmission power level, antenna pattern, phase control values, and amplitude control values. For example, the first beam transmission profile 2010-1 may be a profile for transmitting a light emission control packet to an upper spatial area, the second beam transmission profile 2010-2 may be for a center spatial area, and the third beam transmission profile 2010-3 may be for a lower spatial area.

An estimated coverage area 2020-1, 2020-2, 2020-3 can be set corresponding to each beam transmission profile. The estimated coverage area is not limited to the geometric shape of the beam transmission profile itself. It represents the spatial range where the light emission control packet is expected to reach in an actual performance space. For example, an estimated coverage area can be determined based on at least one of the installation position of the repeater 200, antenna installation direction, transmission power, venue structures, seat arrangement, pre-measured reception intensity, and simulation results.

A control device can acquire a plurality of beam transmission profiles 2010-1, 2010-2, 2010-3 and a plurality of estimated coverage areas 2020-1, 2020-2, 2020-3 from information regarding the repeater 200. Information on the repeater 200 can be provided from a profile table stored in the memory of the repeater 200 or from performance space information stored in the memory of the control device. For example, the profile table may include at least one of beam transmission profile identification information, main transmission direction, beam width, transmission power level, estimated coverage area identification information, and antenna control reference information.

The control device can select a final beam transmission profile to be used based on a relationship between a target spatial area and an estimated coverage area. The control device can calculate a portion of the target spatial area included in the estimated coverage area as a target area inclusion ratio. For example, if 8 out of 10 spatial units included in the target spatial area are contained within the second estimated coverage area 2020-2, the control device can calculate the target area inclusion ratio for the second beam transmission profile 2010-2 as 80%.

The control device can calculate a non-applied area inclusion ratio based on the degree of overlap between the estimated coverage area and a non-applied spatial area. A non-applied spatial area may be a spatial area not intended to be a target for the light emission control packet. For example, if the target spatial area is limited to a center block, and the second estimated coverage area 2020-2 broadly includes the center block without excessively including adjacent upper or lower blocks, the control device may preferentially select the second beam transmission profile 2010-2.

The control device can evaluate the target area inclusion ratio and the non-applied area inclusion ratio independently or evaluate both ratios together. For example, the control device can select a beam transmission profile having a target area inclusion ratio equal to or greater than a first reference value as a primary candidate. Then, the control device can select a beam transmission profile having a non-applied area inclusion ratio equal to or less than a second reference value among the primary candidates. Alternatively, the control device may select a beam transmission profile according to an evaluation value calculated based on at least one of the target area inclusion ratio, non-applied area inclusion ratio, transmission power level, repeater load, and beam switching delay.

The first and second reference values are not limited to fixed numerical values. The control device can determine the first or second reference value based on at least one of performance type, priority of the light emission control packet, remaining time until execution, sensitivity of light emission effects, the degree of allowed transmission to non-applied spatial areas, repeater load, and user settings. For example, in a production where only a specific seat block must be expressed in a different color, the criteria for the non-applied area inclusion ratio may be set more strictly. In a production for transitioning the overall atmosphere, the criteria for the target area inclusion ratio may be used with higher priority.

The repeater 200 can receive the light emission control packet and a beam transmission condition from the control device. The repeater 200 can select one of the plurality of beam transmission profiles 2010-1, 2010-2, 2010-3 based on beam transmission profile identification information or target spatial area information included in the beam transmission condition. The repeater 200 determines antenna control information to be applied to the antenna device based on antenna control reference information corresponding to the selected beam transmission profile. For example, the repeater 200 can set at least one of an antenna selection value, phase control value, amplitude control value, and transmission power value to form the second beam transmission profile 2010-2.

The embodiment of FIG. 21 can also be applied to controlling the antenna device according to transmission mode information. If the transmission mode information indicates a directional transmission mode or a beamforming transmission mode, the repeater 200 can form one beam transmission profile corresponding to the target spatial area. If the transmission mode information indicates a multi-beam transmission mode, the repeater 200 can sequentially or simultaneously form a plurality of beam transmission profiles corresponding to a plurality of target spatial areas. For example, the repeater 200 can sequentially apply the first beam transmission profile 2010-1 and the third beam transmission profile 2010-3 to control separated spatial areas corresponding to the first estimated coverage area 2020-1 and the third estimated coverage area 2020-3.

Using the structure of FIG. 21, the control device can determine beam transmission conditions by considering both reachability to the target spatial area and the possibility of leakage into non-applied spatial areas. The repeater 200 controls the antenna device based on the determined beam transmission conditions and can spatially and selectively transmit the light emission control packet to the target spatial area. The light-emitting device control system can reduce unnecessary diffusion of the light emission control packet, increase the accuracy of light emission production for a specific spatial area, and quickly respond to production changes for each spatial unit during a performance.

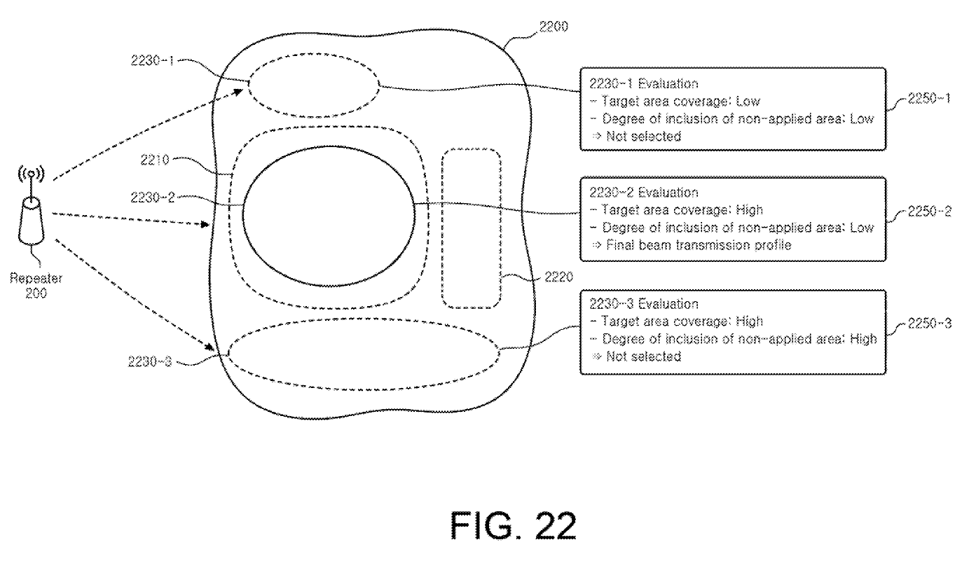

FIG. 22 is a diagram illustrating an embodiment of selecting a beam transmission profile based on evaluation results for a plurality of estimated coverage areas 2230-1, 2230-2, 2230-3 according to an embodiment. Referring to FIG. 22, a target spatial area 2210 and a non-applied spatial area 2220 may be set within a performance space 2200. A control device evaluates the estimated coverage areas 2230-1, 2230-2, 2230-3 respectively corresponding to a plurality of candidate beam transmission profiles and selects a final beam transmission profile to be used based on evaluation results 2250-1, 2250-2, 2250-3.

The target spatial area 2210 may be a spatial area where a light emission control packet is intended to reach. The non-applied spatial area 2220 may be a spatial area not intended as a target for the light emission control packet. The control device determines the target spatial area 2210 by mapping production target indication information included in performance production information to performance space information and can set at least a portion of the performance space 2200, excluding the target spatial area 2210, as the non-applied spatial area 2220.

The estimated coverage areas 2230-1, 2230-2, 2230-3 may correspond to different candidate beam transmission profiles. The control device can acquire a plurality of beam transmission profiles that a repeater can form and estimated coverage areas corresponding to each beam transmission profile from information regarding the repeater. For example, the first estimated coverage area 2230-1 may correspond to a candidate profile narrowly formed in an upward direction, the second estimated coverage area 2230-2 may correspond to a candidate profile formed around the target spatial area 2210, and the third estimated coverage area 2230-3 may correspond to a candidate profile widely formed in a downward direction.

The control device can calculate a target area inclusion ratio based on a degree of overlap between the target spatial area 2210 and each estimated coverage area. The target area inclusion ratio represents the degree of a portion of the target spatial area 2210 that is included in each estimated coverage area. The target area inclusion ratio can be calculated based on at least one of an area, the number of spatial units, and the number of light-emitting devices. For example, if 90 out of 100 light-emitting devices included in the target spatial area 2210 are contained within the second estimated coverage area 2230-2, the control device calculates the target area inclusion ratio of the second estimated coverage area 2230-2 as 90%.

The control device can calculate a non-applied area inclusion ratio based on a degree of overlap between each estimated coverage area and the non-applied spatial area 2220. The non-applied area inclusion ratio may be a value for evaluating the possibility that a candidate beam transmission profile causes a light emission control packet to reach a spatial area that is not a transmission target. The non-applied area inclusion ratio can be calculated based on at least one of an area of the estimated coverage area overlapping with the non-applied spatial area 2220, the number of spatial units, and the number of light-emitting devices. For example, if an estimated coverage area of a specific candidate profile includes the target spatial area 2210 but also broadly includes the non-applied spatial area 2220, the control device calculates a high non-applied area inclusion ratio for that candidate profile.

The control device can evaluate the target area inclusion ratio and the non-applied area inclusion ratio independently or evaluate both ratios together. For example, the control device can select a beam transmission profile having a target area inclusion ratio equal to or greater than a first reference value as a primary candidate. For example, the control device selects a beam transmission profile having a non-applied area inclusion ratio equal to or less than a second reference value among the primary candidates. For example, the control device calculates an evaluation value based on at least one of the target area inclusion ratio, the non-applied area inclusion ratio, a transmission power level, a repeater load, and a beam switching delay, and can select a beam transmission profile according to the calculated evaluation value.

According to evaluation result 2250-1 in FIG. 22, the first estimated coverage area 2230-1 can be evaluated as having low target area coverage and a low degree of inclusion of a non-applied area. Since the first estimated coverage area 2230-1 does not include a sufficient portion of the target spatial area 2210, it may not be selected as a final beam transmission profile. According to evaluation result 2250-3 in FIG. 22, the third estimated coverage area 2230-3 is evaluated as having high target area coverage but also a high degree of inclusion of the non-applied area. Since the third estimated coverage area 2230-3 has a possibility that the light emission control packet excessively reaches the non-applied spatial area 2220, it may not be selected as the final beam transmission profile.

According to evaluation result 2250-2 in FIG. 22, the second estimated coverage area 2230-2 can be evaluated as having high target area coverage and a low degree of inclusion of the non-applied area. The control device can select a beam transmission profile corresponding to the second estimated coverage area 2230-2 as the final beam transmission profile. The control device can determine beam transmission conditions to include at least one of identification information, a main transmission direction, a transmission coverage range, a transmission power level, and a beam maintenance time of the selected beam transmission profile.

The first reference value and the second reference value may not be limited to fixed numerical values. The control device can determine the first reference value or the second reference value based on at least one of a performance type, a priority of the light emission control packet, a remaining time until an execution timing, sensitivity of a light emission effect, a degree of allowed transmission to the non-applied spatial area, and user settings. For example, in a production where only a specific seat block should be represented in a different color, the criteria for the non-applied area inclusion ratio can be strictly set. For example, in a production where inclusion of a portion of an adjacent area is allowed, such as transitioning the overall atmosphere, a higher weight can be given to the target area inclusion ratio.

Using the embodiment of FIG. 22, the control device can determine beam transmission conditions by considering both reachability to the target spatial area 2210 and a possibility of leakage into the non-applied spatial area 2220. A repeater can transmit a light emission control packet by applying antenna control information corresponding to the beam transmission profile selected by the control device. The light-emitting device control system can increase the accuracy of light emission production for a specific spatial area and reduce unnecessary light emission operations that may occur in unintended spatial areas.

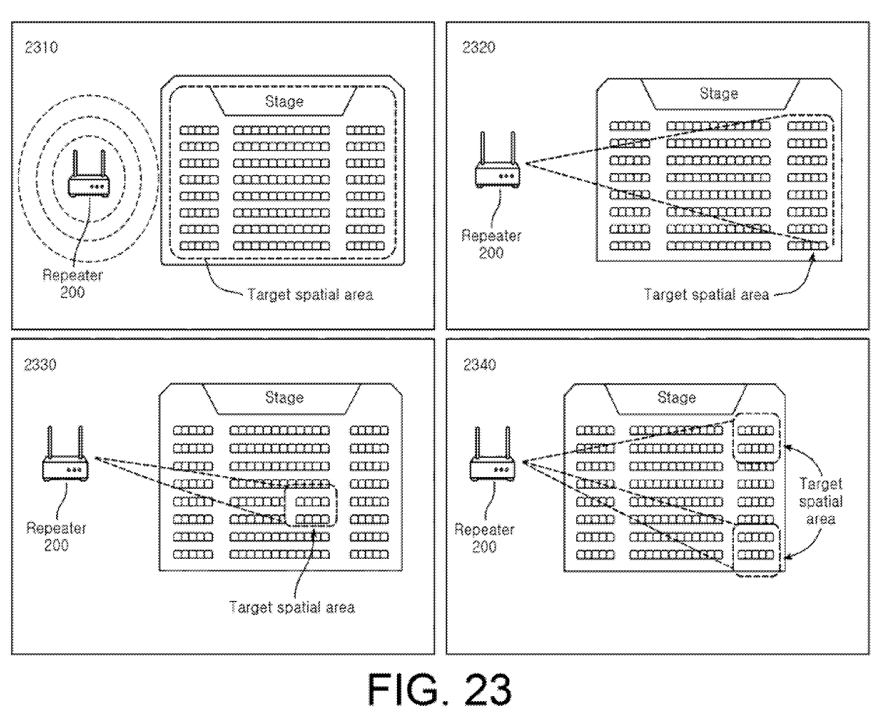

FIG. 23 is a diagram illustrating an embodiment of selecting a transmission mode according to a result of determining spatial selectivity. Referring to FIG. 23, a control device may select one of an omnidirectional transmission mode 2310, a directional transmission mode 2320, a beamforming transmission mode 2330, or a multi-beam transmission mode 2340 according to a shape of a target spatial area. Each embodiment in FIG. 23 may indicate that a different transmission mode may be selected based on at least one of a range occupied by the target spatial area within a performance space, directionality, a necessity for restriction, and whether areas are separated.

The control device may generate the result of determining spatial selectivity by analyzing spatial characteristics of the target spatial area. The result of determining spatial selectivity may correspond to at least one of an all-transmission condition, a single-direction transmission condition, a selected-area-limited transmission condition, and a multiple-separated-area transmission condition. The control device may generate the result of determining spatial selectivity based on at least one of an area ratio of the target spatial area, a number of separated spatial units constituting the target spatial area, whether to restrict transmission to a non-applied spatial area, and a priority of a light emission control packet.

In FIGS. 23, 2310 may represent a case where the target spatial area corresponds to an entire area of the performance space or an area beyond a reference range. The control device may generate the result of determining spatial selectivity corresponding to the all-transmission condition when the target spatial area occupies a reference ratio or more of all spatial units, or when the light emission control packet is for global synchronization or global color transition. For example, if all light-emitting devices must be lit in the same color in a starting scene of a performance, the control device may select the omnidirectional transmission mode 2310.

In the omnidirectional transmission mode 2310, a repeater 200 may transmit a light emission control packet to the entire performance space or an area beyond a reference range. The control device may include at least one of the all-transmission condition, omnidirectional transmission mode information, a transmission power level, and a transmission repetition count in beam transmission conditions. For example, the control device may determine the beam transmission conditions to increase the transmission repetition count or the transmission power level when the priority of the light emission control packet is high or a remaining time until an execution timing is short.

In FIGS. 23, 2320 may represent a case where the target spatial area is concentrated in one direction. The control device may generate the result of determining spatial selectivity corresponding to the single-direction transmission condition when the target spatial area is included in a specific angle range or a specific direction range relative to the repeater 200. For example, when an entire right audience seat block becomes one production target, the control device may select the directional transmission mode 2320 and determine beam transmission conditions including a main transmission direction and a transmission coverage range.

In FIGS. 23, 2330 may represent a case where the target spatial area is restricted to some areas within the performance space. The control device may generate the result of determining spatial selectivity corresponding to the selected-area-limited transmission condition when the target spatial area is limited to a specific seat block, a specific set of seat rows, a specific coordinate range, or a specific light-emitting device group, and transmission restriction to a non-applied spatial area is necessary. For example, when only some blocks of center audience seats must emit light in a different color, the control device may select the beamforming transmission mode 2330.

In the beamforming transmission mode 2330, the control device may search for candidate beam transmission profiles corresponding to the target spatial area and select a final beam transmission profile by evaluating at least one of a target area inclusion ratio and a non-applied area inclusion ratio. The control device may determine the beam transmission conditions to include at least one of identification information, a main transmission direction, a beam width, a transmission power level, and a beam maintenance time of the selected beam transmission profile. For example, the control device may select a beam transmission profile that sufficiently includes the target spatial area while including fewer adjacent seat blocks.

In FIGS. 23, 2340 may represent a case where the target spatial area consists of a plurality of spatial areas separated from each other. The control device may generate the result of determining spatial selectivity corresponding to the multiple-separated-area transmission condition when a number of separated spatial units constituting the target spatial area is a reference number or more, or when the non-applied area inclusion ratio excessively increases if multiple areas are simultaneously covered by one beam transmission profile. For example, when an upper right block and a lower right block are production targets at the same time and an area between them is a non-applied spatial area, the control device may select the multi-beam transmission mode 2340.

In the multi-beam transmission mode 2340, the repeater 200 may sequentially or simultaneously form a plurality of beam transmission profiles corresponding to a plurality of target spatial areas. The control device may determine the beam transmission conditions to include at least one of beam transmission profile identification information for each target spatial area, a beam switching order, a beam maintenance time, a transmission repetition count, and a transmission priority. For example, if there is sufficient time remaining until an execution timing, the repeater 200 may sequentially apply a first beam transmission profile and a second beam transmission profile, and if multi-beam formation is possible, a plurality of beam transmission profiles may be formed together.

By using the embodiment of FIG. 23, the control device may select a transmission mode in accordance with a shape of the target spatial area and a necessity for restriction on non-applied spatial areas. The light-emitting device control system may process at least one of synchronized production for the entire performance space, directional production, specific block-restricted production, and multiple separated area production within one transmission control framework. The light-emitting device control system may reduce unnecessary packet transmission, increase reachability of packets to the target spatial area, and increase accuracy of light emission production for each spatial unit.

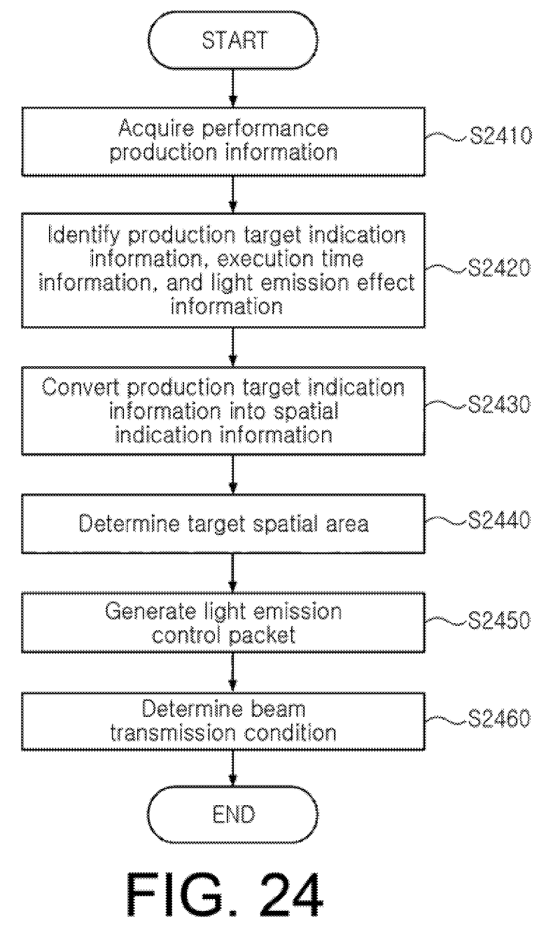

FIG. 24 is a flowchart illustrating a method for a control device to determine a target spatial area and a beam transmission condition from performance production information, according to an embodiment. The method of FIG. 24 may be performed by a processor of the control device. The method of FIG. 24 may represent a procedure for converting performance production information into information usable for spatial transmission control and generating a light emission control packet and a beam transmission condition based on the converted information.

In step S2410, the control device may acquire performance production information. The performance production information may be acquired from at least one of a performance operation server, a performance control program, a user interface device, and an external storage device. The performance production information may represent production content that a light-emitting device should perform according to performance progress time. For example, the performance production information may include light emission production content corresponding to at least one of a specific section of a song, a scene transition timing, an artist movement section, and an emergency control section.

In step S2420, the control device may identify at least one of production target indication information, execution time information, and light emission effect information from the performance production information. The production target indication information may represent a spatial target to which a light emission effect is to be applied, the execution time information may represent a timing when the light emission effect is to be applied, and the light emission effect information may represent at least one of color, brightness, blinking, fade, and a pattern to be output by the light-emitting device. For example, if the performance production information is configured to blink the right first-floor block in red 5 seconds after the chorus of song A starts, the control device may identify the right first-floor block as the production target indication information, 5 seconds after the chorus starts as the execution time information, and red blinking as the light emission effect information.

In step S2430, the control device may convert the production target indication information into spatial indication information. The spatial indication information may be information corresponding to a spatial unit identification system or a performance space coordinate system included in performance space information. When the production target indication information is given as a space name, the control device may convert it into spatial unit identification information by comparing it with spatial unit definition information, and when the production target indication information is given as screen coordinates, the control device may convert it into the performance space coordinate system. For example, the control device may convert the right first-floor block indication into spatial unit identification information corresponding to spatial unit 2010-3 and spatial unit 2010-6.

The conversion of spatial indication information may be performed based on performance space information. The performance space information may include at least one of a venue map, a seat arrangement structure, spatial unit definition information, spatial correspondence information, and transmission reference information. The control device may interpret the production target indication information based on at least one of a boundary of a spatial unit, a seat row/column arrangement, an arrangement of light-emitting device groups, and the performance space coordinate system. For example, if an operator drags a specific area on a seat arrangement map displayed on the user interface device, the control device converts screen coordinates of the dragged area into performance space coordinates and may determine a spatial unit overlapping the converted coordinates as the spatial indication information.

In step S2440, the control device may determine the target spatial area based on the spatial indication information. The target spatial area may be an area within the performance space determined as a target to which the light emission control packet is to be transmitted. When the spatial indication information represents one spatial unit, the control device may determine that spatial unit as the target spatial area, and when the spatial indication information represents a plurality of spatial units or a coordinate range, the control device may determine an area including the plurality of spatial units or the coordinate range as the target spatial area.

The target spatial area may be determined as a continuous area or a separated area according to production purposes. For example, if an entire specific audience seat block should output the same light emission effect, the control device may determine one continuous area as the target spatial area. For example, if an upper left block and a lower right block should simultaneously output the same light emission effect, the control device may manage a plurality of spatial units separated from each other as one target spatial area. The control device may use at least one of an area ratio of the target spatial area, the number of separated spatial units, and a necessity for transmission restriction to a non-applied spatial area as a criterion for selecting a subsequent transmission mode.

In step S2450, the control device may generate a light emission control packet. The control device may generate the light emission control packet based on at least one of the execution time information and the light emission effect information. The light emission control packet may include at least one of light emission control information, execution time information, target spatial area information, spatial indication information, packet identification information, priority information, and error detection information. For example, the control device may configure the light emission control packet to include execution time information corresponding to 5 seconds after the chorus starts and light emission control information corresponding to red blinking.

In step S2460, the control device may determine a beam transmission condition based on at least one of the target spatial area and information regarding a repeater. The control device may search for a repeater and a beam transmission profile capable of covering the target spatial area and evaluate an estimated coverage area of the searched beam transmission profile. The control device may select a final beam transmission profile based on at least one of a target area inclusion ratio, a non-applied area inclusion ratio, a transmission power level, a beam switching delay, and a repeater load. The beam transmission condition may be information for causing the selected repeater to form the selected beam transmission profile.

By using the method of FIG. 24, the control device can convert spatial intent included in performance production information into a target spatial area and a beam transmission condition for a light emission control packet. The control device can generate the light emission control packet and the beam transmission condition by reflecting both temporal elements and spatial elements of the performance production information. A repeater can transmit the light emission control packet to the target spatial area according to the beam transmission condition. The light-emitting device control system can concentrate a light emission effect in a spatial area intended by a performance director and reduce the possibility of unnecessary packet reach to a non-applied spatial area.

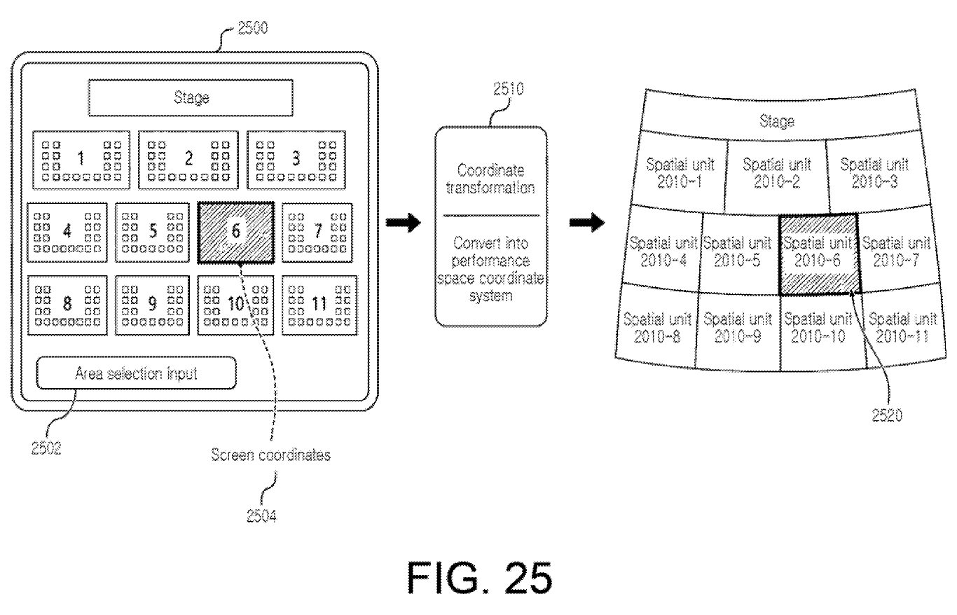

FIG. 25 is a diagram illustrating an embodiment of converting an area selection input entered through a user interface device into a performance space coordinate system and determining a target spatial area based on the converted performance space coordinates. Referring to FIG. 25, a user interface screen 2500 may display a venue map or a seat arrangement map, and a performance operator or a director can select a specific screen area through an area selection input 2502.

The user interface screen 2500 can represent an actual performance space in a screen format that is easy for the operator to recognize. The user interface screen 2500 can display a venue map including at least one of a stage position, a seat block, a seat row, a seat column, a passage, a floor division, and a temporary installation area. For example, the user interface screen 2500 displays a plurality of seat blocks as numbers 1 to 11 and can be configured so that the operator can select a specific block.

The area selection input 2502 may be a user input for designating a target spatial area. The area selection input 2502 may include at least one of a touch input, a mouse input, a pointer input, a drag input, a box selection input, a polygon selection input, and a seat block selection input. For example, when the operator selects a seat block indicated by number 6 on the user interface screen 2500, the control device can acquire screen coordinates 2504 corresponding to the selected screen area.

The control device can convert the screen coordinates 2504 into performance space coordinates corresponding to the performance space coordinate system. The coordinate transformation 2510 may be a process of mapping display coordinates of the user interface screen 2500 to spatial coordinates or a spatial unit identification system used in the actual performance space. The coordinate transformation 2510 may be performed based on at least one of a screen reference point, a performance space reference point, a scale ratio, a rotation angle, an enlargement or reduction state of a screen display area, a seat arrangement reference point, and a curved seat correction value.

The performance space coordinate system may be defined to correspond to an actual spatial arrangement of the venue map or the seat arrangement map. The performance space coordinate system can be implemented with at least one of an orthogonal coordinate system, a polar coordinate system, a block identification system, a row or column identification system, or a virtual spatial unit identification system. For example, as shown in the right drawing of FIG. 25, when actual audience seats are arranged in a curved shape relative to the stage, the control device can correct the screen coordinates 2504 into performance space coordinates corresponding to the curved seat arrangement.

The control device can identify one or more spatial units by comparing the converted performance space coordinates with performance space information. The performance space information includes at least one of spatial unit definition information, spatial correspondence information, and transmission reference information. For example, the control device can determine that the selected screen coordinates 2504 are located inside the boundary of a spatial unit 2010-6 on the converted performance space coordinates and can determine the spatial unit 2010-6 as a target spatial area 2520.

The target spatial area 2520 may include one spatial unit or a plurality of spatial units according to a size or shape of the area selection input 2502. For example, when the operator selects only one seat block, the control device can determine one spatial unit as the target spatial area 2520. For example, when the operator selects a plurality of seat blocks by dragging, the control device can determine a plurality of spatial units overlapping with the selected area as the target spatial area 2520.

When a boundary of the area selection input 2502 overlaps with only a portion of a spatial unit, the control device can determine the target spatial area 2520 based on a degree of overlap. The degree of overlap can be calculated based on at least one of an area ratio where the selection area and the spatial unit overlap, the number of light-emitting devices included in the selection area, the number of seats included in the selection area, and user setting criteria. For example, if 50% or more of a specific spatial unit overlaps with the selection area, the control device can include that spatial unit in the target spatial area 2520.

According to an embodiment, the number of spatial units constituting a target spatial area may be dynamically increased or decreased according to a progress of a performance or a change of a performance scenario. For example, the control device 300 may divide a performance space into a first number of spatial units in a first performance section, and may re-divide the performance space into a second number of spatial units larger than the first number in a second performance section requiring more precise production. For example, in the first performance section, the control device 300 may control a plurality of light-emitting devices 100 in units of two large spatial units, and in the second performance section, the control device 300 may control the plurality of light-emitting devices 100 in units of four or more sub-divided spatial units.

The control device 300 may dynamically change at least one of a boundary, a size, and a number of the spatial units based on at least one of the performance production information, the performance progress time, a reception state distribution, and an operator input. The repeater 200 may adjust at least one of a main transmission direction, a beam width, and a transmission power level of the beamforming antenna in accordance with the changed spatial units, and may transmit a light emission control packet to each of the changed spatial units. Accordingly, a degree of freedom of light emission production may be improved, and a coarse production and a fine production may be selectively performed according to a performance section.

After determining the target spatial area 2520, the control device can search for a repeater and a beam transmission profile corresponding to the target spatial area 2520. The control device can identify a repeater capable of covering the spatial unit 2010-6 based on transmission reference information and can search for a beam transmission profile having an estimated coverage area that includes the spatial unit 2010-6 among beam transmission profiles that the identified repeater can form. The control device can determine beam transmission conditions by calculating at least one of a target area inclusion ratio and a non-applied area inclusion ratio for the searched beam transmission profile.

By using the embodiment of FIG. 25, a selection on a screen by a performance operator or a director can be converted into performance space coordinates and spatial units, and the target spatial area 2520 can be determined based on a result of the conversion. The control device can convert production target indication information into spatial transmission control information through the coordinate transformation 2510 even when a display form of the seat arrangement map and an arrangement form of the actual performance space are different from each other. The light-emitting device control system can quickly reflect at least one of manual production designation, spontaneous production change, and emergency control input as beam transmission conditions on a spatial unit basis.

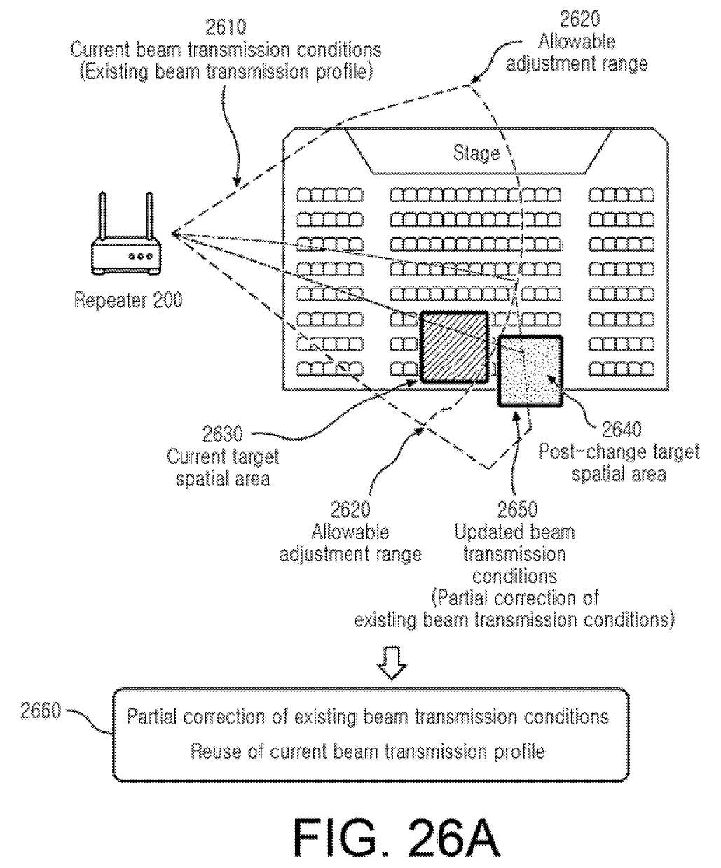

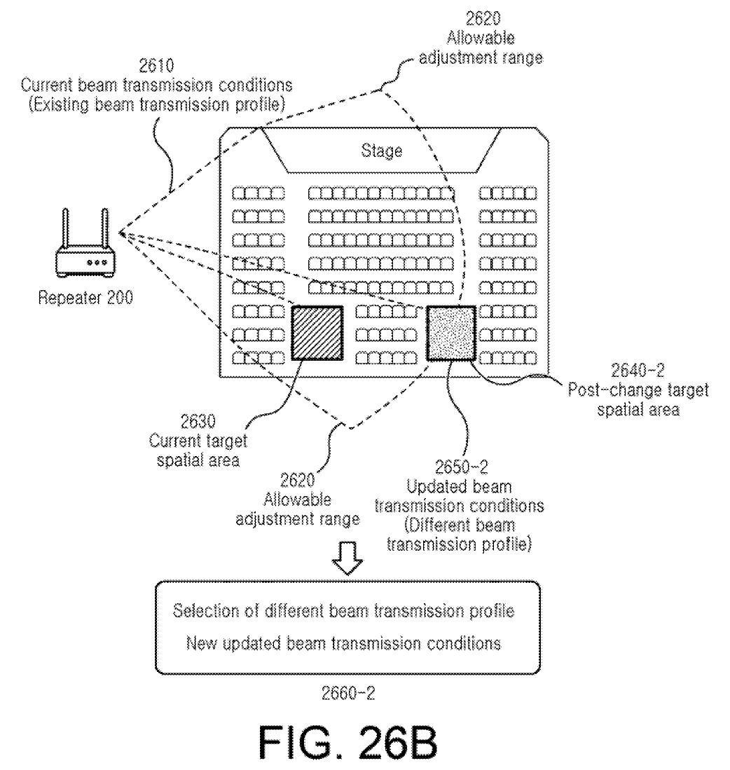

FIG. 26A is a diagram illustrating an embodiment of reusing a current beam transmission profile by partially correcting current beam transmission conditions during a real-time production change, according to an embodiment. Referring to FIG. 26A, a repeater 200 may be forming an existing beam transmission profile toward a current target spatial area 2630 according to current beam transmission conditions 2610. When real-time production change information or emergency control information occurs during a performance, the control device may determine a post-change target spatial area 2640 by mapping change target information to performance space information.

The control device may determine whether the current beam transmission conditions 2610 can cover the post-change target spatial area 2640 within an allowable adjustment range 2620. The allowable adjustment range 2620 may be a reference range for determining whether the current beam transmission profile is reusable. The allowable adjustment range 2620 may be set based on at least one of an adjustable angle of a main transmission direction, an adjustable range of a beam width, an adjustable range of a transmission power level, an adjustable range of antenna control values, and an allowable movement range of an estimated coverage area.

The control device may determine the reusability of the current beam transmission profile based on at least one of a position difference, a degree of overlap, and an area difference between the current target spatial area 2630 and the post-change target spatial area 2640. For example, if the post-change target spatial area 2640 moves to an area adjacent to the current target spatial area 2630 and can be included by slightly adjusting the main transmission direction or beam width of the current beam transmission profile, the control device may determine that the current beam transmission profile is reusable. For example, if the post-change target spatial area 2640 excessively deviates from the current estimated coverage area or can only be covered by excessively including a non-applied spatial area, the control device may determine that selecting a different beam transmission profile is necessary.

If the current beam transmission profile is reusable, the control device may determine updated beam transmission conditions 2650 by correcting a portion of the current beam transmission conditions 2610. The updated beam transmission conditions 2650 may be conditions for changing at least one of the main transmission direction, beam width, transmission power level, beam maintenance time, and transmission repetition count while maintaining the existing beam transmission profile. For example, if the post-change target spatial area 2640 is located to the right of the current target spatial area 2630, the control device may adjust the main transmission direction to the right, and if a coverage shortage is expected, it may increase the beam width or transmission power level.

A correction result 2660 of FIG. 26A may represent a partial correction of existing beam transmission conditions and the reuse of the current beam transmission profile. This method can generate updated beam transmission conditions 2650 faster than a method of searching for or completely replacing a new beam transmission profile. The light-emitting device control system can quickly respond to at least one of a spontaneous production change during a performance, a change in production area according to artist movement, emergency control for a specific area, and corrected transmission for some spatial areas. In addition, beam switching delay can be reduced, and the reachability of light emission control packets to the target spatial area can be maintained.

FIG. 26B is a diagram illustrating an embodiment of determining new updated beam transmission conditions by selecting a different beam transmission profile during a real-time production change, according to an embodiment. Referring to FIG. 26B, a repeater 200 may be forming an existing beam transmission profile toward a current target spatial area 2630 according to current beam transmission conditions 2610. When real-time production change information or emergency control information occurs during a performance, the control device may determine a post-change target spatial area 2640-2 by mapping change target information to performance space information.

The control device may determine whether the current beam transmission conditions 2610 can cover the post-change target spatial area 2640-2 within an allowable adjustment range 2620. The allowable adjustment range 2620 may represent an adjustable range while maintaining the existing beam transmission profile. The allowable adjustment range 2620 may be set based on at least one of an adjustable angle of the main transmission direction, an adjustable range of the beam width, an adjustable range of the transmission power level, an adjustable range of antenna control values, and an allowable movement range of an estimated coverage area.

If the post-change target spatial area 2640-2 is outside the allowable adjustment range 2620, the control device may determine that it is difficult to reuse the current beam transmission profile. For example, if the post-change target spatial area 2640-2 is significantly separated from the current target spatial area 2630, and the target area inclusion ratio is less than a reference value even if the main transmission direction or beam width of the existing beam transmission profile is adjusted, the control device may search for a different beam transmission profile. For example, if the non-applied area inclusion ratio exceeds a reference value when the existing beam transmission profile is expanded to include the post-change target spatial area 2640-2, the control device may not reuse the existing beam transmission profile.

The control device may determine new updated beam transmission conditions 2650-2 by selecting a different beam transmission profile corresponding to the post-change target spatial area 2640-2. The new updated beam transmission conditions 2650-2 may include at least one of identification information of a beam transmission profile different from the existing one, a main transmission direction, a transmission coverage range, a transmission power level, a beam maintenance time, and a beam switching order. For example, the control device may select a beam transmission profile having a high target area inclusion ratio and a low non-applied area inclusion ratio among candidate beam transmission profiles including the post-change target spatial area 2640-2.

A correction result 2660-2 of FIG. 26B may represent the selection of a different beam transmission profile and the determination of new updated beam transmission conditions. This method can be used when it is difficult to stably cover the post-change target spatial area 2640-2 by only partially correcting the current beam transmission profile. The light-emitting device control system can re-select an appropriate beam transmission profile even when the target spatial area moves significantly due to a real-time production change, and can increase the reachability of light emission control packets to the changed spatial area while reducing unnecessary transmission to non-applied spatial areas.

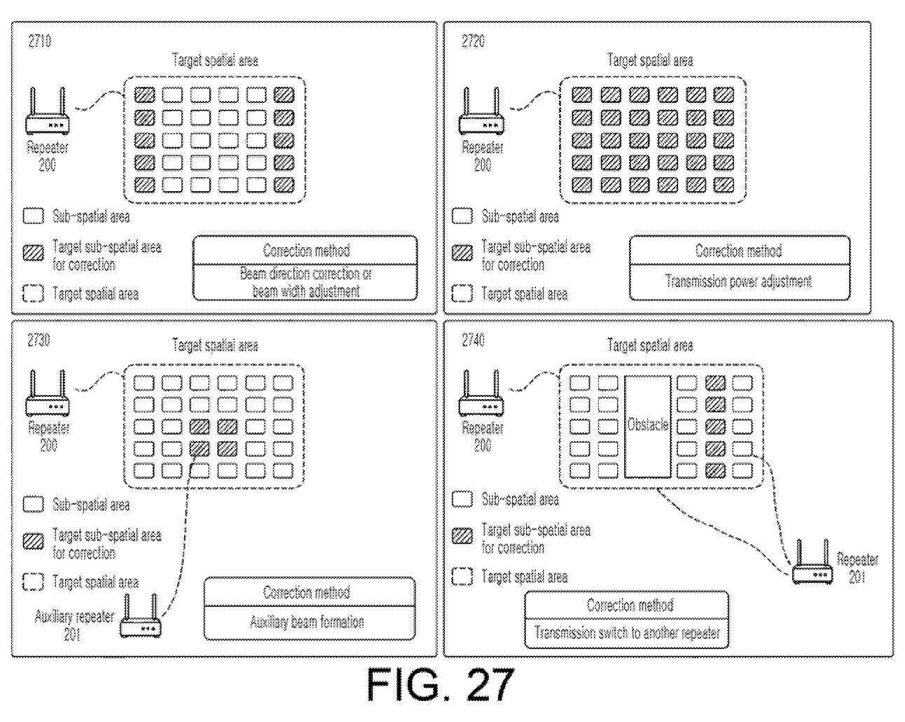

FIG. 27 is a diagram illustrating a plurality of embodiments of correcting beam transmission conditions based on a distribution of reception states, according to an embodiment. Referring to FIG. 27, a target spatial area may be divided into a plurality of sub-spatial areas, and a control device may calculate a reception state distribution by mapping reception state information or communication quality information obtained from light-emitting devices or repeaters to the plurality of sub-spatial areas. The control device may identify a target sub-spatial area for correction where reception quality does not satisfy a reference condition based on the reception state distribution.

The control device may determine a distribution type based on at least one of the location, number, arrangement direction, degree of concentration, and relationship with adjacent areas of the target sub-spatial area for correction. Distribution types may include at least one of a type where reception degradation is concentrated at a boundary of the target spatial area, a type where reception quality is low throughout the target spatial area, a type where reception degradation occurs only in a specific internal area, and a type where reception degradation occurs around a specific obstacle or shielding structure. For example, the control device may identify the target sub-spatial area for correction by comparing at least one of a reception failure rate, response rate, reception intensity, signal quality, and degree of error occurrence for each sub-spatial area.

2710 of FIG. 27 may represent a case where target sub-spatial areas for correction are concentrated at one boundary of the target spatial area. The control device may determine that the reception degradation at the boundary is caused by a deviation in the beam transmission direction or insufficient beam width. The control device may select beam direction correction or beam width adjustment as a correction method. For example, if the target sub-spatial area for correction is concentrated at the left boundary, the control device may adjust the main transmission direction to the left, and if the target sub-spatial areas for correction are distributed at both boundaries, it may increase the beam width.

2720 of FIG. 27 may represent a case where target sub-spatial areas for correction are widely distributed across the target spatial area. The control device may determine that the overall degradation in reception quality is caused by at least one of insufficient transmission power, degradation of the channel environment, an increase in repeater load, and instantaneous interference. The control device may select transmission power adjustment as the correction method. For example, if the reception intensity is below a reference value in most of the target spatial area, the control device may increase the transmission power level and may also increase the number of repeated transmissions of the same light emission control packet.

2730 of FIG. 27 may represent a case where target sub-spatial areas for correction are locally concentrated in some areas within the target spatial area. The control device may determine that local degradation in reception quality is caused by at least one of a structure, audience density, radio shadow, and an angle difference with the repeater. The control device may select auxiliary beam formation using an auxiliary repeater 201 as the correction method. For example, if the auxiliary repeater 201 can cover the target sub-spatial area for correction with a higher target area inclusion ratio, the control device may transmit auxiliary beam transmission conditions to the auxiliary repeater 201.

2740 of FIG. 27 may represent a case where reception quality of some sub-spatial areas degrades due to an obstacle or a shielding structure. If the control device determines that it is difficult to improve the reception quality of the target sub-spatial area for correction even by correcting the beam transmission conditions of the current repeater 200, it may select a transmission switch to another repeater 201 as the correction method. For example, if the estimated coverage area of another repeater 201 includes the target sub-spatial area for correction and the non-applied area inclusion ratio is equal to or less than a reference value, the control device may update the beam transmission conditions to use the other repeater 201.

Using the embodiment of FIG. 27, the control device may select at least one of beam direction correction, beam width adjustment, transmission power adjustment, auxiliary beam formation, and transmission switch to another repeater according to the distribution type of the reception state distribution. The control device may correct the beam transmission conditions according to the selected correction method, and the repeater may transmit a light emission control packet based on the corrected beam transmission conditions. The light-emitting device control system can correct reception failures for each spatial unit by reflecting the reception quality after transmission and can increase the reachability stability of light emission control packets in a large-scale performance space.

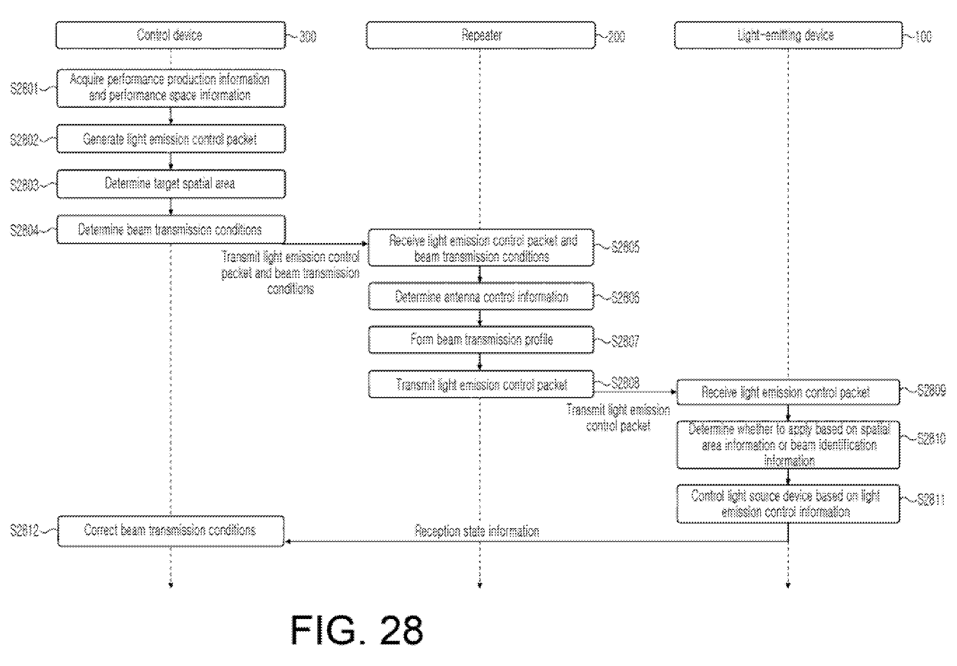

FIG. 28 is a flowchart illustrating a spatial-selective light emission control method among a control device 300, a repeater 200, and a light-emitting device 100, according to an embodiment. The method of FIG. 28 may represent a procedure in which the control device 300 converts performance production information into spatial transmission control information, the repeater 200 transmits a light emission control packet according to beam transmission conditions, and the light-emitting device 100 controls a light source device by determining whether to apply the received light emission control packet.

In step S2801, the control device 300 may acquire performance production information and performance space information. In step S2802, the control device 300 may generate a light emission control packet based on the performance production information. In step S2803, the control device 300 may determine a target spatial area by mapping production target indication information included in the performance production information to the performance space information. For example, when the production target indication information indicates a specific audience seat block, the control device 300 may determine the target spatial area based on at least one of spatial unit definition information, spatial correspondence information, and transmission reference information.

In step S2804, the control device 300 may determine beam transmission conditions based on at least one of the target spatial area and information regarding a repeater. The control device 300 may acquire a beam transmission profile that the repeater can form and an estimated coverage area, and select the beam transmission profile based on at least one of a target area inclusion ratio, a non-applied area inclusion ratio, a transmission power level, a beam switching delay, and a repeater load. The control device 300 may transmit the light emission control packet and the beam transmission conditions to the repeater 200.

In step S2805, the repeater 200 may receive the light emission control packet and the beam transmission conditions from the control device 300. In step S2806, the repeater 200 may determine antenna control information to be applied to an antenna device based on the beam transmission conditions. In step S2807, the repeater 200 may form a beam transmission profile corresponding to the target spatial area based on the antenna control information. In step S2808, the repeater 200 may transmit the light emission control packet to the target spatial area through the formed beam transmission profile.

In step S2809, the light-emitting device 100 may receive the light emission control packet from the repeater 200. In step S2810, the light-emitting device 100 may determine whether to apply the light emission control packet based on spatial area information or beam identification information included in the light emission control packet. For example, the light-emitting device 100 may determine whether it is a processing target packet by comparing information included in the light emission control packet with at least one of spatial correspondence information, device identification information, and beam identification information stored in a memory. In step S2811, if the light emission control packet is a processing target packet, the light-emitting device 100 may control the light source device based on light emission control information.

In step S2812, the control device 300 may acquire reception state information from the light-emitting device 100 or the repeater 200, and correct the beam transmission conditions based on the reception state information. The control device 300 may calculate a reception state distribution by mapping the reception state information to a plurality of sub-spatial areas within the target spatial area, and identify a target sub-spatial area for correction based on the reception state distribution. The control device 300 may select at least one of beam direction correction, beam width adjustment, transmission power adjustment, auxiliary beam formation, and transmission switch to another repeater according to a distribution type of the target sub-spatial area for correction. By using the method of FIG. 28, spatial meaning of performance production information can be converted into beam transmission conditions, and accuracy and stability of spatial-selective light emission control can be increased by reflecting the reception state after transmission.

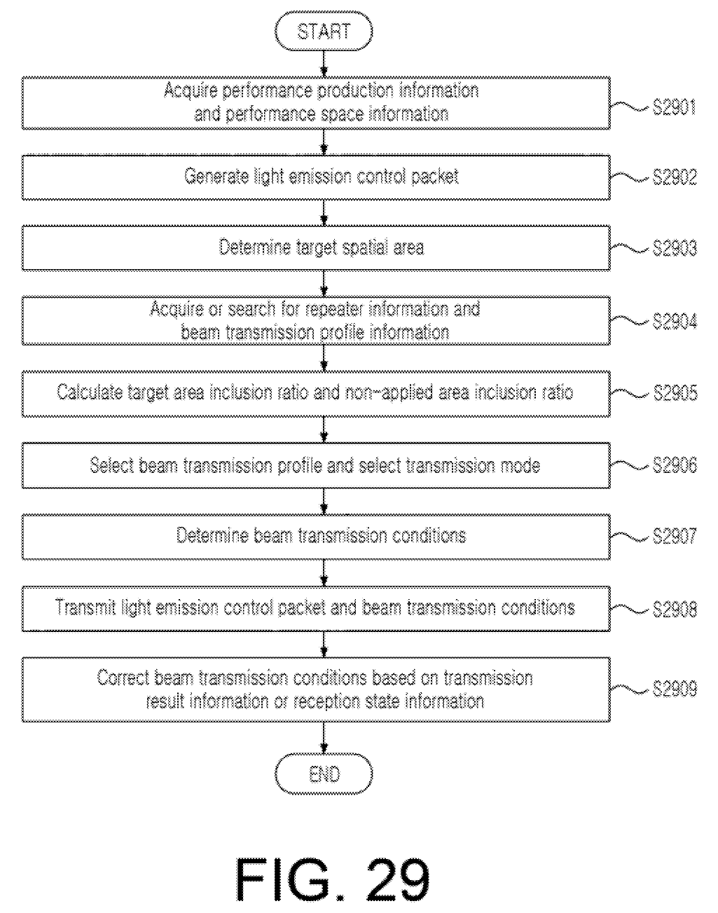

FIG. 29 is a flowchart illustrating a method for determining beam transmission conditions performed by a control device according to an embodiment. The method of FIG. 29 may represent a procedure in which the control device generates a light emission control packet using performance production information and performance space information, selects a beam transmission profile and a transmission mode suitable for a target spatial area, and then determines beam transmission conditions based on a selection result. The method of FIG. 29 may be a flow that summarizes the spatial unit, estimated coverage area, result of determining spatial selectivity, and reception state distribution-based correction procedure described in FIGS. 20-27 as performed by the control device.

In step S2901, the control device may acquire performance production information and performance space information. The performance production information may include at least one of production target indication information, execution time information, and light emission effect information, and the performance space information may include at least one of spatial unit definition information, spatial correspondence information, and transmission reference information. In step S2902, the control device may generate a light emission control packet based on the performance production information. In step S2903, the control device may determine a target spatial area by mapping the production target indication information to the performance space information. For example, the control device may convert production target indication information indicating blue blinking for the bottom right audience seat block into spatial unit identification information or a performance space coordinate range, and determine a spatial unit corresponding to a conversion result as the target spatial area.

In step S2904, the control device may acquire or search for repeater information and beam transmission profile information. The repeater information may include at least one of an installation position of a repeater, a transmittable range, a supported transmission mode, a repeater load, and communication quality. The beam transmission profile information may include at least one of beam transmission profile identification information, a main transmission direction, a beam width, a transmission power level, an estimated coverage area, and antenna control reference information. In step S2905, the control device may calculate a target area inclusion ratio based on a degree of overlap between the target spatial area and the estimated coverage area, and calculate a non-applied area inclusion ratio based on a degree of overlap between the estimated coverage area and a non-applied spatial area.

In step S2906, the control device may select a beam transmission profile based on at least one of the target area inclusion ratio, the non-applied area inclusion ratio, the transmission power level, a beam switching delay, and the repeater load, and select a transmission mode based on a result of determining spatial selectivity. For example, the control device may primarily select candidate beam transmission profiles having a target area inclusion ratio equal to or greater than a first reference value, and select a beam transmission profile having a non-applied area inclusion ratio equal to or less than a second reference value among primary candidates. For example, when the target spatial area occupies most of the performance space, the control device may select an omnidirectional transmission mode, and when the target spatial area is limited to a specific spatial unit, the control device may select a beamforming transmission mode, and when the target spatial area is composed of a plurality of areas separated from each other, the control device may select a multi-beam transmission mode.

In step S2907, the control device may determine beam transmission conditions based on the selected beam transmission profile and the transmission mode. The beam transmission conditions may include at least one of repeater identification information, beam transmission profile identification information, the main transmission direction, a transmission coverage range, the transmission power level, a beam maintenance time, a beam switching order, and a transmission restriction condition. In step S2908, the control device may transmit the light emission control packet and the beam transmission conditions to the selected repeater. For example, when the multi-beam transmission mode is selected, the control device may include a plurality of pieces of beam transmission profile identification information and the beam switching order in the beam transmission conditions to allow the repeater to sequentially or simultaneously cover a plurality of target spatial areas.

In step S2909, the control device may correct the beam transmission conditions based on transmission result information or reception state information. The control device may calculate a reception state distribution by mapping the reception state information or the communication quality information to a plurality of sub-spatial areas within the target spatial area, and identify a target sub-spatial area for correction where reception quality does not satisfy a reference condition. The control device may select at least one of beam direction correction, beam width adjustment, transmission power adjustment, auxiliary beam formation, and transmission switch to another repeater based on a distribution type of the target sub-spatial area for correction. Using the method of FIG. 29, the control device can convert spatial meaning of performance production information into beam transmission conditions, and increase accuracy and stability of spatial-selective transmission by reflecting a reception state after transmission.

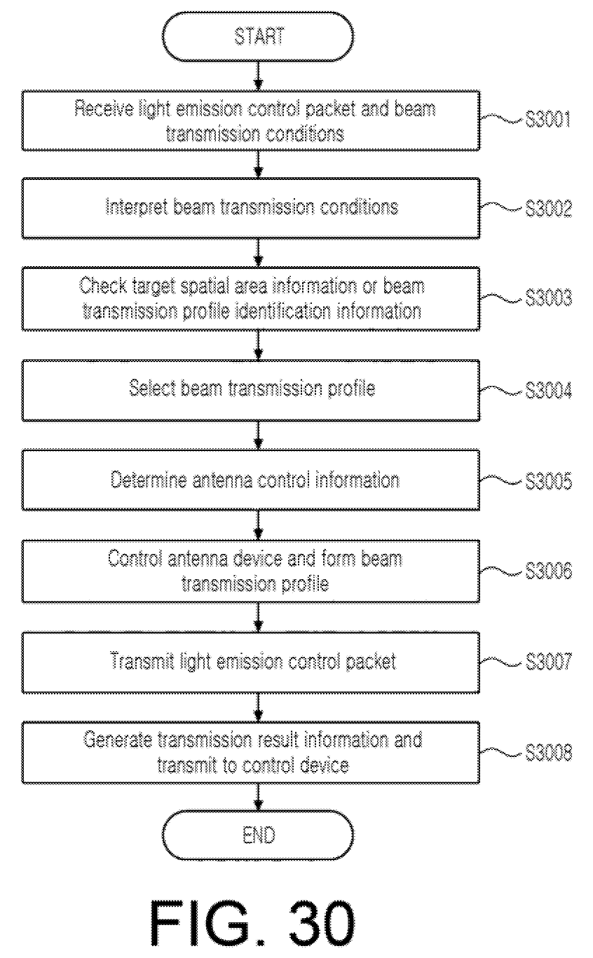

FIG. 30 is a flowchart illustrating a spatial-selective packet transmission method performed by a repeater 200, according to an embodiment. The method of FIG. 30 represents a procedure in which the repeater 200 receives a light emission control packet and beam transmission conditions from a control device, interprets the beam transmission conditions to control an antenna device, and then transmits the light emission control packet to a target spatial area. The method of FIG. 30 may be an embodiment in which the repeater 200 operates not as a simple delivery device but as a transmission device that controls the antenna device and a beam transmission profile according to the beam transmission conditions.

In step S3001, the repeater 200 may receive the light emission control packet and the beam transmission conditions from the control device. In step S3002, the repeater 200 may interpret the beam transmission conditions. The beam transmission conditions may include at least one of beam transmission profile identification information, target spatial area information, transmission mode information, a main transmission direction, a transmission coverage range, a transmission power level, a beam maintenance time, and a beam switching order. For example, the repeater 200 may specify one of a plurality of beam transmission profiles stored in a memory by using the beam transmission profile identification information included in the beam transmission conditions.

In step S3003, the repeater 200 may check the target spatial area information or the beam transmission profile identification information. When the target spatial area information is included, the repeater 200 may check a beam transmission profile capable of covering the target spatial area by comparing the target spatial area information with estimated coverage area information stored in the memory. When the beam transmission profile identification information is included, the repeater 200 may select a beam transmission profile corresponding to the identification information. For example, when the target spatial area corresponds to a specific audience seat block, the repeater 200 may select a beam transmission profile having an estimated coverage area that includes the audience seat block.

In step S3004, the repeater 200 may select the beam transmission profile. In step S3005, the repeater 200 may determine antenna control information corresponding to the selected beam transmission profile. The antenna control information may include at least one of an antenna selection value, a transmission direction value, a beam width value, a transmission power value, a phase control value, and an amplitude control value. For example, the repeater 200 may determine a phase control value and a transmission power value corresponding to the selected beam transmission profile by referring to antenna control reference information stored in the memory.

In step S3006, the repeater 200 may control the antenna device based on the antenna control information and form the selected beam transmission profile. In step S3007, the repeater 200 may transmit the light emission control packet through the formed beam transmission profile. For example, when the transmission mode information indicates a beamforming transmission mode, the repeater 200 may form a beam transmission profile toward one target spatial area. For example, when the transmission mode information indicates a multi-beam transmission mode, the repeater 200 may sequentially or simultaneously form a plurality of beam transmission profiles.

In step S3008, the repeater 200 may generate transmission result information in response to the transmission of the light emission control packet and transmit the generated transmission result information to the control device. The transmission result information may include at least one of the transmitted beam transmission profile, whether transmission is completed, an antenna control state, whether a packet transmission error occurred, reception state information, and communication quality information. The control device may determine whether to correct subsequent beam transmission conditions based on the transmission result information. By using the method of FIG. 30, the repeater 200 can convert the beam transmission conditions determined by the control device into actual antenna control operations and increase the reachability of light emission control packets to the target spatial area.

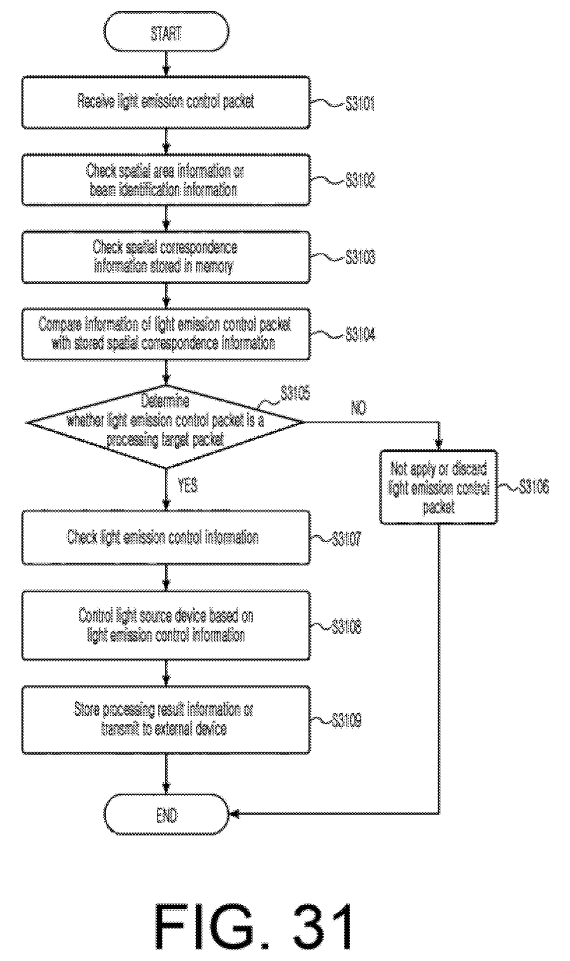

FIG. 31 is a flowchart illustrating a light emission control packet processing method performed by a light-emitting device, according to an embodiment. The method of FIG. 31 may represent a procedure in which a light-emitting device receives a light emission control packet from a repeater, determines whether it is a processing target packet based on spatial area information or beam identification information included in the light emission control packet, and then controls a light source device based on light emission control information. The method of FIG. 31 can explain a structure in which the light-emitting device does not execute all received packets but selectively processes only the packets applicable to itself.

In step S3101, the light-emitting device may receive a light emission control packet. In step S3102, the light-emitting device may check spatial area information or beam identification information included in the received light emission control packet. The spatial area information may include at least one of a target spatial area, spatial unit identification information, a spatial coordinate range, and light-emitting device group identification information. The beam identification information may be information indicating which beam transmission profile or which transmission area the light emission control packet corresponds to.

In step S3103, the light-emitting device may check spatial correspondence information stored in a memory. The spatial correspondence information may include at least one of a spatial unit to which the light-emitting device belongs, a coordinate range, a light-emitting device group, beam identification information, and device identification information. For example, if the light-emitting device is set to correspond to spatial unit 2010-6, the light-emitting device can check spatial correspondence information corresponding to spatial unit 2010-6 in the memory. For example, if the light-emitting device is arranged in an area corresponding to a specific beam transmission profile, the light-emitting device can check beam identification information stored in the memory.

In step S3104, the light-emitting device may compare the information of the light emission control packet with the stored spatial correspondence information. In step S3105, the light-emitting device may determine whether the light emission control packet is a processing target packet based on a comparison result. For example, if the spatial area information included in the light emission control packet matches the spatial correspondence information of the light-emitting device, or if the beam identification information included in the light emission control packet matches the stored beam identification information of the light-emitting device, the light-emitting device may determine the light emission control packet to be a processing target packet. If the light emission control packet is not a processing target packet, in step S3106, the light-emitting device may not apply or discard the light emission control packet.

If the light emission control packet is a processing target packet, in step S3107, the light-emitting device may check light emission control information. In step S3108, the light-emitting device may control the light source device based on the light emission control information. The light emission control information may include at least one of a color value, a brightness value, a blinking period, a fade time, and a light emission maintenance time. For example, the light-emitting device can control the light source device to blink in blue if the light emission control information indicates blue blinking, and if the light emission control information indicates a brightness increase, it can gradually increase the output level of the light source device.

In step S3109, the light-emitting device may store processing result information or transmit it to an external device. The processing result information may include at least one of whether the light emission control packet is received, whether it is a processing target packet, whether the light emission control information is applied, whether an error occurs, and a current light emission state. By using the method of FIG. 31, the light-emitting device can determine whether to apply a packet based on the spatial area information or the beam identification information, and only light-emitting devices included in the target spatial area can selectively perform a light emission operation. The light-emitting device control system can reduce unnecessary light emission operations in non-applied spatial areas and increase the accuracy of spatial-selective production.

Such a computer-readable storage medium may be a read-only memory (ROM), a random-access memory (RAM), a flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, a magnetic tape, a floppy disk, a magneto-optical data storage device, an optical data storage device, a hard disk, or a solid-state disk (SSD), and may be any device capable of storing instructions or software, related data, data files, and data structures and providing the instructions or software, related data, data files, and data structures to a processor or a computer so that the processor or the computer can execute the instructions.

Although some exemplary embodiments have been described in detail above, the scope of the present invention is not limited thereto, and various modifications and improvements made by those of ordinary skill in the art using the basic concept of the present invention defined in the following claims also fall within the scope of the present invention.

What is claimed is:

1. A control device for controlling a plurality of light-emitting devices, the control device comprising:
a communication device; a memory; and a processor configured to execute instructions stored in the memory, wherein the processor, by executing the instructions, is configured to:
acquire performance production information including at least one of performance progress time information, production target information, and light emission effect information;
generate, based on the performance production information, a light emission control packet including light emission control information and information on a reception target range of the light emission control information;
determine, based on the information on the reception target range included in the light emission control packet, one of a plurality of transmission methods corresponding to different reception target ranges;
determine, based on the determined transmission method, a transmission condition to be applied to at least one repeater for transmitting the light emission control packet; and
transmit the light emission control packet and the transmission condition to the at least one repeater through the communication device.

2. The control device of claim 1, wherein the processor is configured to:
identify, from the production target information, at least one of a target area based on a performance space, a light-emitting device group, an individual light-emitting device, and a state condition of a light-emitting device; and
generate the information on the reception target range based on at least one of the identified target area, the identified light-emitting device group, the identified individual light-emitting device, and the identified state condition.

3. The control device of claim 2, wherein the processor is configured to:
generate the information on the reception target range by using at least one of correspondence information between the target area based on the performance space and a preset light-emitting device group, identification information of the light-emitting device group, identification information of the individual light-emitting device, and the state condition of the light-emitting device.

4. The control device of claim 1,
wherein the plurality of transmission methods correspond to a plurality of target categories having different reception target ranges, and
wherein the processor is configured to select one of the plurality of transmission methods based on a target category to which the reception target range belongs.

5. The control device of claim 1, wherein the processor is configured to:
generate execution time information representing an application timing of the light emission control information based on the performance progress time information; and
construct the light emission control packet to include the execution time information.

6. The control device of claim 5, wherein the processor is configured to:
determine the transmission condition, including at least one of a transmission timing, a transmission repetition count, and a transmission priority of the light emission control packet, based on a relationship between an application timing indicated by the execution time information and a current performance progress time.

7. The control device of claim 1,
wherein the transmission condition includes at least one of a transmission method, a transmission target, a transmission timing, a transmission repetition count, a transmission priority, whether to re-transmit, and whether to perform calibration transmission, and
wherein the processor is configured to transmit the transmission condition to the at least one repeater so that the at least one repeater transmits the light emission control packet according to the transmission condition.

8. The control device of claim 1,
wherein the at least one repeater is selected from a plurality of repeaters, and
wherein the processor is configured to select the at least one repeater based on a correspondence relationship between the reception target range and a transmittable range of each of the plurality of repeaters.

9. The control device of claim 1, wherein the processor is configured to:
determine whether a subsequent transmission of the light emission control packet is necessary and determine a subsequent transmission condition, based on information on a transmission result of the light emission control packet.

10. The control device of claim 9,
wherein the information on the transmission result includes at least one of packet identification information of the light emission control packet, transmission history information, reception state information collected from a light-emitting device, device state information of the light-emitting device, and valid time information of the light emission control packet, and
wherein the subsequent transmission condition includes at least one of a repeated transmission condition for the same light emission control packet, a re-transmission condition for a previously transmitted light emission control packet, and a transmission condition for a calibration packet indicating a light emission state corresponding to a current performance progress time.

11. A light-emitting device comprising:
a communication device configured to receive a light emission control packet from an external device;
a light source device configured to emit light;
a memory; and
a processor configured to execute instructions stored in the memory, wherein the processor, by executing the instructions, is configured to:
determine whether the light emission control packet is a processing target packet based on information on a reception target range included in the light emission control packet;
determine, when the light emission control packet is the processing target packet, an application timing of light emission control information included in the light emission control packet based on execution time information included in the light emission control packet; and
control the light source device based on the light emission control information at the application timing.

12. The light-emitting device of claim 11,
wherein the memory is configured to store device identification information of the light-emitting device and current device correspondence information that is updated based on at least one of a performance progress time, a previously received light emission control packet, group update information, and state information of the light-emitting device,
wherein the current device correspondence information includes at least one of information on a light-emitting device group to which the light-emitting device currently belongs and current state information of the light-emitting device, and
wherein the processor is configured to determine whether the light emission control packet is the processing target packet applied to the light-emitting device as any one of target categories corresponding to all light-emitting devices, a light-emitting device group, or an individual light-emitting device, by comparing the information on the reception target range with at least one of the device identification information and the current device correspondence information.

13. The light-emitting device of claim 11,
wherein the light emission control packet further includes at least one of packet identification information, version information, error detection information, and valid time information, and
wherein the processor is configured to determine, before determining whether the light emission control packet is the processing target packet, at least one of integrity, redundancy, and validity of the light emission control packet based on at least one of the packet identification information, the version information, the error detection information, and the valid time information.

14. The light-emitting device of claim 11, wherein the processor is configured to:
immediately apply the light emission control information when the execution time information indicates immediate execution;
temporarily store the light emission control information in the memory when the execution time information indicates an application timing corresponding to a reserved execution time or a performance progress time, and apply the light emission control information at the application timing; and
not apply the light emission control information when the execution time information includes a valid time or an expiration time and indicates that validity of the light emission control packet has been lost.

15. The light-emitting device of claim 11, wherein the processor is configured to:
generate processing result information representing at least one of whether the light emission control packet is received, whether the light emission control packet is the processing target packet, whether the light emission control information is applied, whether an error occurs, and a current light emission state; and
store the processing result information in the memory or transmit the processing result information to the external device through the communication device.
